(19) United States
(12) Patent Application Publication
(10) Pub. No.: US 2022/0270166 A1
(43) Pub. Date: Aug. 25, 2022

(54) ELECTRONIC AUCTION PLATFORM WITH MULTI-LOT, MULTI-BUYER AUCTIONS

(71) Applicant: KEMGO INC., Princeton, NJ (US)

(72) Inventors: Joseph M. Naaman, Nashville, TN (US); Ralph De Haan, Papenburg (DE); Varun Vijay, Delhi (IN)

(21) Appl. No.: 17/677,835

(22) Filed: Feb. 22, 2022

Related U.S. Application Data
(60) Provisional application No. 63/152,281, filed on Feb. 22, 2021.

(51) Int. Cl. G06Q 30/08; G06Q 30/02

(52) U.S. Cl. CPC G06Q 30/08; G06Q 30/0206

(57) ABSTRACT

Systems, methods, and computer-readable media for conducting multi-lot, multi-buyer auctions on electronic auction platforms are provided.

### CROSS-REFERENCE TO RELATED APPLICATION(S)

This application claims the benefit of prior filed U.S. Provisional Patent Application No. 63/152,281, filed Feb. 22, 2021, which is hereby incorporated by reference herein in its entirety.

### COPYRIGHT NOTICE

At least a portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### TECHNICAL FIELD

This disclosure relates to electronic auction platforms and, more particularly, to systems, methods, and computer-readable media for conducting multi-lot, multi-buyer auctions on electronic auction platforms.

### BACKGROUND OF THE DISCLOSURE

Conventional auctions between a seller and multiple buyers have several disadvantages including, but not limited to, the inability to determine minimum allowable bid values per buyer effectively at any given moment during an auction.

### SUMMARY OF THE DISCLOSURE

This document describes systems, methods, and computer-readable media for conducting multi-lot, multi-buyer auctions on electronic auction platforms.

For example, a computer-implemented method of facilitating, at an electronic auction subsystem including a communications component and a memory and at least one processor, an electronic auction between a prospective seller end user subsystem and a plurality of prospective buyer end user subsystems may be provided, wherein the electronic auction includes an auction status indicative of a plurality of possible buyers, a plurality of possible bid quantities of auction product, a minimum starting bid value, a minimum increment value, and, for each current active bid of the auction, a current bid quantity, a current raw bid value, and an associated possible buyer of the plurality of possible buyers, the method including receiving, at the electronic auction subsystem from one prospective buyer end user subsystem of the plurality of prospective buyer end user subsystems, a new bid indicative of: one associated possible buyer of the plurality of possible buyers, a new bid quantity, and a new raw bid value, based on the received new bid, automatically updating, at the electronic auction subsystem, the auction status of the electronic auction, based on the updated auction status of the electronic auction, automatically calculating, at the electronic auction subsystem, for each possible buyer of the plurality of possible buyers, a raw minimum bid value for each possible bid quantity of the plurality of possible bid quantities of auction product, and, after the calculating, automatically transmitting the calculated raw minimum bid value for each possible bid quantity of the plurality of possible bid quantities of auction product for a first possible buyer of the plurality of possible buyers from the electronic auction subsystem to a first prospective buyer end user subsystem of the plurality of prospective buyer end user subsystems, and automatically transmitting the calculated raw minimum bid value for each possible bid quantity of the plurality of possible bid quantities of auction product for a second possible buyer of the plurality of possible buyers from the electronic auction subsystem to a second prospective buyer end user subsystem of the plurality of prospective buyer end user subsystems.

As another example, a computer-implemented method of facilitating, at an electronic auction subsystem including a communications component and a memory and at least one processor, an electronic auction between a prospective seller end user subsystem and a plurality of prospective buyer end user subsystems may be provided, wherein the electronic auction includes an auction status indicative of a plurality of possible buyers, a plurality of possible bid quantities of auction product, a minimum starting bid value, a minimum increment value, at least one first buyer-customization value associated with a first possible buyer of the plurality of possible buyers, at least one second buyer-customization value associated with a second possible buyer of the plurality of possible buyers and, for each current active bid of the auction, a current bid quantity, a current raw bid value, and an associated possible buyer of the plurality of possible buyers, the method including receiving, at the electronic auction subsystem from one prospective buyer end user subsystem of the plurality of prospective buyer end user subsystems, a new bid indicative of one associated possible buyer of the plurality of possible buyers, a new bid quantity, and a new raw bid value, based on the received new bid, automatically updating, at the electronic auction subsystem, the auction status of the electronic auction, based on the updated auction status of the electronic auction, automatically calculating, at the electronic auction subsystem, for each possible buyer of the plurality of possible buyers, a raw minimum bid value for each possible bid quantity of the plurality of possible bid quantities of auction product, and, after the calculating, automatically adjusting the calculated raw minimum bid value for a particular possible bid quantity of the plurality of possible bid quantities of auction product for the first possible buyer by the first buyer-customization value, and automatically adjusting the calculated raw minimum bid value for the particular possible bid quantity of the plurality of possible bid quantities of auction product for the second possible buyer by the second buyer-customization value, wherein the first buyer-customization value is different than the second buyer-customization value.

As yet another example, a computer-implemented method of facilitating, at an electronic auction subsystem including a communications component and a memory and at least one processor, an electronic auction between a prospective seller end user subsystem and a plurality of prospective buyer end user subsystems may be provided, wherein the electronic auction includes an auction status indicative of a plurality of possible buyers, a plurality of possible bid quantities of auction product, a minimum starting bid value, a minimum increment value, and, for each current active bid of the auction, a current bid quantity, a current raw bid value, and an associated possible buyer of the plurality of possible buyers, the method including receiving, at the electronic auction subsystem from one prospective buyer end user subsystem of the plurality of prospective buyer end user subsystems, a new bid indicative of one associated possible buyer of the plurality of possible buyers, a new bid quantity, and a new raw bid value, based on the received new bid, automatically updating, at the electronic auction subsystem, the auction status of the electronic auction, based on the updated auction status of the electronic auction, automatically calculating, at the electronic auction subsystem, for each possible buyer of the plurality of possible buyers, a raw minimum bid value for each possible bid quantity of the plurality of possible bid quantities of auction product, and, after the calculating, automatically simultaneously presenting the calculated raw minimum bid value for each possible bid quantity of the plurality of possible bid quantities of auction product for only a first possible buyer of the plurality of possible buyers on a first prospective buyer end user subsystem of the plurality of prospective buyer end user subsystems.

This Summary is provided to summarize some example embodiments, so as to provide a basic understanding of some aspects of the subject matter described in this document. Accordingly, it will be appreciated that the features described in this Summary are only examples and should not be construed to narrow the scope or spirit of the subject matter described herein in any way. Unless otherwise stated, features described in the context of one example may be combined or used with features described in the context of one or more other examples. Other features, aspects, and advantages of the subject matter described herein will become apparent from the following Detailed Description, Figures, and Claims.

### BRIEF DESCRIPTION OF THE DRAWINGS

The discussion below makes reference to the following drawings, in which like reference characters may refer to like parts throughout, and in which:

FIG. 1 is a schematic view of an illustrative system that may provide an electronic auction service of the disclosure;

FIG. 1A is a more detailed schematic view of a subsystem of the system of FIG. 1;

FIG. 2 is a flowchart of an illustrative process that may provide features to a seller of the electronic auction service of the disclosure;

FIG. 3 is a flowchart of an illustrative process that may provide features to a buyer of the electronic auction service of the disclosure;

FIG. 3A is a flowchart of another illustrative process that may provide features to a buyer of the electronic auction service of the disclosure;

FIG. 4 is a flowchart of another illustrative process that may provide features to a buyer of the electronic auction service of the disclosure;

FIG. 4A is a flowchart of an illustrative subprocess of the process of FIG. 4;

FIGS. 5-9, 9A, and 9B are screen shots of various illustrative user interfaces that may be provided by any suitable subsystem for any suitable user entity of the electronic auction service of the disclosure;

FIGS. 10-62A show various data structures that can be utilized by processes of the electronic auction service of the disclosure; and

FIGS. 63-65 are flowcharts of illustrative processes of the electronic auction service of the disclosure.

### DETAILED DESCRIPTION OF THE DISCLOSURE

Systems, methods, and computer-readable media for conducting multi-lot, multi-buyer auctions on electronic auction platforms are provided.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. The term “and/or” as used herein may refer to and encompass any and all possible combinations of one or more of the associated listed items. The terms “includes,” “including,” “comprises,” and/or “comprising,” when used in this specification, may specify the presence of stated features, integers, operations, operations, elements, and/or components, but do not preclude the presence or addition of one or more other features, integers, operations, operations, elements, components, and/or groups thereof.

The term “if” may, optionally, be construed to mean “when” or “upon” or “in response to determining” or “in response to detecting,” depending on the context. Similarly, the phrase “if it is determined” or “if [a stated condition or event] is detected” may, optionally, be construed to mean “upon determining” or “in response to determining” or “upon detecting [the stated condition or event]” or “in response to detecting [the stated condition or event],” depending on the context.

As used herein, the terms “computer,” “personal computer,” “device,” “computing device,” “router device,” and “controller device” may refer to any programmable computer system that is known or that will be developed in the future. In certain embodiments, a computer may be coupled to a network, such as described herein. A computer system may be configured with processor-executable software instructions to perform the processes described herein. Such computing devices may be mobile devices, such as a mobile telephone, data assistant, tablet computer, or other such mobile device. Alternatively, such computing devices may not be mobile (e.g., in at least certain use cases), such as in the case of server computers, desktop computing systems, or systems integrated with non-mobile components.

As used herein, the terms “component,” “module,” and “system” may be intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server may be a component. One or more components may reside within a process and/or thread of execution and a component may be localized on one computer and/or distributed between two or more computers.

An electronic auction service is provided that may be operative to manage and efficiently and effectively automate the process of operating an auction (e.g., in real time). The services may provide an electronic auction (“eAuction”) platform and, more particularly, an eAuction platform that may support various types of auctions, including, but not limited to, multi-lot, multi-buyer auctions (“English Yankee auctions”), English auctions, Dutch auctions, allocation auctions, standard reverse auctions, Dutch reverse auctions, and/or the like for any suitable industry (e.g., for the chemical industry) and/or for any suitable products (e.g., goods and/or services) to be bought and sold. Such an electronic auction service, online marketplace, and eAuction platform may be referred to herein as “Kemgo” or an electronic auction service platform (“EASP”).

An electronic auction service platform of this disclosure may generally facilitate any auction type to support sellers and buyers with online transactions. For example, the EASP may be configured to support any suitable English auctions, where a single highest bidder may win the entirety of the auctioned product (e.g., each bidder may enter the highest price they are willing to pay, the highest bidder may lead the auction and the highest price may be visible to every participant, the identity of each and every buyer may not be disclosed to other buyers, and/or the seller may have full visibility). As another example, the EASP may be configured to support any suitable Dutch auctions, which may be a timed auction that may start with a high price that may decline over time, where a single bidder who places the earliest bid may win the auction (e.g., the starting high price may be decreased by a certain amount X (e.g., as may be defined by the seller) at a certain time interval (e.g., as may also be defined by the seller), where, if any buyer offers the current price or higher, the auction may end, and where, if a buyer placed an offer below the current price, the auction may automatically meet this price given the time, where the highest bidder may be automatically awarded the auction once the current price meets the bid price, where buyers may not be made aware if there are any other bids or any other buyers taking part in the auction, and/or where the Dutch auction can be successful with a single buyer being invited). As another example, the EASP may be configured to support any suitable allocation auctions, which may be similar in principle to an English auction but where the buyer may be bidding for future volumes (e.g., including that the bidding price includes a pricing formula (e.g., an auction is offering a 12 month contract for 1,200 units of product equally distributed over this or the following year (e.g., time and quantity can be defined)), which may be helpful when nobody knows the prices for the product 6 months ahead, whereby the EASP may enable the option to offer a bidding mechanism that may work with a pricing formula (e.g., chemical product pricing may be calculated on basis of its feedstock plus a premium, where the seller may define the feedstock formula and the buyer may bid on the premium). As another example, the EASP may be configured to support any suitable reverse English auctions, which may allow a buyer to invite sellers to place an offer for supplying a certain volume and meeting certain conditions (e.g., delivery location, date, etc.), whereby the logic of such an auction may be to achieve reaching the best price for the buyer, such that the bids placed by the seller may have to be lower compared to the previous ones, where, if the buyer defines a maximum price, the seller may not be enabled to start with an offer higher than this price. As another example, the EASP may be configured to support any suitable reverse Dutch auctions, which may allow a buyer to invite sellers to place an offer supplying a certain volume and meeting certain conditions (e.g., delivery location, date, etc.), whereby the logic of such an auction may be to achieve reaching the best price for the buyer, such that the auction may start with a low price, which may be defined by the buyer, and the price may increase with a certain amount X (e.g., as may be defined by the buyer) at a certain time interval (e.g., as may also be defined by the buyer), where by the auction may end if a seller is placing an offer meeting the current price, and, if a seller's offer is higher than the current price, the auction may finalize when the current price meets the bid. As yet another example, the EASP may be configured to support any suitable English Yankee auctions or multi-lot, multi-buyer auctions, in which different quantities of the auctioned product can be sold to different buyers at the same time in a single auction.

As a particular example, in the chemical industry, sales may be desired in many forms depending on various characteristics, including, but not limited to, products sold, quantities sold, market conditions, and/or the like. Sellers may generally desire to trade large quantities of products from a single product lot with multiple buyers purchasing from the same lot. The EASP of his disclosure may provide an automated auction type that allows an online transaction to be conducted in a way similar to spot business (e.g., by enabling multiple buyers to purchase from the same lot of products). This automated auction type, which may be referred to herein as an automated “English Yankee” auction, or “multi-lot, multi-winner” auction, or “multi-lot, multi-buyer” auction, may be configured to enable a seller to sell product from a single lot to multiple winners of the same auction, which may be accomplished by allowing buyers to decide on the quantities they are interested in bidding on, and at the price they are interested in proposing for those quantities that may also meet the current minimum requirement(s) of the auction, and/or which may offer any suitable visual (and/or aural, haptic, etc.) and automated mechanism to identify how much and at what minimum price a buyer should bid to guarantee they have the highest bid (e.g., based on the total transaction value). Unlike in an English auction, where a complete auctioned volume may always go to a single winner, a complete auctioned volume can be won by a single winner or can be shared by multiple winners in an English-Yankee auction. Unlike in an English auction, where a complete auctioned volume may not be broken into distinct lot sizes, a complete auctioned volume may be distributed in lots in an English-Yankee auction. Unlike in an English auction, where prices may be offered by the buyers using a minimum increment from the previous bid, a price may be automatically calculated by the EASP using weighted averages for an English-Yankee auction as part of a complete auctioned volume may be taken from other buyers.

Continuing with a particular example for such an English-Yankee auction, a seller may be enabled by the EASP to create an auction that defines (i) a minimum unit of measure (“UoM”) of product being auctioned (e.g., 1 metric ton (“MT”), which may be common in some chemical industry auctions), (ii) a total number of units of product being auctioned (e.g., 300 MTs of Product A), (iii) a lot size representing the discrete quantity of product that can be obtained during the auction (e.g., 25 MTs (e.g., a truck load of Product A), which thereby defines the total number of lots of product being auctioned (e.g., 12 lots (e.g., 300 MTs/25 MTs))), (iv) a minimum increment that any buyer would need to make to the value of a current successful/active bid in order for that buyer to submit a successful bid for at least a portion of that current active bid (e.g., $1.00 per MT), and, if desired, (v) a minimum price per lot (or per unit) that a buyer may be able to bid during the auction for product that has not yet been bid on (e.g., $800.00 per MT of product A or $4,000.00 per lot of 25 MTs of product A). Therefore, in some embodiments, a particular auction that may be defined by a seller may offer 300 MTs of Product A, where the lot size may be 25 MTs of Product A (e.g., equivalent to one truck load), such that the auction may have the following volume available: 12 lots×25 MTs per lot=300 MTs of Product A. Therefore, once the auction commences, any buyer participating in the auction (e.g., any potential bidder) may be enabled by the EASP to select a minimum of 1 lot (25 MTs) and a maximum of 12 lots (300 MTs) or any number of lots therebetween. The auction may be configured to end with a single buyer winning the entire volume (12 lots (300 MTs)) or up to 12 buyers each winning a respective single lot (25 MTs) or some other combination (e.g., a first buyer winning 1 lot, a second buyer winning 2 lots, a third buyer winning 3 lots, and a fourth buyer winning 6 lots, although some lots could go unsold in certain situations). This auction type can be considered a success for the seller if the total demand of all invited buyers exceeds 300 MTs, as this would create competition for the available volume. This auction type may be very challenging to facilitate, as a particular buyer may need to outbid multiple lots at the same time, which could mean that the buyer potentially needs to outbid multiple buyers as well. The EASP may be configured to calculate, automatically and efficiently (e.g., in real-time in response to the most recent successful bid by any buyer), a customized minimum bid value that a particular buyer would need to submit for each possible number of lots at any particular moment in time during such an auction in order for that buyer to be enabled to make a successful bid on any possible amount of product being auctioned. These customized minimum bid values for each possible number of lots for each buyer may be presented to the buyers in any suitable manner (e.g., in graph form, in drop-down list form, etc.) by the EASP in order to make the auction run as efficiently and effectively as possible for each buyer. For example, a first customized set of minimum bid values for a first buyer may be calculated and presented to the first particular buyer (e.g., 12 customized minimum bid values, one for each of the 12 possible number of lots (e.g., 1 lot, 2 lots, . . . 12 lots)), a second customized set of minimum bid values for a second buyer may be calculated and presented to the second particular buyer (e.g., 12 customized minimum bid values), and the like for each of the remaining buyers, such that, if there were 7 buyers in the auction, 84 distinct minimum bid values may be calculated by the EASP and presented as appropriate to the various respective buyers. Such calculation and presentation may be conducted each time a new bid is successfully submitted throughout the life of the auction. For example, in some embodiments, a customized set of minimum bid values as customized for a particular buyer at a particular moment during the auction may be presented by the EASP to that buyer through use of an interactive graph that may also allow that buyer to immediately and intuitively select one of the minimum bid values for a particular amount of product in order to submit a successful bid. The EASP may provide the buyer with the ability to slide (e.g., interactively) and select a particular possible quantity while understanding the minimum bid value that would be successful for such a possible quantity, where such a minimum bid value may be customized to that buyer and may be automatically (e.g., instantaneously) updated in real-time by the EASP in response to any change to the status of the auction (e.g., in response to a successful bid having been made). Therefore, each time any buyer submits a successful bid for any possible amount of product to the EASP, the customized set of minimum bid values for each buyer may be immediately recalculated and presented by the EASP to each of the respective buyers, thereby providing a seamless user experience

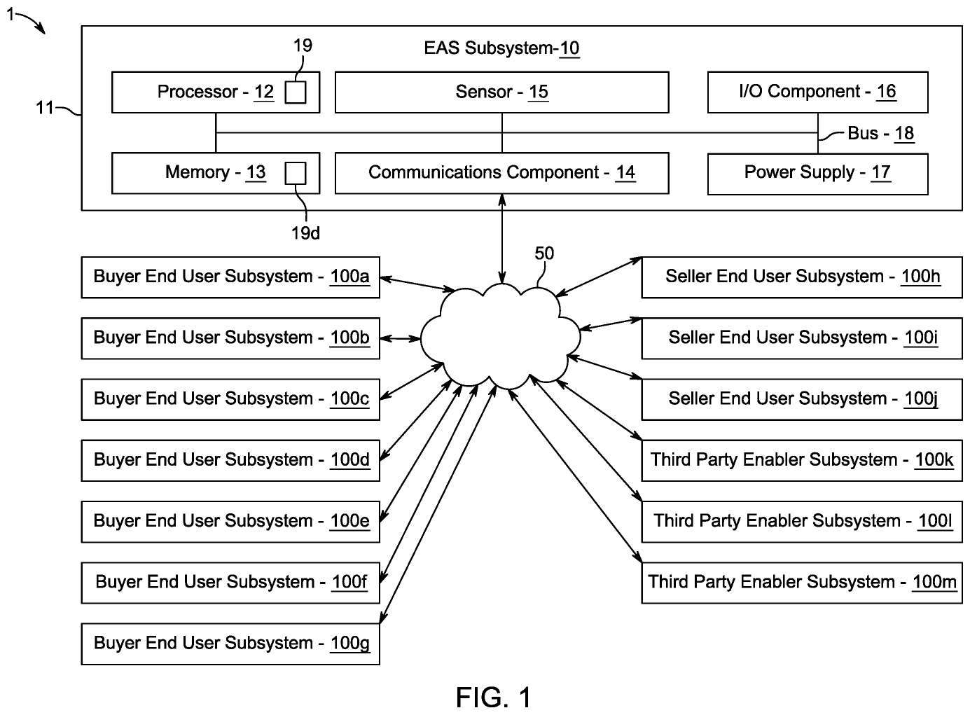

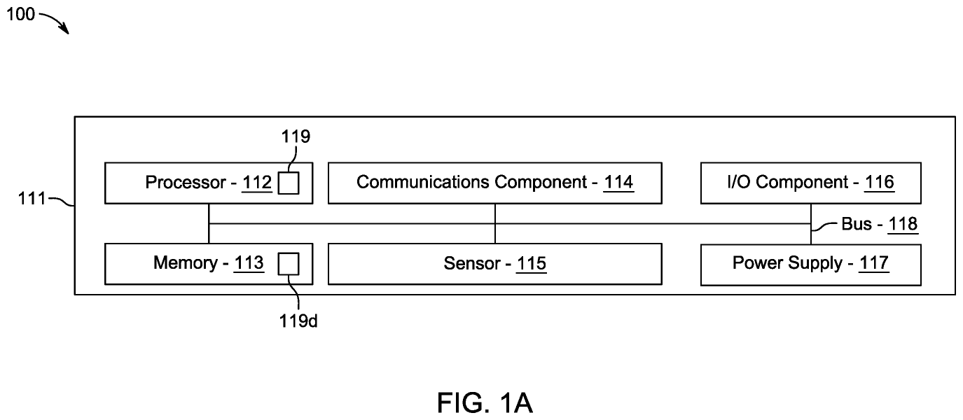

FIG. 1 is a schematic view of an illustrative system 1 in which an electronic auction service may be facilitated amongst various entities. For example, as shown in FIG. 1, system 1 may include an electronic auction service (“EAS”) subsystem 10, various subsystems 100 (e.g., one or more buyer end user (“BEU”) subsystems 100a-100g, one or more seller end user (“SEU”) subsystems 100h-100j, and/or one or more third party enabler (“TPE”) subsystems 100k-100m), and at least one communications network 50 through which any two or more of the subsystems 10 and 100 may communicate. EAS subsystem 10 may be operative to interact with any of the various subsystems 100 to provide an electronic auction service platform (“EASP”) that may facilitate various electronic auction services, including, but not limited to, managing and enhancing the user experience for each one of various buyers for each one of various possible number of lots of auctioned product for each one of various possible scenarios during the life of an auction (e.g., for any auction status (e.g., for when any possible amount of product has been successfully bid on by any of the buyers)).

As shown in FIG. 1A, and as described in more detail below, a subsystem 100 (e.g., any one of subsystems 100a-100m or otherwise of system 1) may include a processor component 112, a memory component 113, a communications component 114, a sensor component 115, an input/output (“I/O”) component 116, a power supply component 117, and/or a bus 118 that may provide one or more wired or wireless communication links or paths for transferring data and/or power to, from, or between various other components of subsystem 100. I/O component 116 may include at least one input component (e.g., a button, mouse, keyboard, microphone, input connector, etc.) to receive information from a user of subsystem 100 and/or at least one output component (e.g., an audio speaker, video display, haptic component, output connector, etc.) to provide information to a user of subsystem 100, such as a touch screen that may receive input information through a user's touch on a touch sensitive portion of a display screen and that may also provide visual information to a user via that same display screen. Memory 113 may include one or more storage mediums, including for example, a hard-drive, flash memory, permanent memory such as read-only memory (“ROM”), semi-permanent memory such as random access memory (“RAM”), any other suitable type of storage component, or any combination thereof (e.g., for storing any suitable data (e.g., any suitable data or data structure(s) 119d)). Communications component 114 may be provided to allow one subsystem 100 to communicate with a communications component of one or more other subsystems 100 or subsystem 10 or servers using any suitable communications protocol (e.g., via communications network 50). Communications component 114 can be operative to create or connect to a communications network for enabling such communication. Communications component 114 can provide wireless communications using any suitable short-range or long-range communications protocol, such as Wi-Fi (e.g., an 802.11 protocol), Bluetooth, radio frequency systems (e.g., 1200 MHz, 2.4 GHz, and 5.6 GHz communication systems), infrared, protocols used by wireless and cellular telephones and personal e-mail devices, or any other protocol supporting wireless communications. Communications component 14 can also be operative to connect to a wired communications link or directly to another data source wirelessly or via one or more wired connections or other suitable connection type(s). Communications component 14 may be a network interface that may include the mechanical, electrical, and/or signaling circuitry for communicating data over physical links that may be coupled to other devices of a network. Such network interface(s) may be configured to transmit and/or receive any suitable data using a variety of different communication protocols, including, but not limited to, TCP/IP, UDP, ATM, synchronous optical networks (“SONET”), any suitable wired protocols or wireless protocols now known or to be discovered, Frame Relay, Ethernet, Fiber Distributed Data Interface (“FDDI”), and/or the like. In some embodiments, one, some, or each of such network interfaces may be configured to implement one or more virtual network interfaces, such as for Virtual Private Network (“VPN”) access. Communication may be over the internet or any suitable public and/or private network or combination of networks (e.g., one or more networks 50). Sensor 115 may be any suitable sensor that may be configured to sense any suitable data from an external environment of subsystem 100 or from within or internal to subsystem 100 (e.g., light data via a light sensor, audio data via an audio sensor, location-based data via a location-based sensor system (e.g., a global positioning system (“GPS”)), etc.). Power supply 117 can include any suitable circuitry for receiving and/or generating power, and for providing such power to one or more of the other components of subsystem 100. Subsystem 100 may also be provided with a housing 111 that may at least partially enclose one or more of the components of subsystem 100 for protection from debris and other degrading forces external to subsystem 100. Each component of subsystem 100 may be included in the same housing 111 (e.g., as a single unitary device, such as a laptop computer or portable media device) and/or different components may be provided in different housings (e.g., a keyboard input component may be provided in a first housing that may be communicatively coupled to a processor component and a display output component that may be provided in a second housing, and/or multiple servers may be communicatively coupled to provide for a particular subsystem). In some embodiments, subsystem 100 may include other components not combined or included in those shown or several instances of the components shown.

Processor 112 may be used to run one or more applications, such as an application 119 that may be accessible from memory 113 (e.g., as a portion of data 119d) and/or from any other suitable source (e.g., from EAS subsystem 10 via an active internet connection). Application 119 may include, but is not limited to, one or more operating system applications, firmware applications, communication applications (e.g., for enabling communication of data between devices), internet browsing applications (e.g., for interacting with a website provided by EAS subsystem 10 for enabling subsystem 100 to interact with an online service of EAS subsystem 10 (e.g., a EASP)), EAS applications (e.g., a web application or a native application or a hybrid application or widget that may be at least partially produced by EAS subsystem 10 for enabling subsystem 100 to interact with an online service of EAS subsystem 10 (e.g., a EASP) via a EAS website or application or another entity's website or application), third party service applications (e.g., for interacting with a website provided by a third party subsystem), application programming interfaces (“APIs”), software development kits (“SDKs”), proprietary applications (e.g., a web application or a native application), or any other suitable applications. For example, processor 112 may load an application 119 as an interface program (e.g., user interface (“UI”) program) to determine how instructions or data received via an input component of I/O component 116 or other component of device 100 (e.g., sensor 115 and/or communications component 114) may manipulate the way in which information may be stored (e.g., in memory 113) and/or provided via an output component of I/O component 116 and/or communicated to another system device via communications component 114. As one example, application 119 may be a third party application that may be running on device 100 (e.g., an application associated with the network of system 1 and/or EAS subsystem 10) that may be loaded on device 100 in any suitable manner, such as via an application market (e.g., using communications component 114), such as the Apple App Store or Google Play, or that may be accessed via an internet application or web browser (e.g., by Apple Safari or Google Chrome) that may be running on device 100 and that may be pointed to a uniform resource locator (“URL”) whose target or web resource may be managed by or otherwise affiliated with any suitable entity. Any device (e.g., any communication device or controller device of a network) may include any suitable special purpose hardware (e.g., hardware support of high-speed packet processing, hardware support of machine learning algorithms, etc.). An application 119 may provide a user or a communicatively coupled device with the ability to interact with an electronic auction service or the EASP of EAS subsystem 10, where such an application 119 may be a third party application that may be running on subsystem 100 (e.g., an application (e.g., software and/or firmware) or at least one API associated with EAS subsystem 10 that may be loaded on or otherwise made accessible to subsystem 100 from or with EAS subsystem 10 or via an application market) and/or that may be accessed via an internet application or web browser running on subsystem 100 (e.g., processor 112) that may be pointed to a URL whose target or web resource may be at least partially managed by EAS subsystem 10 or any other remote subsystem. Each subsystem 100 may be a portable media device (e.g., a smartphone), a laptop computer, a tablet computer, a desktop computer, an appliance, a wearable electronic device, a virtual reality device, a dongle device, at least one web or network server (e.g., for providing an online resource, such as a website or native online application or widget, for presentation on one or more other subsystems) with an interface for an administrator of such a server, and/or the like. Each subsystem 100 may be any portable, mobile, wearable, implantable, or hand-held electronic device configured to operate with system 1. Alternatively, subsystem 100 may not be portable during use, but may instead be generally stationary. Subsystem 100 can include, but is not limited to, a media player, video player, still image player, game player, other media player, music recorder, movie or video camera or recorder, still camera, other media recorder, radio, medical equipment, domestic appliance, smart appliance (e.g., smart door knob, smart door lock, etc.), transportation vehicle instrument, musical instrument, calculator, cellular telephone, other wireless communication device, personal digital assistant, remote control, pager, computer (e.g., a desktop, laptop, tablet, server, etc.), monitor, television, stereo equipment, set up box, set-top box, wearable device (e.g., an Apple Watch™ by Apple Inc.), boom box, modem, router, printer, kiosk, beacon, server, and any combinations thereof that may be useful as a subsystem in system 1.

EAS subsystem 10 may include a housing 11 that may be similar to housing 111, a processor component 12 that may be similar to processor 112, a memory component 13 that may be similar to memory component 113, a communications component 14 that may be similar to communications component 114, a sensor component 15 that may be similar to sensor component 115, an I/O component 16 that may be similar to I/O component 116, a power supply component 17 that may be similar to power supply component 117, and/or a bus 18 that may be similar to bus 118. Moreover, EAS subsystem 10 may include one or more applications 119 and any suitable data structure(s) 119d that may include any suitable data or one or more applications (e.g., any application similar to application 119 and/or data structure(s) 119d) for facilitating an electronic auction service or EASP that may be provided by EAS subsystem 10 in conjunction with one or more subsystems 100. Some or all portions of EAS subsystem 10 may be operated, managed, or otherwise at least partially controlled by an entity (e.g., administrator) responsible for providing an electronic auction service to one or more clients or other suitable entities.

EAS subsystem 10 may communicate with one or more subsystems 100 via communications network 50. Network 50 may be the internet or any other suitable network, such that when intercoupled via network 50, any two subsystems of system 1 may be operative to communicate with one another (e.g., a subsystem 100 may access information (e.g., application 19 or otherwise from data 19d of EAS subsystem 10, as may be provided as an electronic auction service via processor 12 and communications component 14 of EAS subsystem 10) as if such information were stored locally at that subsystem 100 (e.g., as application 119 and/or data structure(s) 119d in memory component 113)).

Various clients and/or partners may be enabled to interact with EAS subsystem 10 for enabling the electronic auction services and the EASP. For example, at least one buyer end user subsystem of system 1 (e.g., each one of the one or more buyer end user subsystems 100a-100g) may be any suitable subsystem (e.g., computer) operated by any suitable auction bidder or buyer end user (“BEU”) or otherwise that may be interested in bidding on one or more auctions for purchasing, leasing, renting, or otherwise obtaining any suitable goods or services (e.g., auctioned product). Such a BEU may be an incorporated business that purchases any suitable goods or services through an auction of the EASP (e.g., a business entity) or a solo independent being (e.g., a human entity) that may interface with EAS subsystem 10 for bidding on one or more auction items to facilitate a purchase of one or more goods or services using the EASP. At least one seller end user subsystem of system 1 (e.g., each one of the one or more seller end user subsystems 100h-100j) may be any suitable subsystem (e.g., computer) operated by any suitable auction product owner or seller end user (“SEU”) or otherwise that may seek to sell or otherwise transfer any suitable goods or services (e.g., auctioned product). Such an SEU may be an incorporated business that offers any suitable goods or services through an auction of the EASP (e.g., a business entity) or a solo independent being (e.g., a human entity) that may interface with EAS subsystem 10 for offering up one or more auction items to facilitate a transfer of one or more goods or services using the EASP. At least one third party enabler subsystem of system 1 (e.g., each one of the one or more third party enabler subsystems 100k-100m) may be any suitable subsystem (e.g., computer) operated by any suitable third party enabler (“TPE”) that may be operative to enable at least partially any suitable operation provided by the EASP, such as a third party application or service provider that may be operative to process or provide any suitable subject matter that may be used by any other suitable subsystem of system 1 for enabling an electronic auction using the EASP (e.g., financial institutions (e.g., banks) or other suitable entities that may provide any suitable financial information or credit scores for any suitable users or products of the platform (e.g., information management service and credit information service entities, from which data may be collected by any suitable data hub or data management system (“DMS”) and shared with the EASP), third party payment processing providers, risk management research entities, ancillary goods/services provisioning entities, backup and recovery provider entities, any suitable underwriting entities, loan servicer entities, financial transaction electronic network entities, electronic signature facilitator entities, any suitable investor entities, any suitable social network entities that may provide any suitable connection information between various parties, government agencies/regulators, licensing bodies, third party advertisers, owners of relevant data, sellers of relevant goods/materials, software providers, maintenance service providers, scheduling service providers, and/or any other suitable third party service provider that may be distinct from a BEU subsystem, SEU subsystem, and/or EAS subsystem 10).

Each subsystem 100 of system 1 (e.g., each one of subsystems 100a-100m) may be operated by any suitable entity for interacting in any suitable way with EAS subsystem 10 (e.g., via network 50) for deriving value from and/or adding value to a service of the EASP of EAS subsystem 10. For example, a particular subsystem 100 may be a server operated by a client/partner entity that may receive any suitable data from EAS subsystem 10 related to any suitable electronic auction enhancement of the EASP provided by EAS subsystem 10 (e.g., via network 50). Additionally or alternatively, a particular subsystem 100 may be a server operated by a client/partner entity that may upload or otherwise provide any suitable data to EAS subsystem 10 related to any suitable electronic auction service of the EASP provided by EAS subsystem 10 (e.g., via network 50). Although system 1 and many subsystems of system 1 may be described herein with respect to the auction of product (e.g., chemical product) auctioned in lots of a number of MTs, it is to be understood that the auctioned product may be of any suitable type auctioned in any suitable amounts (e.g., shirts on a per shirt basis, hotel rooms in blocks of 5 rooms, top of website banner advertisements in blocks of 9 websites, commodities (e.g., agricultural, products, metals, minerals, etc.), services (e.g., logistics, etc.), or any other suitable type of product (e.g., good and/or service) that may be auctioned as multiple lots to multiple buyers in a single auction according to one or more of the concepts of this disclosure).

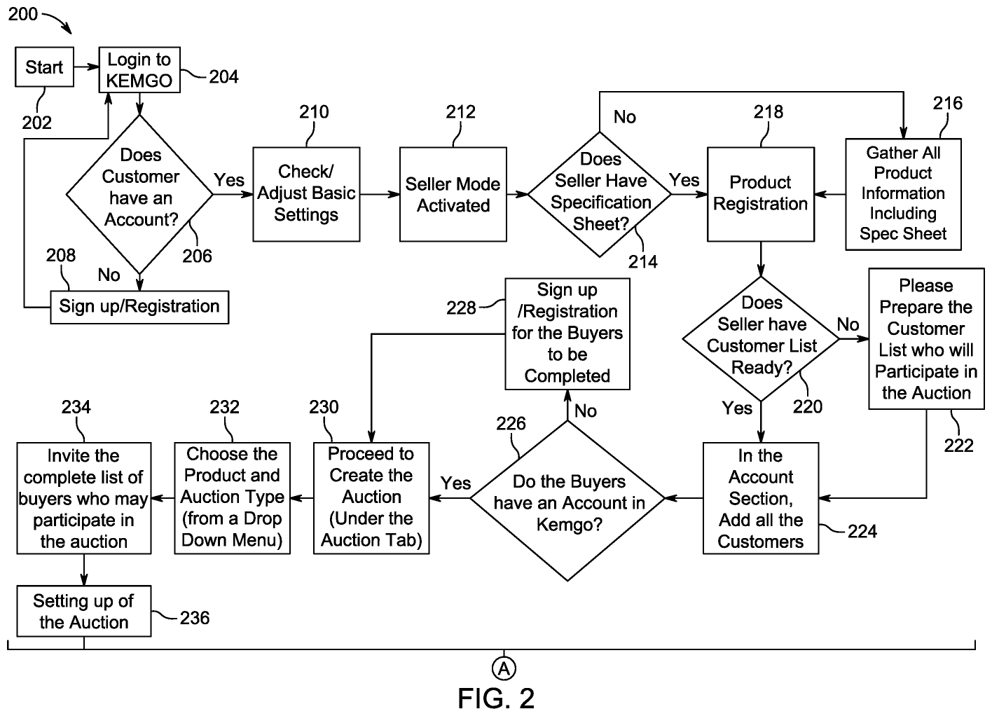

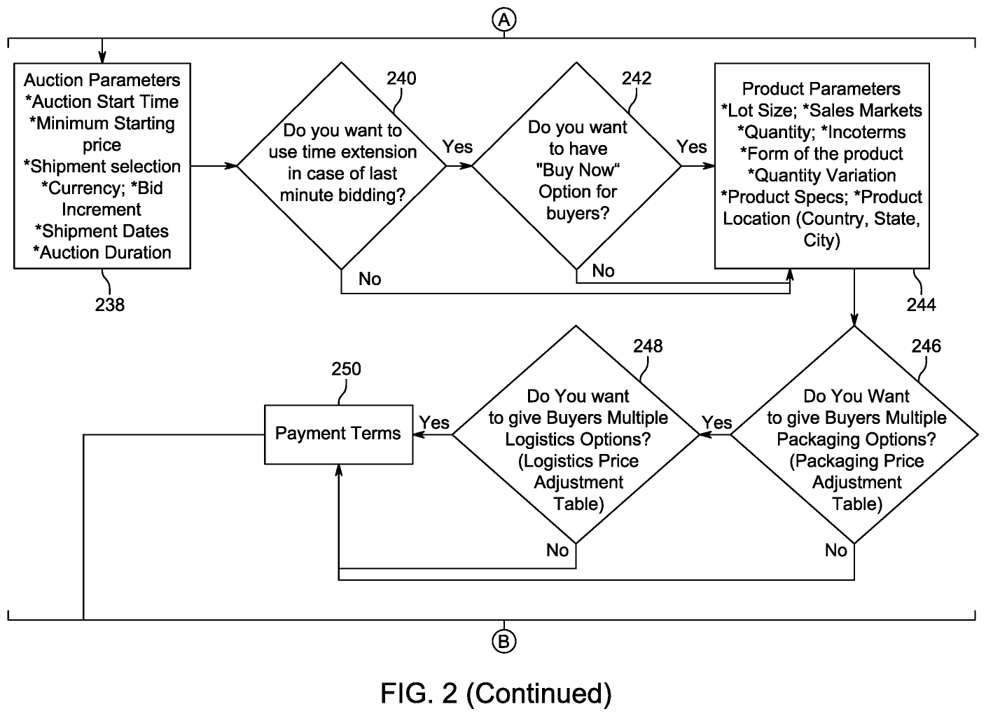

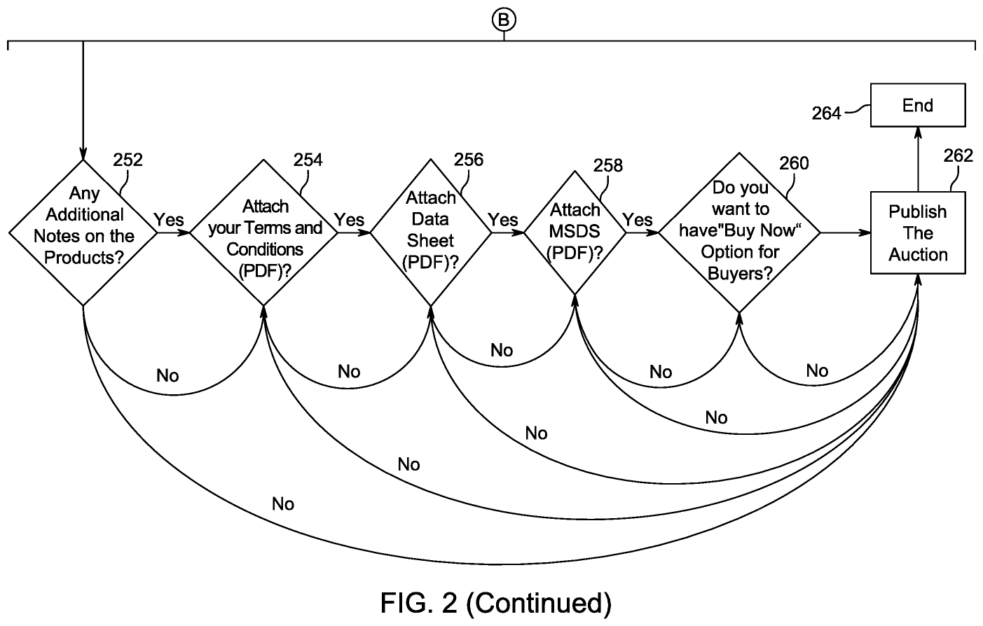

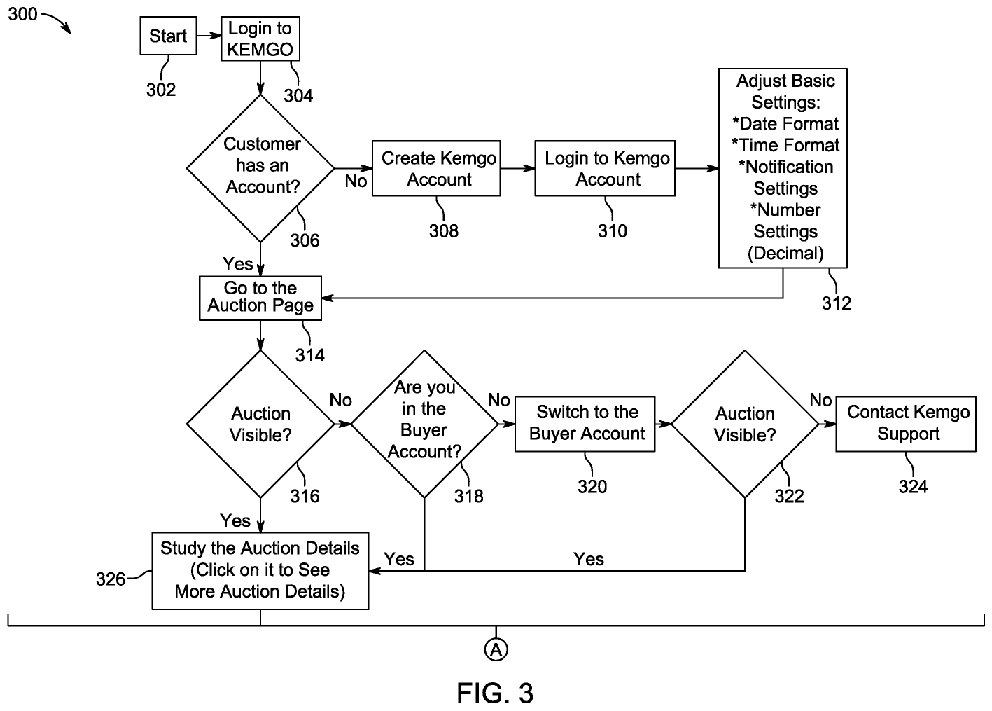

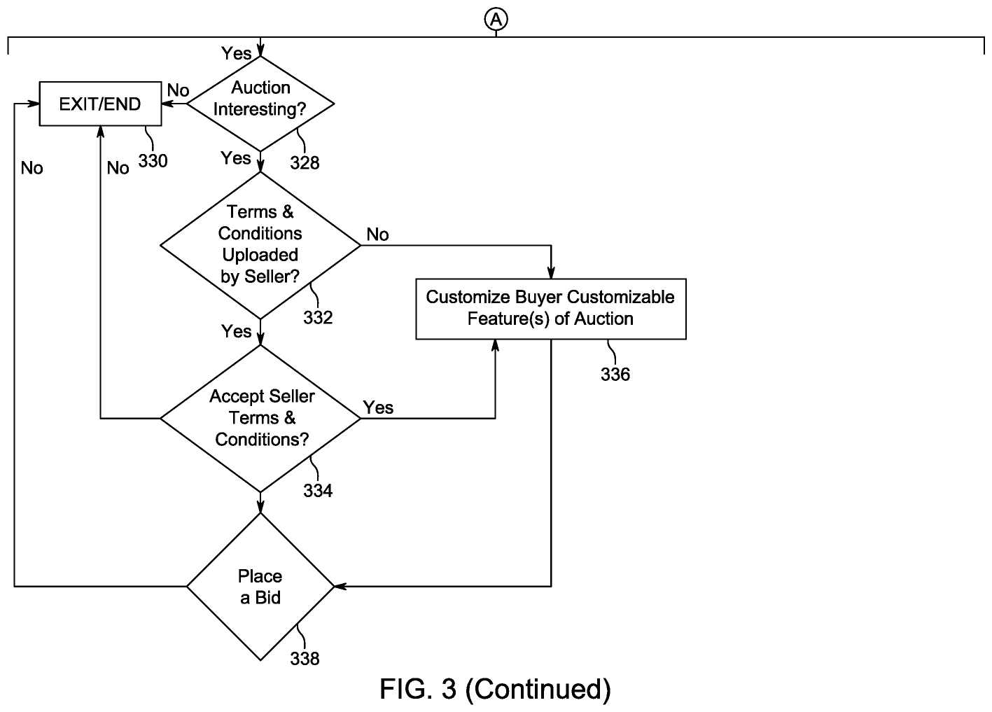

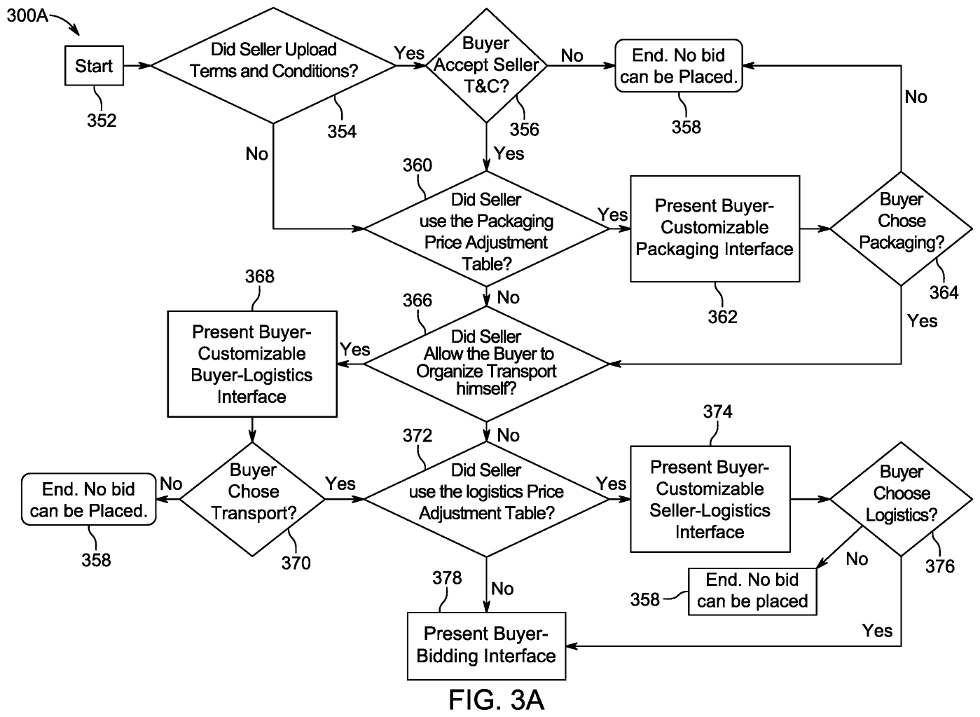

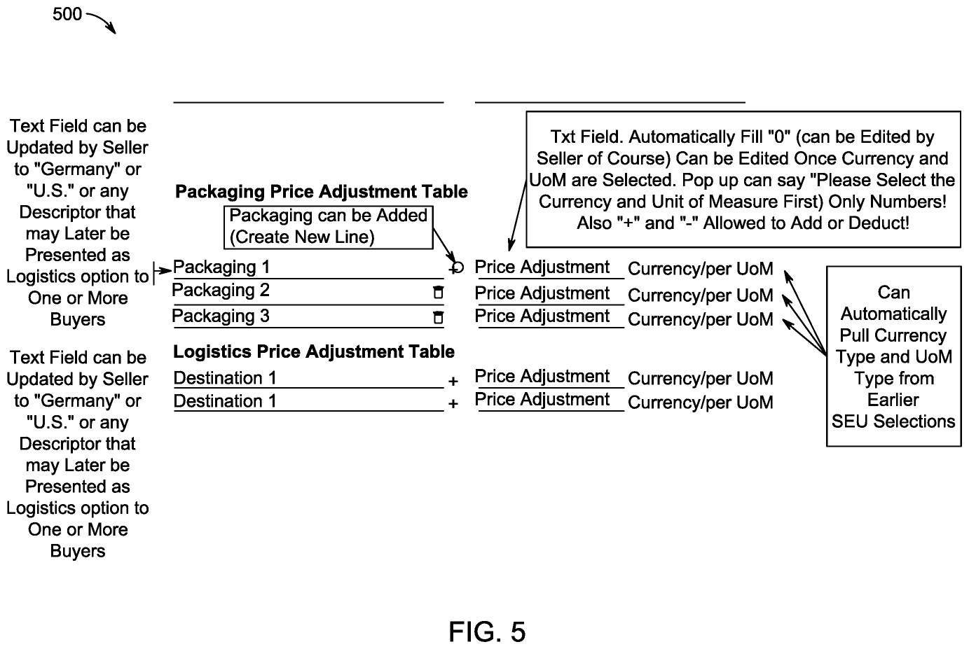

FIG. 2 is a flowchart of an illustrative auction seller setup process 200 that may be implemented by the EASP (as may be otherwise referred to herein as “Kemgo”) and various subsystems of system 1. However, it is to be understood that process 200 may be implemented using any other suitable components or subsystems. Process 200 may provide a seamless seller end user experience for securely and effectively and efficiently setting up an auction of any suitable seller product that is to be facilitated by the EASP for one or more buyers. To facilitate the following discussion regarding the operation of system 1 for setting up an auction according to process 200 of FIG. 2, reference is made to various components of system 1 of the schematic diagrams of FIGS. 1 and 1A, to various specific subprocesses of an illustrative process 300 of FIG. 3, and to one or more of front views of screens 500-900B of FIGS. 5-9B that may be representative of various graphical user interfaces (“GUIs”) of one or more subsystems of system 1 during process 200 of FIG. 2. The operations described may be achieved with a wide variety of graphical elements and visual schemes. Therefore, the embodiments of the GUIs of FIGS. 5-9B are not intended to be limited to the precise interface conventions adopted herein. Rather, embodiments may include a wide variety of interface styles, including some that may be at least partially non-visual, but rather at least partially aural and/or tactile or otherwise configured to convey information to and/or receive information from one or more end users.

At operation 202, process 200 may start and proceed to operation 204, although it is to be understood that an auction seller setup process may alternatively start by proceeding to any other suitable operation. At operation 204 of process 200, an SEU may be prompted by the EASP (e.g., on any suitable interface of any suitable SEU subsystem (e.g., one of SEU subsystems 100h-100j of system 1)) to log in to a particular account on the EASP (e.g., using any suitable username and password or other suitable credential verification system). At operation 206 of process 200, the EASP may determine whether or not the SEU has a verified account on the EASP. If not, process 200 may proceed from operation 206 to operation 208 for enabling the SEU to sign-up/register with the EASP before proceeding back to operation 204 so that the SEU may now properly log in to its new account with the EASP. However, if the SEU is determined to have a verified account on the EASP at operation 206, process 200 may proceed to operation 210, where the EASP may enable the SEU to check and/or adjust any basic platform settings associated with that SEU, as may be desired, where such settings may include, but are not limited to, date format, time format, notification settings, number settings (e.g., decimal settings), and/or the like. Then, at operation 212 of process 200, the EASP may enable the SEU to activate that end user's account's “seller mode” for this auction seller setup (e.g., as EASP end user accounts may be provided with the option of choosing between seller and buyer mode depending on the type of user selected during registration (e.g., distributors), where the platform may remember the last mode used and the user can toggle between modes depending on the reason for why they are currently using their EASP account).

At operation 214 of process 200, the EASP may determine whether or not the SEU has registered a product to be auctioned. If not, process 200 may advance to operation 216, where the EASP may enable the SEU to register a product in an EASP database by gathering any or all product information regarding a product to be auctioned, including, for example, a specification sheet. Entering of specification information digitally (e.g., versus just as an attachment) with the EASP may allow for more advanced search features on products, such as down to the specification level. After operation 216 or after an affirmative determination at operation 214, process 200 may advance to operation 218, where the EASP may register the product (e.g., in any suitable database accessible by the EASP).

At operation 220 of process 200, the EASP may determine whether or not the SEU has a customer list prepared. If not, process 200 may advance to operation 222, where the EASP may enable the SEU to generate a list of customers (e.g., buyers) who may participate in the auction being set up by enabling entry of customer details and placing one or more customers into one or more groups, as may be desired. The EASP may, therefore, provide an online auction functionality that may allow for multiple buyers to be organized in groups and for the seller to be able to invite groups and/or buyers to participate in an online auction. After operation 222 or after an affirmative determination at operation 220, process 200 may advance to operation 224, where the EASP may add the list of customers in a customer account section of the SEU's EASP account (e.g., in any suitable database accessible by the EASP). At operation 226 of process 200, the EASP may determine whether or not each of one or more of the seller's customers (e.g., as identified generally at operation 224 or as may be indicated to be invited to the auction being set up) has a verified account on the EASP. If not, process 200 may proceed from operation 226 to operation 228 for enabling the seller's customer (e.g., a BEU) to sign-up/register with the EASP. In some embodiments, the EASP may request or, alternatively, require a seller to upload information about one or more or all of their customers, where such a customer may have its own entry in a database accessible by the EASP, where such an entry may include any suitable fields, including, but not limited to, name, e-mail address, company, and/or the like. The EASP may be configured in such a way so that a customer's e-mail address may be entered first, such that the EASP may then automatically run a check whereby if the customer is already registered with EASP (e.g., as may be identified through e-mail address (e.g., as a log-in credential)), the customer name and/or company and/or any other suitable field data may be automatically filled by EASP. In some embodiments, only customers registered with a seller may be invited to an auction by the seller, whereby the seller may actively select or choose particular customers to invite to a particular auction. Once selected for a particular auction, such customer(s) may be automatically notified by the EASP (e.g., by e-mail), such as at the time of selection and/or at the time the auction has been defined and/or at the time the auction starts, and/or the like. The EASP may be configured to use an e-mail address as a user identifier to verify the authority to access an auction, where some auctions may only be visible to verified invited customers. A seller can create customer clusters in the EASP. There may be no limitation on the amounts of clusters, such that the EASP may makes it easy for sellers to cluster customers for certain auctions and forego the process of selecting customers individually for each auction.

After operation 228 or after an affirmative determination at operation 226, process 200 may advance to operation 230, where the EASP may enable the SEU to create a new auction (e.g., under an auction tab of a user interface of the EASP) in an auction section of the SEU's EASP account (e.g., in any suitable database accessible by the EASP). At operation 232, the EASP may enable the SEU to choose a particular product (e.g., as registered at operation 218) and a particular auction type (e.g., from a drop down menu or via any suitable interface configuration) that the SEU would like to use for auctioning the chosen product on the EASP (e.g., English, Dutch, allocation, English-Yankee, English revers, Dutch reverse, etc.). At operation 234, the EASP may enable the SEU to select the complete list of seller customers that the SEU would like to invite to this auction as buyers (e.g., from the list of customers determined at operation 224), and the EASP may associate and save this selected buyer list with the particular type of auction and product to be auctioned in the auction section of the SEU's EASP account (e.g., in any suitable database accessible by the EASP). Next, at operation 236, the EASP may further set up the auction, which may include proceeding to operation 238, where the EASP may enable one or more auction parameters to be defined, customized, and/or otherwise associated with the auction being set up for the SEU. Such auction parameters of operation 238 (e.g., that may be defined and customized by the SEU or automatically by the EASP) may include, but are not limited to, auction start time (e.g., when the one or more buyers will be allowed to start participating in the auction), minimum starting price (e.g., minimum price per lot (or per unit) that a buyer may be able to bid during the auction for product that has not yet been bid on or that does not have a current active bid), shipment selection (e.g., type of shipment (e.g., while setting up an auction, the EASP can enable a seller to select what kind of shipment process will take place (e.g., “Organized by Seller”, “Organized by Buyer”, “Buyer can Select”, “According to Incoterm”, etc.))), currency, bid increment (e.g., minimum increment that any buyer would need to make to the value of a current successful/active bid in order for that buyer to submit a successful bid for at least a portion of that current active bid), shipment date(s) (e.g., when an auctioned product will be shipped after being won in the auction), auction duration, and/or the like. In some embodiments, the EASP may enable a seller to choose whether or not to define a minimum starting price for the auction. If defined, the EASP may be configured to prevent a buyer from placing a bid that is below the minimum starting price. In such embodiments, the EASP may be configured to enable a seller to prevent the buyer from being able to see the chosen minimum starting price even though the EASP may still not allow the buyer to enter a price below the minimum starting price (e.g., for various auction types, although English-Yankee auction types may not allow buyers to enter a price below a minimum allowable bid price but may still enable a buyer to see a minimum allowable bid price (e.g., as may be customized to that buyer for the particular current auction status)). At operation 240, the EASP may enable the SEU to choose whether or not to allow the auction duration to be extended in certain circumstances (e.g., extend the auction by 60 seconds if a new successful bid is received by the EASP with less than 30 seconds currently remaining in the auction (e.g., sniping), where such an extension may be configured to only be allowed a maximum of 10 times (e.g., such that an auction pre-defined to have a 60 minute duration may be actually no longer than 70 minutes)). At operation 242, the EASP may enable the SEU to choose whether or not to provide a “buy now” feature for the buyers during the auction (e.g., a feature that may allow the seller to define a “buy now price” that is higher than the minimum starting price but that may reflect a price level for which the seller would agree to instantly end the auction (e.g., if the minimum price for product A is set at $800.00 per MT and the buy now price is set at $1,200.00 per MT, a bid will need to be a minimum of $800.00 per MT to be made, but if a buyer successfully places a bid of $1,200.00/MT or higher for all of the lots of the auction, the auction may be immediately terminated by the EASP regardless of how much time is left)). In some embodiments, a seller may set different buy now prices for different possible bid quantities (e.g., $1,200.00/MT for 1 lot (e.g., 25 MTs), $1,100.00/MT for 2 lots (e.g., 50 MTs), . . . $999.00/MT for all 12 lots (e.g., 300 MTs)), such that a particular buyer could immediately win a bid for a particular lot size if bidding a particular buy now bid price, even if the auction were not to end after that bid is made (e.g., if more lot sizes remain unbid on or bid on for less than the buy now price). No matter the determination(s) at operations 240 and 242, process 200 may proceed to operation 244, where the EASP may further set up the auction by enabling one or more product parameters to be defined, customized, and/or otherwise associated with the auction being set up for the SEU. Such product parameters of operation 244 (e.g., that may be defined and customized by the SEU or automatically by the EASP) may include, but are not limited to, lot size (e.g., amount of how the total volume may be divided into smaller quantities or “lots” (e.g., this parameter may be unique to English-Yankee auctions)), a minimum unit of measure (“UoM”) of product being auctioned, quantity (e.g., total number of units of product being auctioned), sales markets (e.g., geographic markets (e.g., global regions, countries, sub-regions, cities, etc.) that the product in question may be sold in (e.g., one or many markets)), incoterms (e.g., logistics terms (e.g., CFR (Cost and Freight (named port of destination)), CIF (Cost, Insurance & Freight (named port of destination)), FOB (Free on Board (named port of shipment)), EW (Ex Works (named place of loading)), DATDDP, DDP (Delivered Duty Paid (named place of destination)), FCA (Free Carrier (named place of delivery)), DAP (Delivered at Place (named place of destination)), CPT (Carriage Paid To (named place of destination)), CIP (Carriage and Insurance Paid to (named place of destination)), FAS (30 days from B/L, Free Alongside Ship (named port of shipment)), CAP (Customer arranged pick-up), etc.)), product form (e.g., the form in which the product may be (e.g., best quality (prime), old product, expired product, etc. (e.g., PRIME, REWORK, REPRO, GENERIC, WIDE SPEC, NEAR SPEC, TRANSITION, ON SPEC, OFF SPEC, etc.))), variations in quantity (e.g., quantities may not always be exact, but a +/−percentage on total quantity may be applied (e.g., +/−1% to +/−10%)), product specifications (e.g., a product may have its own specification sheet that may describe the product's specifications and features, which may be an important element for buyers to know exactly what they are buying), product location (e.g., where the product currently resides geographically (e.g., country, state, city)), and/or the like.

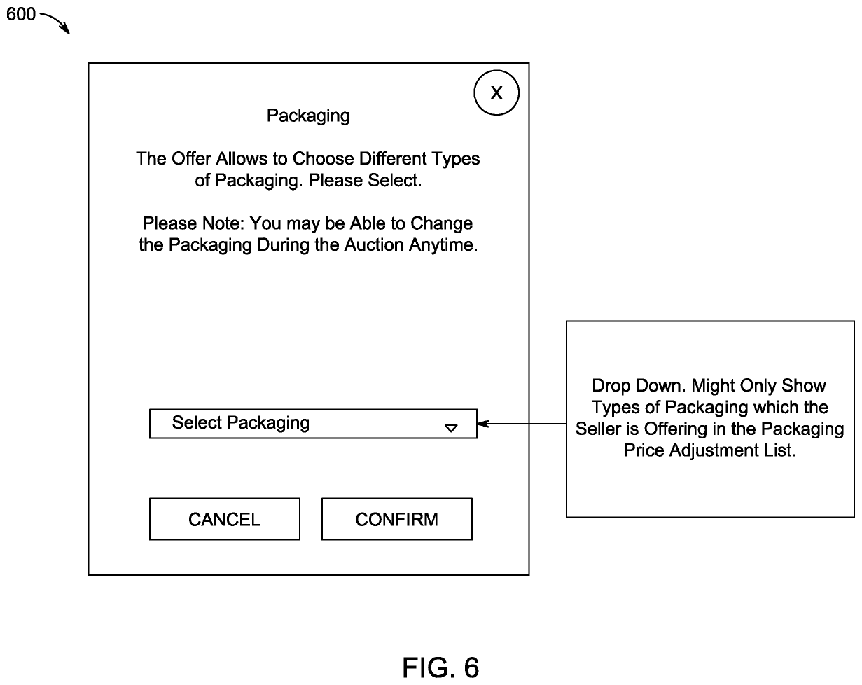

At operation 246, the EASP may enable the SEU to choose whether or not to provide the buyers with multiple packaging options (e.g., via one or more packaging price adjustment tables). If so, the EASP may provide the SEU with any suitable interface for defining such packaging options. For example, as shown by the (annotated) GUI of screen 500 of FIG. 5 (e.g., as may be presented by the EASP to an SEU via any suitable SEU subsystem (e.g., on any suitable interface of any suitable SEU subsystem (e.g., one of SEU subsystems 100h-100j of system 1))), a packaging price adjustment table of the EASP may enable an SEU (i) to select or define two or more various packaging options that may later be provided to a buyer of the auction (e.g., as shown by the (annotated) GUI of screen 600 of FIG. 6), and (ii) to select a particular price adjustment for each selected packaging option that may be defined as a particular amount of currency (e.g., as may be defined at operation 238) per UoM (e.g., as may be defined at operation 244). For example, the seller may choose to offer large quantities (e.g., liquid pure alcohol) and the seller might not care if the customer wants the product to be packaged in a bulk truck, or drums, or any other packaging type. However, a bulk truck may be cheaper than drums, such that the seller may define a bulk truck packaging option with a price adjustment of $0.00/MT and a drums packaging option with a price adjustment of +$20.00/MT and an octabins packaging option with a price adjustment of +$50.00/MT. Later, when the EASP may enable various particular buyers to customize their own experiences with this particular auction (e.g., as may be described in more detail with respect to FIGS. 3, 3A, and 6-8), different buyers may select different ones of these provided packaging options, such that a first buyer who has selected the drums packaging option before beginning the auction may then during the auction be presented by the EASP with minimum bid prices that have been adjusted upwards by +$20.00/MT (e.g., by operation 410 of process 400), such that a second buyer who has selected the bulk truck packaging option before beginning the auction may then during the auction be presented by the EASP with minimum bid prices that have not been adjusted upwards by +$20.00/MT but rather by $0.00/MT (e.g., by operation 410 of process 400), and such that a third buyer who has selected the octabins packaging option before beginning the auction may then during the auction be presented by the EASP with minimum bid prices that have been adjusted upwards by +$50.00/MT (e.g., by operation 410 of process 400). Therefore, in some embodiments, every invited buyer can choose in between 3 different packaging types, such that 3 different buyers could see 3 different minimum prices, dependent on the chosen packaging type. In other words, while the base price may be the same for every buyer (e.g., the minimum beginning bid of $800.00/MT), once the buyer selects a packaging type, the price may be adjusted automatically and individually. In some embodiments, the EASP may be configured such that only the seller is privy to the difference in price between the various packaging options (e.g., the difference may be defined by the seller at screen 500), whereas a particular buyer may only be enabled by the EASP to choose from the various packaging options without seeing the difference in price (e.g., at screen 600). Additionally or alternatively, any other suitable packaging options may be enabled by the seller and optionally selected by one or more buyers, including more complex options such as enabling a user to select a first packaging option if the bid is for a first range of lots (e.g., drums packaging if bid is for 6 lots or less) and a second packaging option if the bid is for a second range of lots (e.g., bulk trucks packaging if bid is for 7 lots or more). Various types of packaging may be offered, which may vary based on type of product being auctioned. For example, for a chemical product auction, the packaging types may include, but are not limited to, Drums, IBC, Big Bags 1000 kg, Big Bags 750 kg, Pallets, Pallets—Heat Treated, Bulk, Octabin, Gaylord, Isocontainers, Flexibags, Pails, Railtank, Road Tanker, Chemical Tanker, Barge, Pipeline, Bags, Bags 25 kg, Bags 50 kg, Dry Bulk, 20 ft Container—Bags, 40 ft Container—Bags, 20 ft Container—Bags—Heat Treated, 40 ft Container—Bags—Heat Treated, Bags 1000 kg, Cargo Tank, Bulk Truck, 20 ft Container—Bulk, 40 ft Container—Bulk, Drum 200 Litre, Container 25 Litre, Container 2.5 Litre, Drum, Container, Drum 200 kg, Drum 250 kg, IBC 1 MT, IBC—1 MT, Drum 55 gallon, Pail 5 Gallon, Pail 1 Gallon, Pail 20 kg, Bags 20 kg, Can, Bottle, ISO Container, Aerosol Can, Plastic Can, Metal Can, Big Bag 800 kg, Box, Bag, 20 ft container—loose bags, 40 ft container—loose bags, Drum 20 kg, Drum 25 kg, Drum 30 kg, Drum 220 kg, Jumbo Bags—1000 kg, Jumbo Bags, Big Bags, Drum 208 litre, IBC—10001, Railway Bulk, Railway Tank, Barge Chemical Bulk, Barge Dry Bulk, Individual Packaging, Fibre Drum—25 kg, Fibre Drum—100 kg, Big Bag—450 kg, Big Bag—475 kg, Big Bag—530 kg, Big Bag—550 kg, Big Bag—625 kg, Big Bag—780 kg, Big Bag—900 kg, Drum 50 kg, Drums 10 kg, Drum 190 kg, Parcel—10.5 m², Parcel—3.6 m³, Drum 240 kg, IBC 1200 kg, Bucket/Jerry Can 35 kg, Drum 150 kg, Drum 90 kg, Drum 230 kg, Carton, Drum 140 kg, FIBC, FIBC 500 kg, FIBC 1000 kg, 1.5 kg box, 1.5 kg box (6×0.25 kg), 1500 gram box, 1.5 kg box (6×250 gram), Hopper Car, Container 1 Litre, Container 1000 Kg, 170 kg Steel Drum, 180 kg Steel Drum, and/or the like.

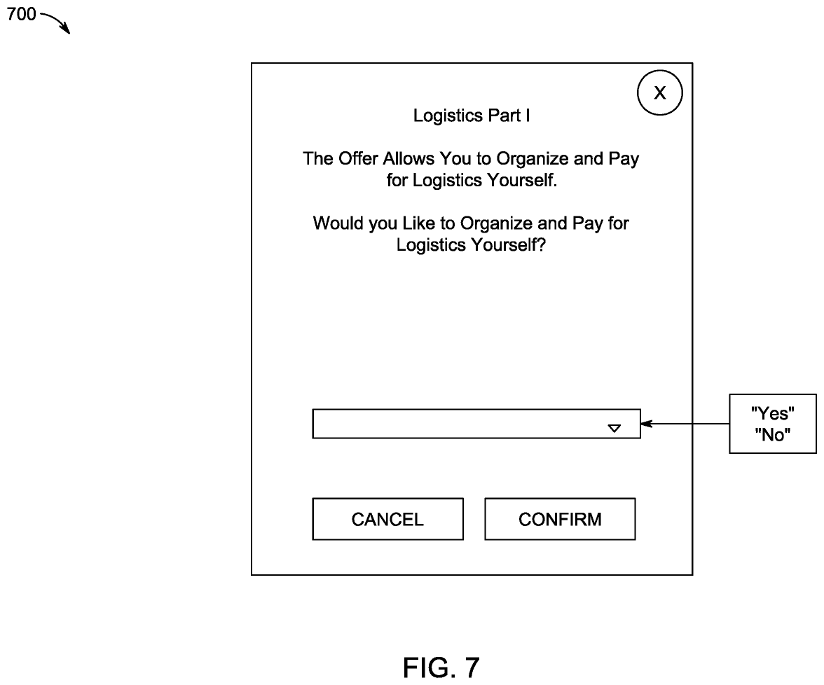

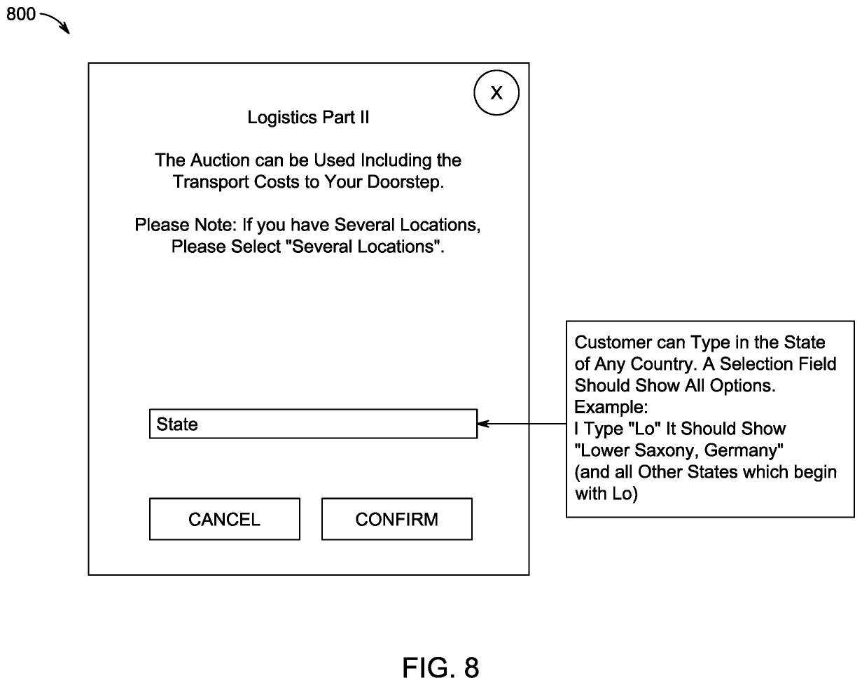

At operation 248, the EASP may enable the SEU to choose whether or not to provide the buyers with multiple logistics options (e.g., via one or more logistics price adjustment tables). If so, the EASP may provide the SEU with any suitable interface for defining such logistics options. For example, as shown by the (annotated) GUI of screen 500 of FIG. 5 (e.g., as may be presented by the EASP to an SEU via any suitable SEU subsystem), a logistics price adjustment table of the EASP may enable an SEU (i) to select or define two or more various logistics options that may later be provided to a buyer of the auction (e.g., as shown by the (annotated) GUI of screen 700 of FIG. 7 and/or the (annotated) GUI of screen 800 of FIG. 8), and (ii) to select a particular price adjustment for each selected logistics option that may be defined as a particular amount of currency (e.g., as may be defined at operation 238) per UoM (e.g., as may be defined at operation 244). For example, the seller may choose to offer large quantities (e.g., liquid pure alcohol) and the seller might not care if the buyer wants to pay for shipping itself or whether the seller should handle the shipping and have it baked into the bidding price (e.g., as may later be selected by the buyer at the GUI of screen 700 of FIG. 7). However, if shipping logistics is to be handled by the seller, different destination locations for shipping may be offered by the seller for different prices. For example, shipping to Germany may be cheaper for the seller than shipping to Japan, such that the seller may define a shipping option to Germany with a shipping price adjustment of $40.00/MT and a shipping option to Japan with a shipping price adjustment of +$100.00/MT. Later, when the EASP may enable various particular buyers to customize their own experiences with this particular auction (e.g., as may be described in more detail with respect to FIGS. 3, 3A, and 6-8), different buyers may select different ones of these provided shipping options, such that a first buyer who has selected the Germany shipping option before beginning the auction may then during the auction be presented by the EASP with minimum bid prices that have been adjusted upwards by +$40.00/MT (e.g., by operation 410 of process 400), such that a second buyer who has selected the Japan shipping option before beginning the auction may then during the auction be presented by the EASP with minimum bid prices that have not been adjusted upwards by +$40.00/MT but rather by $100.00/MT (e.g., by operation 410 of process 400), and such that a third buyer who has selected buyer self-shipping option before beginning the auction may then during the auction be presented by the EASP with minimum bid prices that have not been adjusted for shipping at all (e.g., by operation 410 of process 400) but with the understanding that the buyer must pay for all shipping costs if/when he wins an auction. Therefore, the EASP may be configured to allow the maintenance of a logistics price adjustment table. The seller can maintain the table and determine freight rates per city, state, country, or region. Every buyer can be enabled by the EASP to choose from the offered selections and may be provided with an updated individual minimum bid price during the auction. In some embodiments, the EASP may be configured such that only the seller is privy to the difference in price between the various shipping options (e.g., the difference may be defined by the seller at screen 600), whereas a particular buyer may only be enabled by the EASP to choose from the various shipping options without seeing the difference in price (e.g., at screen 700 and/or screen 800). As an example, in a particular type of English-Yankee auction, the seller may be using multiple options, product pricing, logistics options, packaging options, and/or the like, but for the buyer it may be always a bundled product (e.g., one price that includes everything). As another example, a logistics option that may be enabled by the EASP may be a price adjustment that rewards buying larger quantities (e.g., if a particular buyer wins more than 6 lots, the shipping cost is reduced by −$5.00/MT), which may induce a buyer to bid for more lots (e.g., the savings may be apparent at least to some degree in the minimum bid graph due). Any other suitable logistics options may be enabled by the EASP in addition to or as an alternative to geography-based shipping, including various types of incoterms. Different logistics options may be enabled depending on a particular selected packaging option. Additionally or alternatively, any other suitable logistics options may be enabled by the seller and optionally selected by one or more buyers, including more complex options such as enabling a user to select a first destination shipping option if the bid is for a first range of lots (e.g., shipping to Germany if bid is for 6 lots or less) and a second shipping option if the bid is for a second range of lots (e.g., shipping to Japan if bid is for 7 lots or more) or a third shipping option for half of the lots if the bid is for a second range and a fourth shipping option for the other half (e.g., if bid is for 7 or more lots, ship half to Japan and half to Germany, with greater amount to Germany if even halves is not possible). As another example, there could be further complications where once a certain packaging is chosen by the buyer, the lot size and logistics options can change accordingly (e.g., a certain buyer may choose 25 kg bags, so the lot size may be in multiples of 25 and logistics may only be offered to Germany and Spain, while another buyer may choose 100 kg packaging so their UI generated by the EASP may be operative only to present options (e.g., minimum bid values) according to the lot sizes in multiples of 100 and logistics may only be offered to USA and Japan).

No matter the determination(s) at operations 246 and 248, process 200 may proceed to operation 250, where the EASP may enable the seller to enter any suitable applicable payment terms and/or payment methods (e.g., the seller may selectively allow or disallow certain payment terms or methods, either auction-wide or on a per-buyer basis). At operation 252, the EASP may be configured to enable the seller to enter any additional notes on the auctioned product or the auction itself, as may be desired. At operation 254, the EASP may be configured to enable the seller to attach or otherwise enter any terms and conditions (e.g., as a PDF or otherwise), as may be desired, which a buyer may be required to agree to before being allowed to participate in the auction. At operation 256, the EASP may be configured to enable the seller to attach or otherwise enter any data sheets (e.g., as a PDF or otherwise), as may be desired, which a buyer may be required to review before being allowed to participate in the auction. At operation 258, the EASP may be configured to enable the seller to attach or otherwise enter any material safety data sheets (“MSDS”) or otherwise (e.g., as a PDF or otherwise), as may be desired, which a buyer may be required to review before being allowed to participate in the auction. At operation 260, the EASP may be configured to enable the seller to attach or otherwise enter any suitable brochure materials or otherwise (e.g., as a PDF or otherwise), as may be desired, which a buyer may be required to review before being allowed to participate in the auction. No matter the determination(s) at operations 252, 254, 256, 258, and/or 260, process 200 may proceed to operation 262, where the EASP may enable the seller to publish the auction on the EASP such that it may be available for the one or more buyers to review and eventually begin such that bids may be placed (e.g., the buyer(s) may be invited to participate via e-mail or otherwise and the auction may eventually go live at the scheduled time). At operation 264, process 200 may end, after which any suitable auction buyer setup process (e.g., process 300 and/or process 400 may be enabled by the EASP for one or more buyers of the auction that has been setup by the seller through process 200). Various other options may be enabled by the EASP to be selectively chosen by a seller when setting up an auction, including, but not limited to, disable arching and expected final price. For example, forward auctions on the EASP may enable (e.g., at operation 238) the feature that a seller can disable the ability to archive an ended auction. This may be chosen when the auction is created. If this feature is chosen by the seller, the auction may be configured not to be made visible by the EASP in a participating buyer's archive, such that a buyer may not be able to access the outcome and/or other suitable details of the auction once the auction has ended (e.g., the bidding history may not be accessible via the EASP to anyone else including the winning buyer if the seller chooses to not make it available). Additionally or alternatively, sellers may be enabled by the EASP to select an expected final price during the auction creation (e.g., at operation 238), where such an expected final price may then not be shared by the EASP with the buyer(s) but may be used by the EASP to automatically detect faulty bids. For example, if an expected final price for an auction is defined to be $1,000.00/MT and a buyer then enters a bid of $10,000.00/MT, the EASP may be configured to automatically compare the two values and create a warning pop up for the buyer if the comparison meets a particular threshold (e.g., bid is at least twice or two-and-a-half or any other suitable magnitude of the value of the expected final price).

It is understood that the operations shown in process 200 of FIG. 2 are only illustrative and that existing operations may be modified or omitted, additional operations may be added, and the order of certain operations may be altered.

FIG. 3 is a flowchart of an illustrative auction buyer customization process 300 that may be implemented by the EASP and various subsystems of system 1 for one or more buyers invited to a seller defined auction (e.g., an English-Yankee auction or any other suitable auction). However, it is to be understood that process 300 may be implemented using any other suitable components or subsystems. Process 300 may provide a seamless buyer end user experience for securely and effectively and efficiently customizing an auction that has been setup by a seller for any suitable seller product that is to be facilitated by the EASP for at least this one buyer. To facilitate the following discussion regarding the operation of system 1 for enabling a buyer to customize a seller-defined auction according to process 300 of FIG. 3, reference is made to various components of system 1 of the schematic diagrams of FIGS. 1 and 1A, to various specific subprocesses of an illustrative process 200 of FIG. 2, and to one or more of front views of screens 500-900B of FIGS. 5-9B that may be representative of various graphical user interfaces (“GUIs”) of one or more subsystems of system 1 during process 300 of FIG. 3. The operations described may be achieved with a wide variety of graphical elements and visual schemes. Therefore, the embodiments of the GUIs of FIGS. 5-9B are not intended to be limited to the precise interface conventions adopted herein. Rather, embodiments may include a wide variety of interface styles, including some that may be at least partially non-visual, but rather at least partially aural and/or tactile or otherwise configured to convey information to and/or receive information from one or more end users.

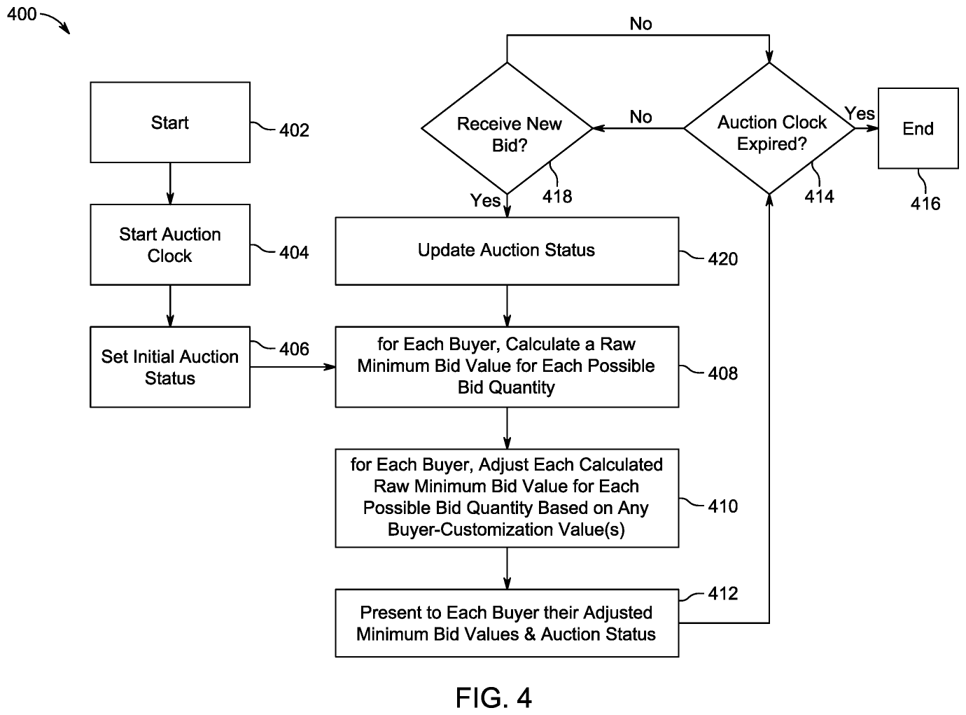

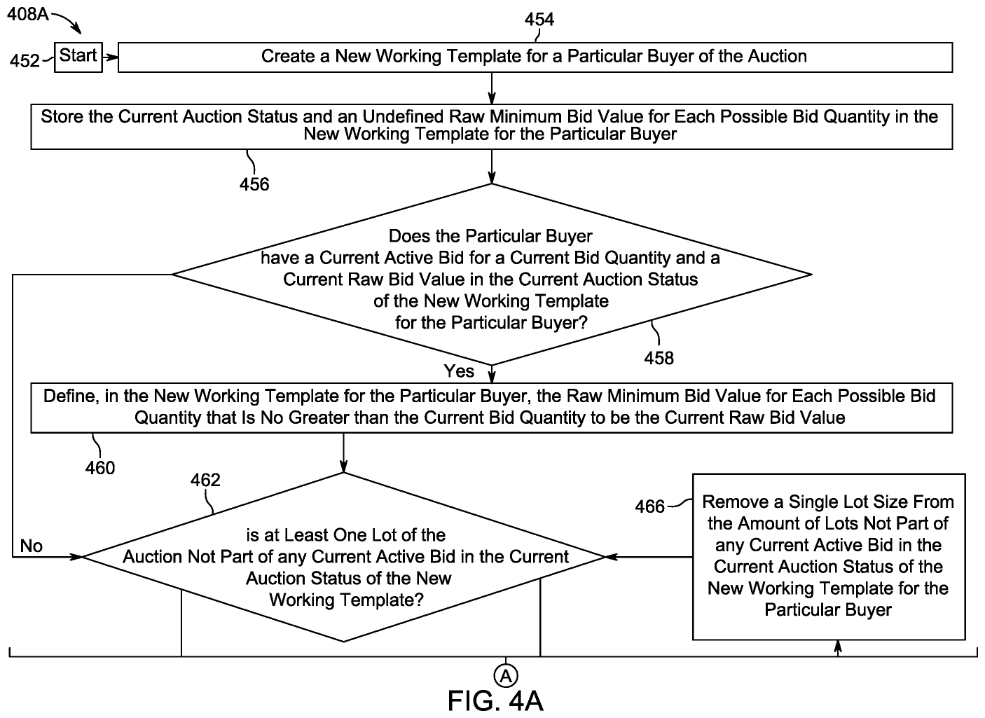

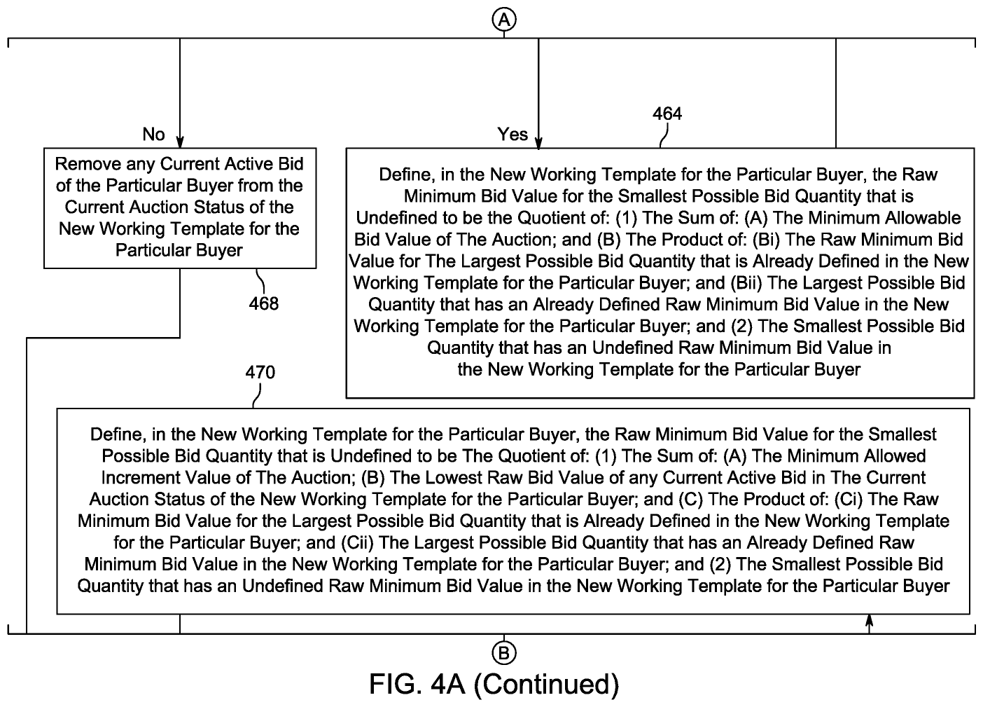

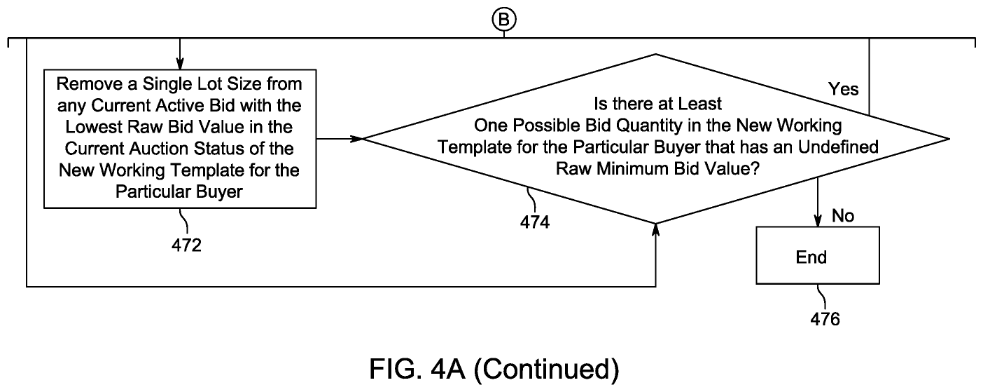

At operation 302, process 300 may start and proceed to operation 304, although it is to be understood that an auction buyer customization process may alternatively start by proceeding to any other suitable operation. At operation 304 of process 300, a BEU may be prompted by the EASP (e.g., on any suitable interface of any suitable BEU subsystem (e.g., one of BEU subsystems 100a-100g of system 1)) to log in to a particular account on the EASP (e.g., using any suitable username and password or other suitable credential verification system). At operation 306 of process 300, the EASP may determine whether or not the BEU has a verified account on the EASP. If not, process 300 may proceed from operation 306 to operation 308 for enabling the BEU to sign-up/register and create an account with the EASP before proceeding to operation 310 so that the BEU may now properly log in to its new account with the EASP and then to operation 312 so that the BEU may then check and/or adjust any basic platform settings associated with that BEU and its verified account, as may be desired, where such settings may include, but are not limited to, date format, time format, notification settings, number settings (e.g., decimal settings), and/or the like. Then, once the BEU has been logged in to a verified account (e.g., via an affirmative operation 306 or after operation 312), the EASP may enable the SEU to activate that end user's account's “buyer mode” for this auction buyer customization process (e.g., as EASP end user accounts may be provided with the option of choosing between seller and buyer mode depending on the type of user selected during registration (e.g., distributors), where the platform may remember the last mode used and the user can toggle between modes depending on the reason for why they are currently using their EASP account), and then advance to the auction page for that buyer at operation 314 (e.g., if the buyer user is invited to a particular auction (e.g., an auction defined by a seller in process 200), that auction may be displayed or otherwise selectable by the buyer on an auction tab and dashboard or otherwise. If an expected auction is determined not to be visible at an operation 316, process 300 may advance to operation 318 to ask the buyer to switch to buyer mode at operation 320 and if still not visible, contact the EASP support features at operation 324. However, if the auction is found and selected by the buyer, process 300 may advance to operation 326 where the EASP may be configured to present any suitable details and/or customizable options to the BEU. Based on the presented details, the EASP may enable the BEU to choose whether or not the auction is of interest to them at operation 328. If not, process 300 may advance to operation 330 and end. Otherwise, process 300 may advance to operation 332 to determine whether any terms and conditions or any other documentation has been provided by the SEU for the auction (e.g., at one or more of operations 252-260 or otherwise of process 200) that is to be explicitly reviewed and/or approved of by a BEU before enabling the BEU to participate in the auction. If so, process 300 may advance to operation 334 where the EASP may prompt the buyer whether or not they accept such terms and conditions (e.g., if so, the EASP may be configured to create a log, including the buyer ID and a time stamp of when the buyer accepted the requisite terms and conditions for a particular auction). If not, process 300 may advance to operation 330 and end. Otherwise, process 300 may advance from operation 334 (or from operation 332 if not in the affirmative) to operation 336, where the EASP may be configured to enable the BEU to personally select any buyer-customizable options that may be available to them for the auction (e.g., any suitable packaging options (e.g., via any suitable GUI, such as the GUI of screen 600 of FIG. 6 (e.g., on any suitable interface of any suitable BEU subsystem (e.g., one of BEU subsystems 100a-100g of system 1))) and/or any suitable logistic options (e.g., via any suitable GUI, such as the GUI of screen 700 of FIG. 7 and/or the GUI of screen 800 of FIG. 8 (e.g., on any suitable interface of any suitable BEU subsystem (e.g., one of BEU subsystems 100a-100g of system 1))) and/or any other suitable buyer-customizable options). After operation 336, process 300 may proceed to operation 338, at which the EASP may enable the BEU to monitor the auction and place one or more bids once the auction starts. The BEU may interact with the EASP throughout the auction until the auction expires or until the BEU actively exits the auction, at which time process 300 may advance from operation 338 to operation 300 and end. When the EASP is enabling the BEU to place a bid at one or more iterations of operation 338 of process 300, the EASP may be configured to require one or more conditions before enabling a BEU bid to be submitted, including, but not limited to, confirming that any bid quantity of any bid attempted to be submitted by the buyer is divisible by the lot size for the auction (e.g., as defined by the seller (e.g., at operation 244 of process 200)), confirming that any bid price of any bid attempted to be submitted by the buyer on an as of yet bidden on quantity is equal to or greater than the minimum starting for the auction (e.g., as defined by the seller (e.g., at operation 238 of process 200)), confirming that any bid price of any bid attempted to be submitted by the buyer on a quantity that already has been successfully bidded on (e.g., by another buyer participating in the same auction) beats the previous successful bid by at least the bid increment of the auction (e.g., as defined by the seller (e.g., at operation 238 of process 200)), and/or the like. As described in more detail with respect to process 400 of FIG. 4, the EASP may be configured to present bidding options to the BEU that enforce one, some, or each of such conditions. During an auction, the EASP may be configured to automatically communicate a notification to a BEU every time a previously successful bid made by that BEU has been beat (e.g., every time the buyer loses a winning position) and/or every time an auction concludes or at any other suitable junction. In some embodiments, the EASP may be configured with tools to enable a winning bidder and seller to complete a transaction after the auction closes (e.g., transfer funds from the buyer to the seller and track shipment of the product).

It is understood that the operations shown in process 300 of FIG. 3 are only illustrative and that existing operations may be modified or omitted, additional operations may be added, and the order of certain operations may be altered.

FIG. 3A is a flowchart of another illustrative auction buyer customization process 300A that may be implemented by the EASP and various subsystems of system 1 for one or more buyers invited to a seller defined auction (e.g., an English-Yankee auction or any other suitable auction). However, it is to be understood that process 300A may be implemented using any other suitable components or subsystems. Process 300A may provide a seamless buyer end user experience for securely and effectively and efficiently customizing an auction that has been setup by a seller for any suitable seller product that is to be facilitated by the EASP for at least this one buyer. To facilitate the following discussion regarding the operation of system 1 for enabling a buyer to customize a seller-defined auction according to process 300A of FIG. 3A, reference is made to various components of system 1 of the schematic diagrams of FIGS. 1 and 1A, to various specific subprocesses of an illustrative process 200 of FIG. 2, and to one or more of front views of screens 500-900B of FIGS. 5-9B that may be representative of various graphical user interfaces (“GUIs”) of one or more subsystems of system 1 during process 300A of FIG. 3A. The operations described may be achieved with a wide variety of graphical elements and visual schemes. Therefore, the embodiments of the GUIs of FIGS. 5-9B are not intended to be limited to the precise interface conventions adopted herein. Rather, embodiments may include a wide variety of interface styles, including some that may be at least partially non-visual, but rather at least partially aural and/or tactile or otherwise configured to convey information to and/or receive information from one or more end users.

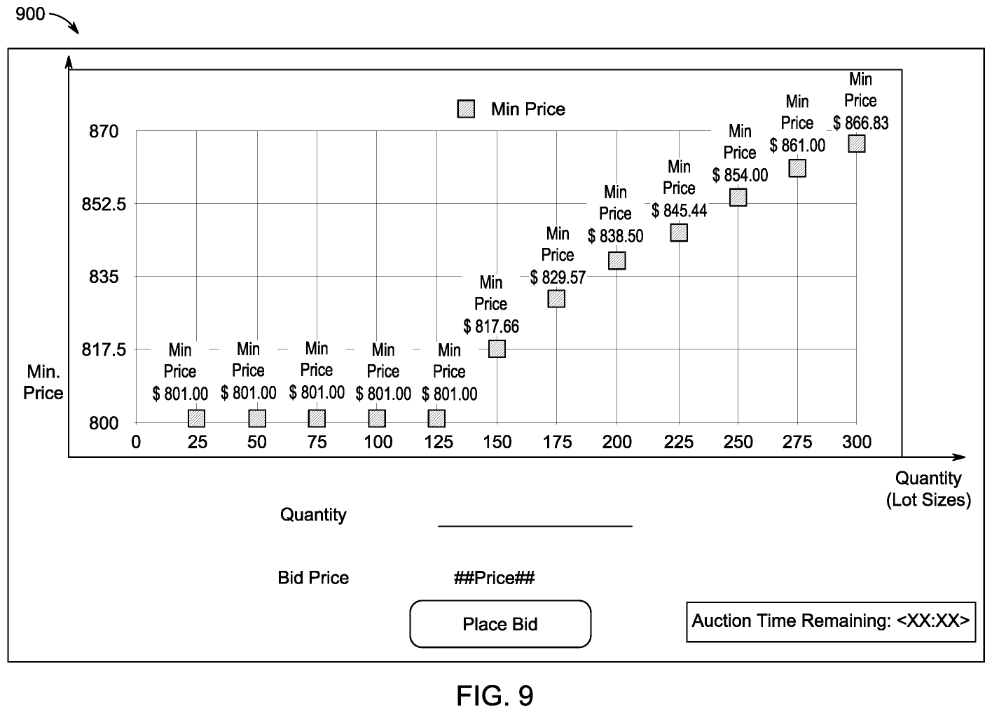

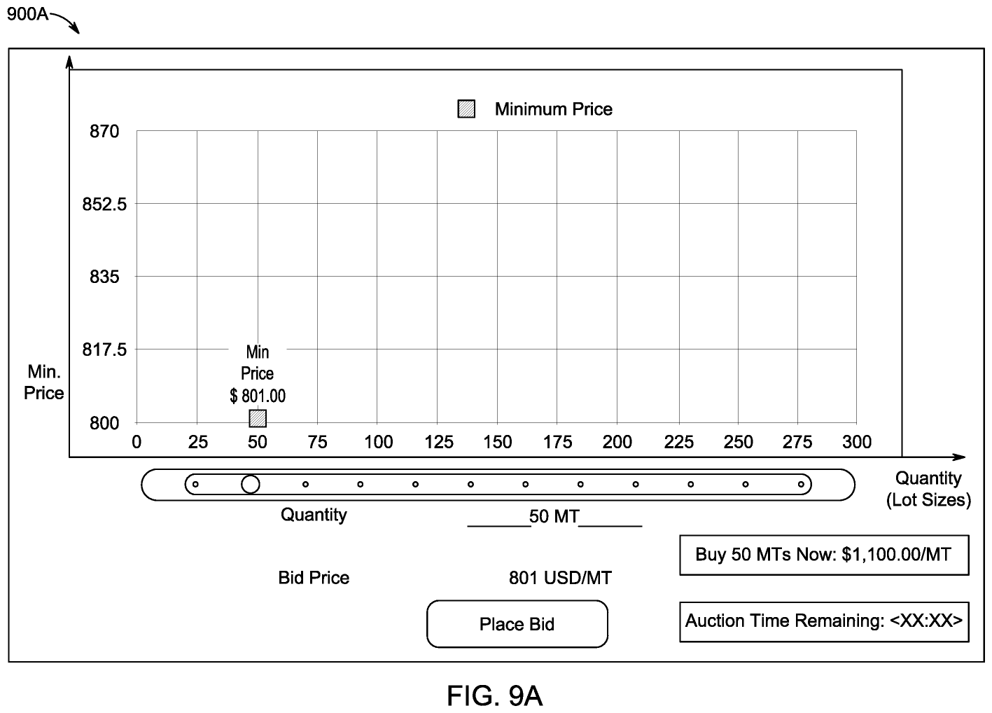

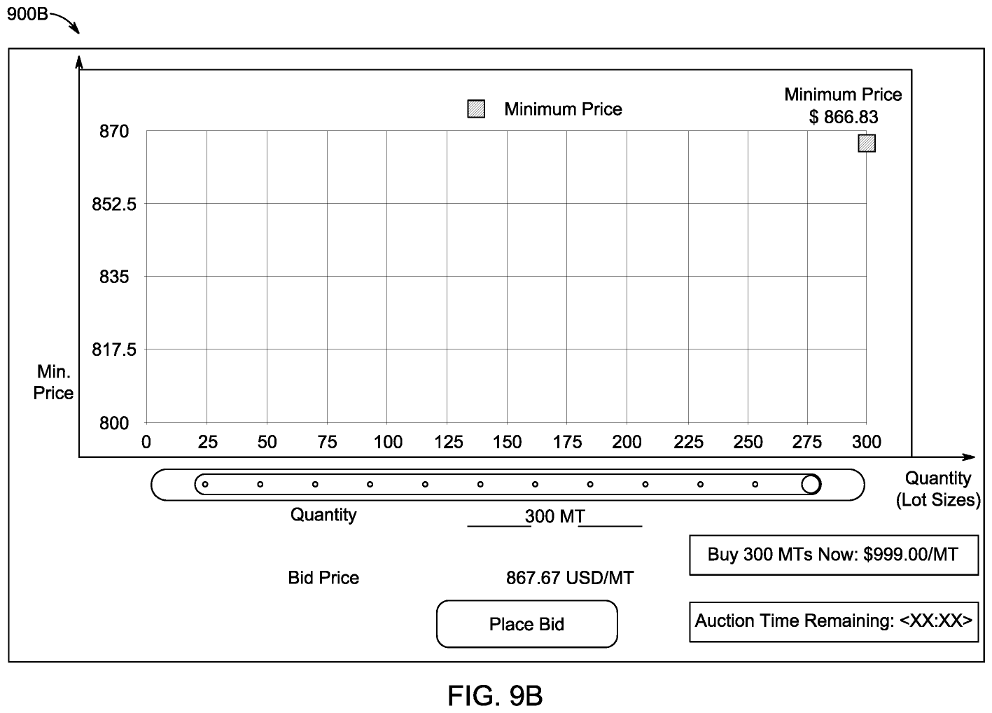

At operation 352, process 300A may start and proceed to operation 354, although it is to be understood that an auction buyer customization process may alternatively start by proceeding to any other suitable operation. At operation 354 of process 300, the EASP may be configured to determine whether any terms and conditions or any other documentation has been provided by the SEU for the auction (e.g., at one or more of operations 252-260 or otherwise of process 200) that is to be explicitly reviewed and/or approved of by a BEU before enabling the BEU to participate in the auction. If so, process 300A may advance to operation 356 where the EASP may prompt the buyer whether or not they accept such terms and conditions (e.g., if so, the EASP may be configured to create a log, including the buyer ID and a time stamp of when the buyer accepted the requisite terms and conditions for a particular auction). If not, process 300A may advance to operation 358 and end. Otherwise, process 300A may advance from operation 356 (or from operation 354 if not in the affirmative) to operation 360, where the EASP may be configured to determine whether any packaging price adjustment table or other suitable manner of defining any suitable buyer-customizable packaging options has been provided by the SEU for the auction (e.g., at operation 246 or otherwise of process 200) that is to be explicitly reviewed by a BEU before enabling the BEU to participate in the auction. If so, process 300A may advance to operation 362 where the EASP may prompt the buyer to select one or more customizable packaging options by presenting any suitable buyer-customizable packaging interface to the buyer (e.g., via any suitable GUI, such as the GUI of screen 600 of FIG. 6 (e.g., on any suitable interface of any suitable BEU subsystem (e.g., one of BEU subsystems 100a-100g of system 1))) and then to operation 364 where the EASP may be configured to determine whether or not the buyer has interacted with the presented buyer-customizable packaging interface for choosing one or more particular packaging options. If not, process 300A may advance to operation 358 and end. Otherwise, process 300A may advance from operation 364 (or from operation 360 if not in the affirmative) to operation 366, where the EASP may be configured to determine whether any suitable buyer-customizable buyer-logistics options have been provided by the SEU for the auction (e.g., at operation 248 or otherwise of process 200) that is to be explicitly reviewed by a BEU before enabling the BEU to participate in the auction. If so, process 300A may advance to operation 368 where the EASP may prompt the buyer to select one or more customizable buyer-logistics options by presenting any suitable buyer-customizable buyer-logistics interface to the buyer (e.g., via any suitable GUI, such as the GUI of screen 700 of FIG. 7 (e.g., on any suitable interface of any suitable BEU subsystem (e.g., one of BEU subsystems 100a-100g of system 1))) and then to operation 370 where the EASP may be configured to determine whether or not the buyer has interacted with the presented buyer-customizable buyer-logistics interface for choosing one or more particular buyer-logistics options. If not, process 300A may advance to operation 358 and end. Otherwise, process 300A may advance from operation 370 (or from operation 366 if not in the affirmative) to operation 372, where the EASP may be configured to determine whether any suitable buyer-customizable seller-logistics options have been provided by the SEU for the auction (e.g., at operation 248 or otherwise of process 200) that is to be explicitly reviewed by a BEU before enabling the BEU to participate in the auction. If so, process 300A may advance to operation 374 where the EASP may prompt the buyer to select one or more customizable seller-logistics options by presenting any suitable buyer-customizable seller-logistics interface to the buyer (e.g., via any suitable GUI, such as the GUI of screen 800 of FIG. 8 (e.g., on any suitable interface of any suitable BEU subsystem (e.g., one of BEU subsystems 100a-100g of system 1))) and then to operation 376 where the EASP may be configured to determine whether or not the buyer has interacted with the presented buyer-customizable seller-logistics interface for choosing one or more particular seller-logistics options. If not, process 300A may advance to operation 358 and end. Otherwise, process 300A may advance from operation 376 (or from operation 372 if not in the affirmative) to operation 378, where the EASP may enable the BEU to monitor the auction and place one or more bids once the auction starts, for example, by presenting any suitable buyer-bidding interface to the buyer (e.g., via any suitable GUI, such as the GUI of screen 900 of FIG. 9 and/or the GUI of screen 900A of FIG. 9A and/or the GUI of screen 900B of FIG. 9B and/or the like (e.g., on any suitable interface of any suitable BEU subsystem (e.g., one of BEU subsystems 100a-100g of system 1))). The BEU may interact with the EASP throughout the auction until the auction expires or until the BEU actively exits the auction, at which time process 300A may advance from operation 378 and end. When the EASP is enabling the BEU to place a bid at one or more iterations of operation 338 of process 300A, the EASP may be configured to require one or more conditions before enabling a BEU bid to be submitted, including, but not limited to, confirming that any bid quantity of any bid attempted to be submitted by the buyer is divisible by the lot size for the auction (e.g., as defined by the seller (e.g., at operation 244 of process 200)), confirming that any bid price of any bid attempted to be submitted by the buyer on an as of yet bidden on quantity is equal to or greater than the minimum starting for the auction (e.g., as defined by the seller (e.g., at operation 238 of process 200)), confirming that any bid price of any bid attempted to be submitted by the buyer on a quantity that already has been successfully bidded on (e.g., by another buyer participating in the same auction) beats the previous successful bid by at least the bid increment of the auction (e.g., as defined by the seller (e.g., at operation 238 of process 200)), and/or the like. As described in more detail with respect to process 400 of FIG. 4, the EASP may be configured to present bidding options to the BEU that enforce one, some, or each of such conditions. During an auction, the EASP may be configured to automatically communicate a notification to a BEU every time a previously successful bid made by that BEU has been beat (e.g., every time the buyer loses a winning position) and/or every time an auction concludes or at any other suitable junction. In some embodiments, the EASP may be configured with tools to enable a winning bidder and seller to complete a transaction after the auction closes (e.g., transfer funds from the buyer to the seller and track shipment of the product).

It is understood that the operations shown in process 300A of FIG. 3A are only illustrative and that existing operations may be modified or omitted, additional operations may be added, and the order of certain operations may be altered.

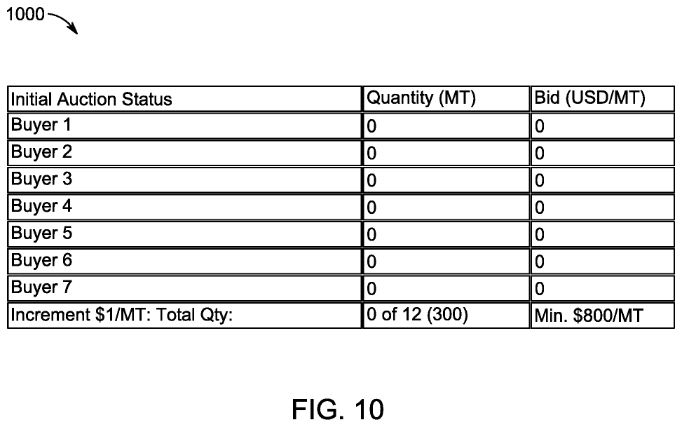

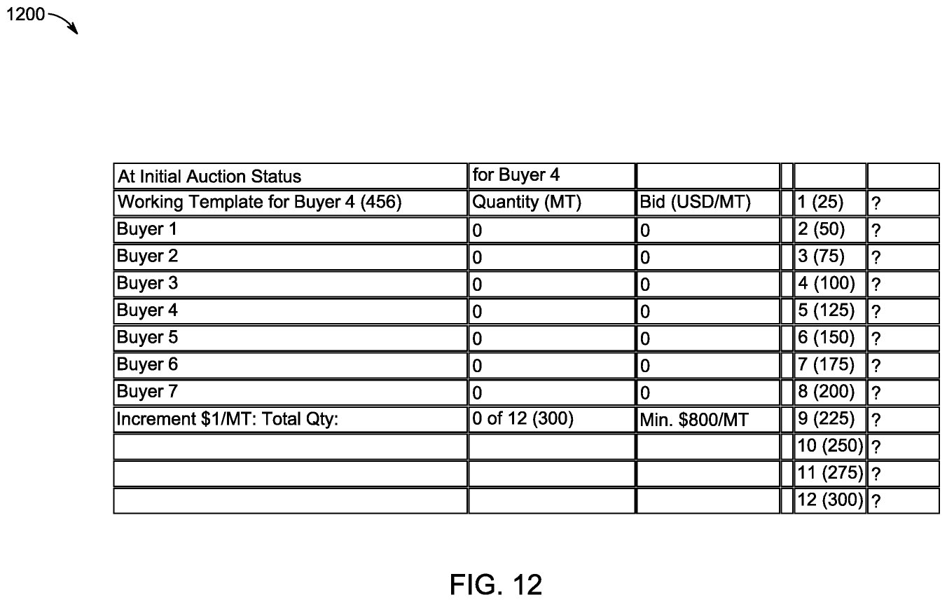

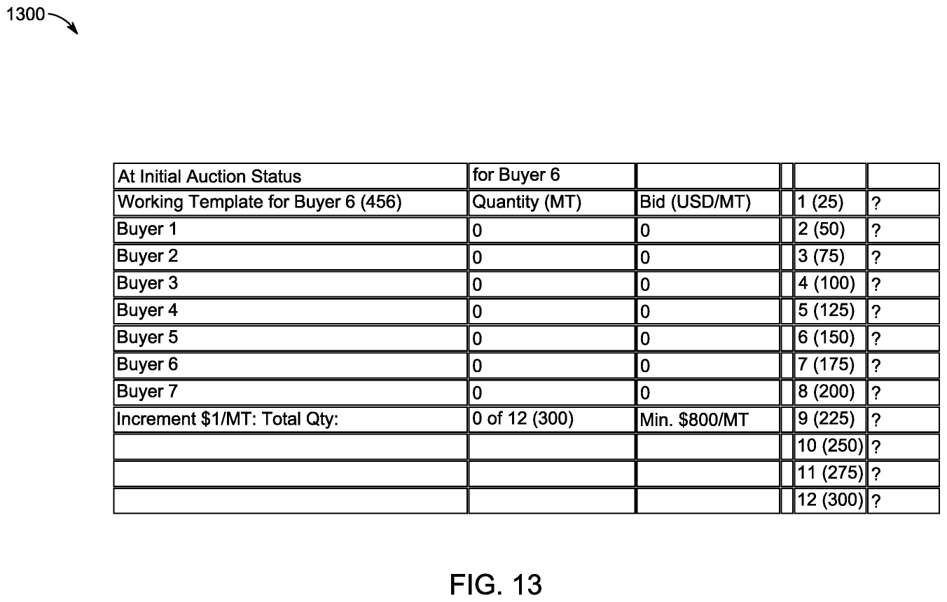

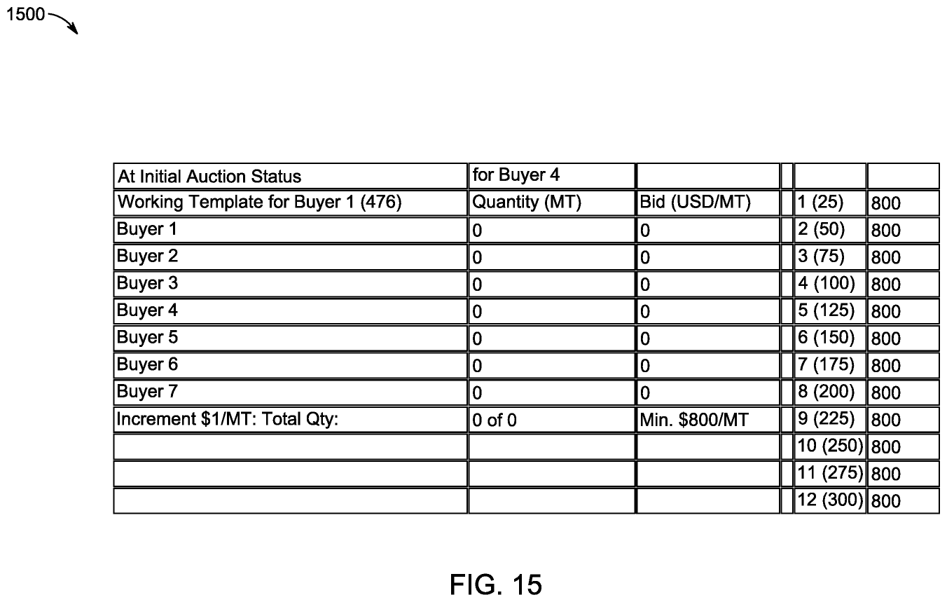

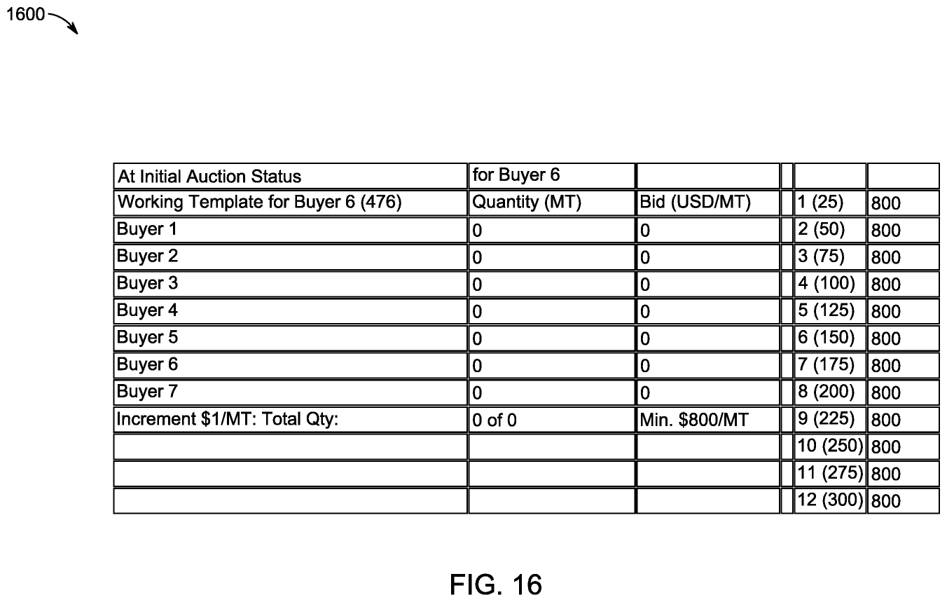

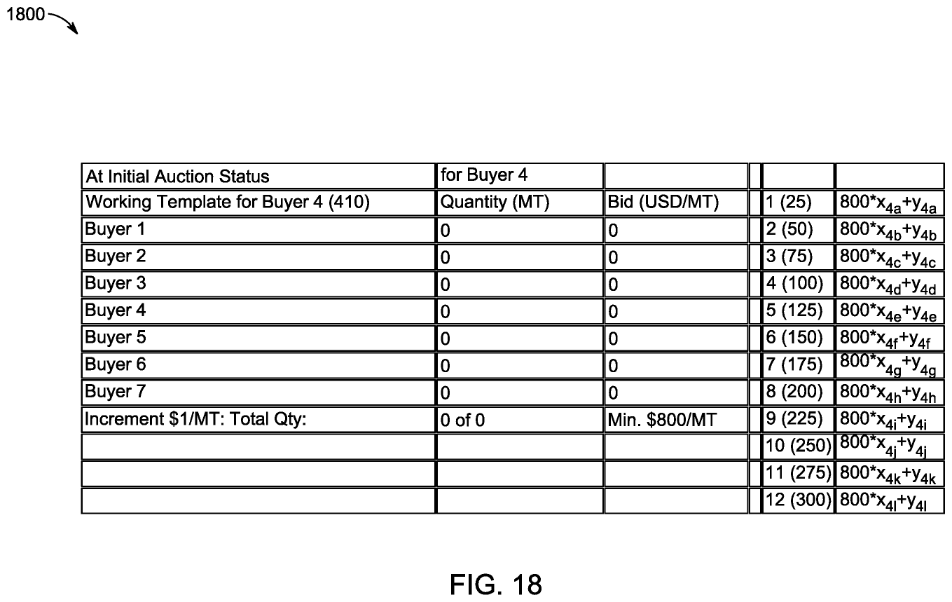

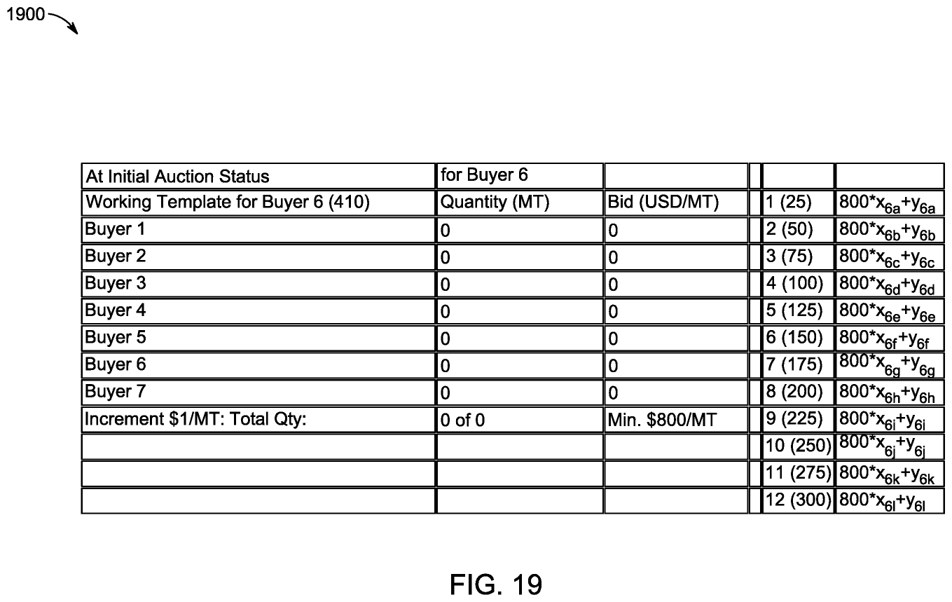

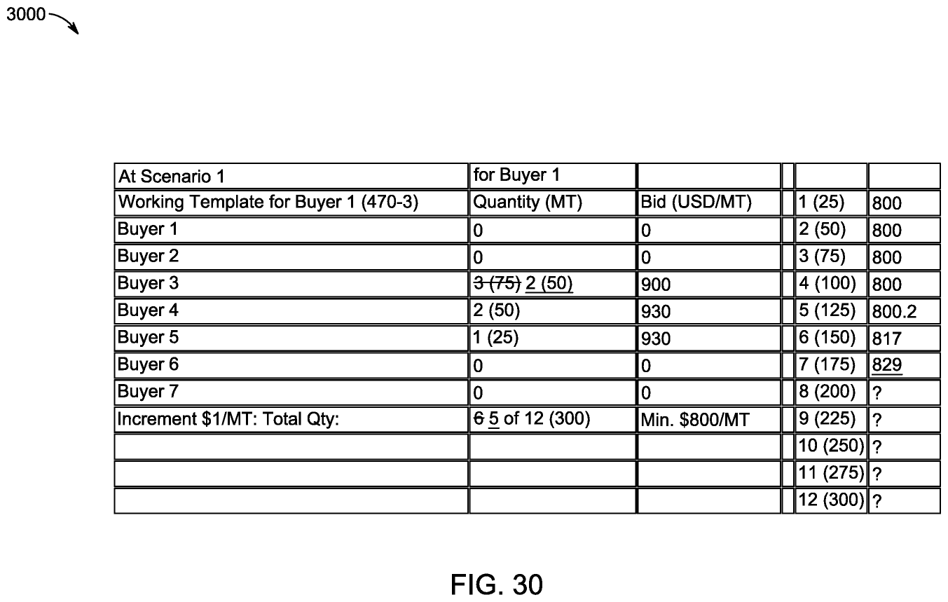

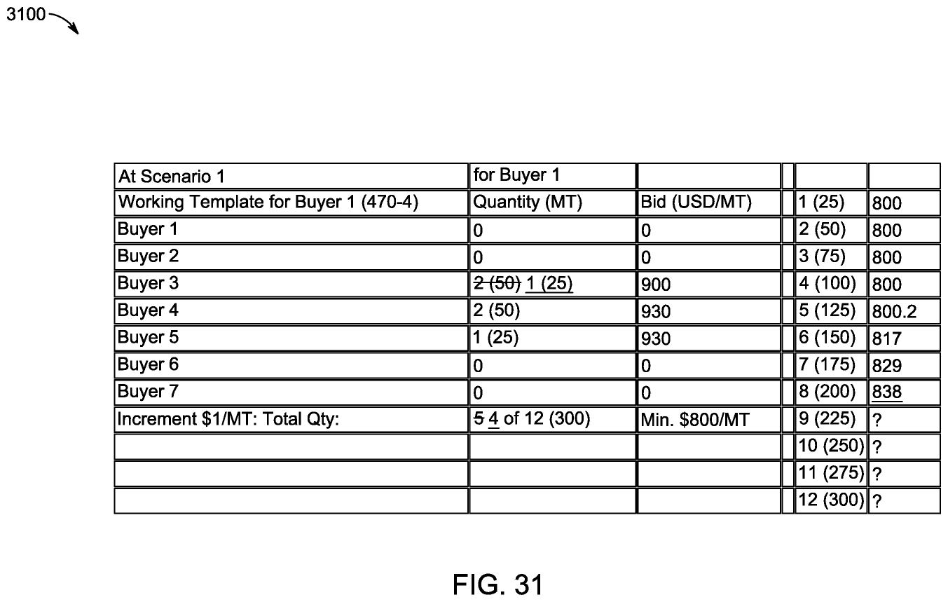

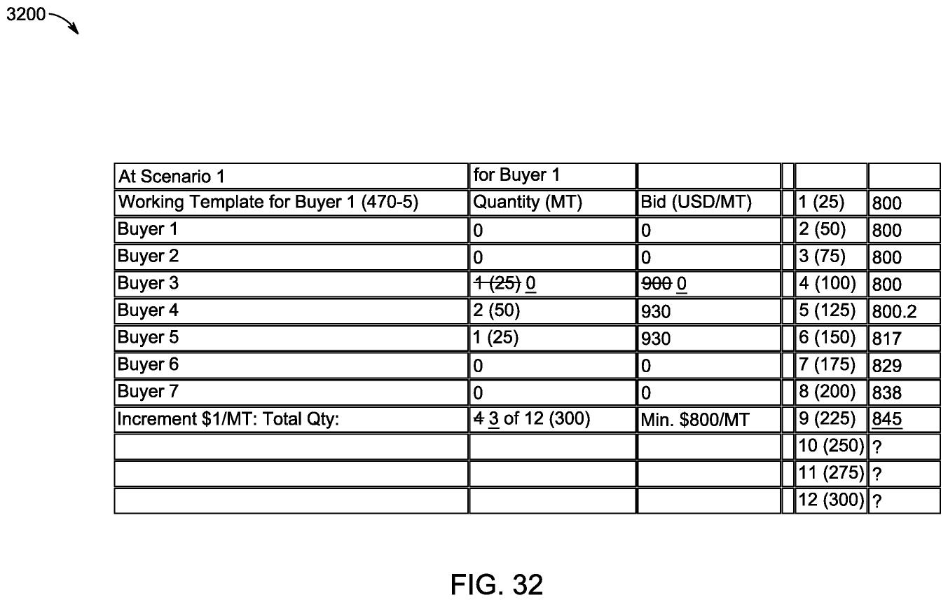

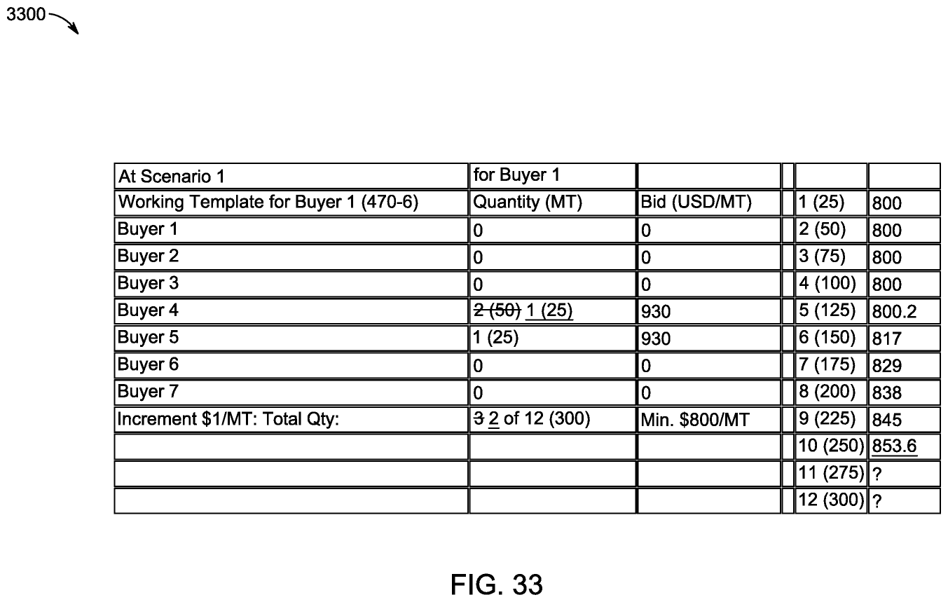

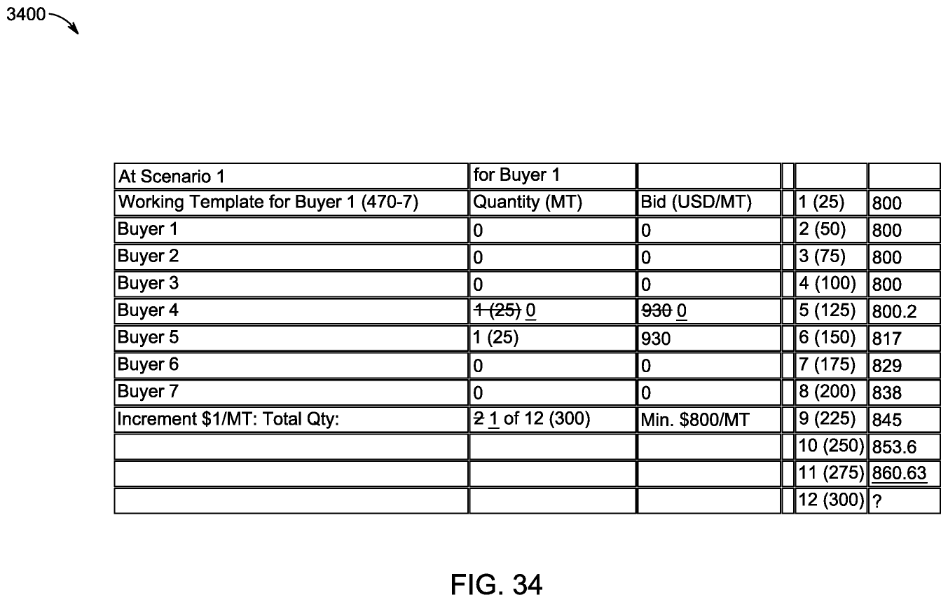

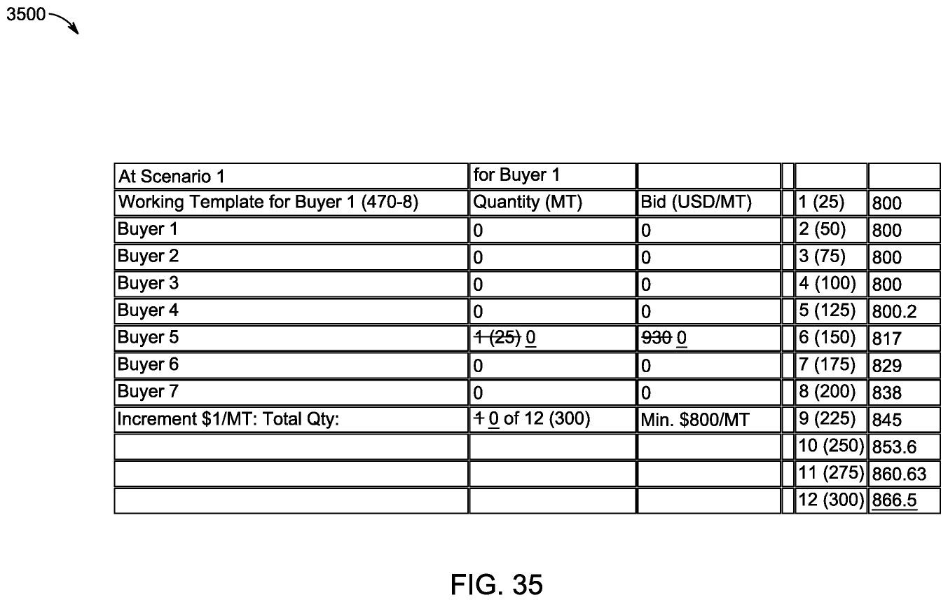

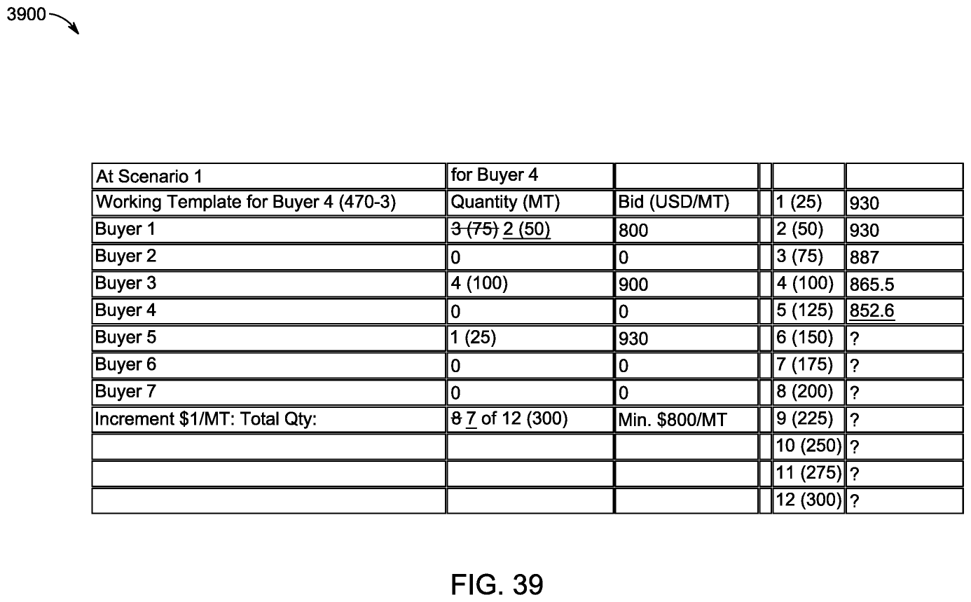

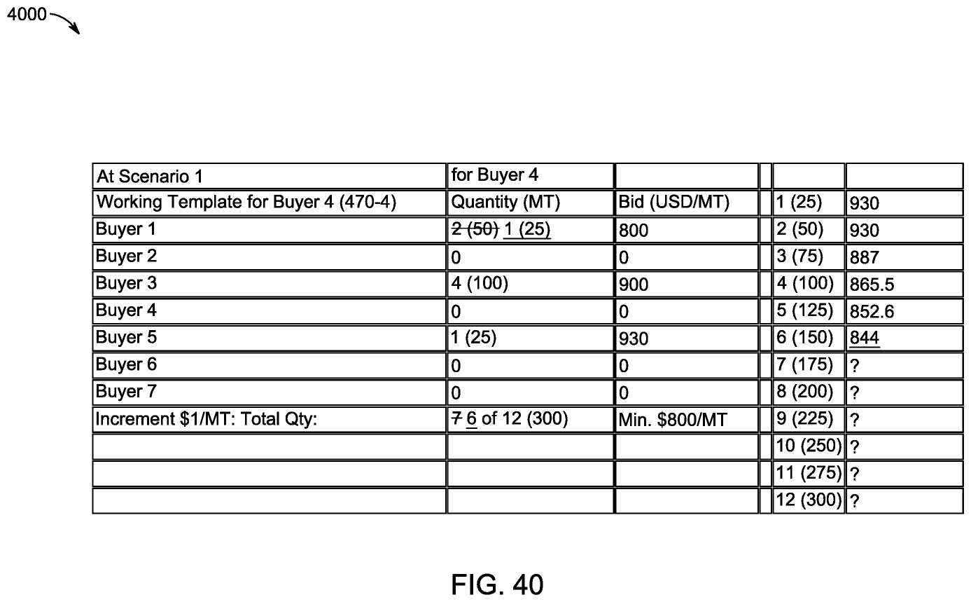

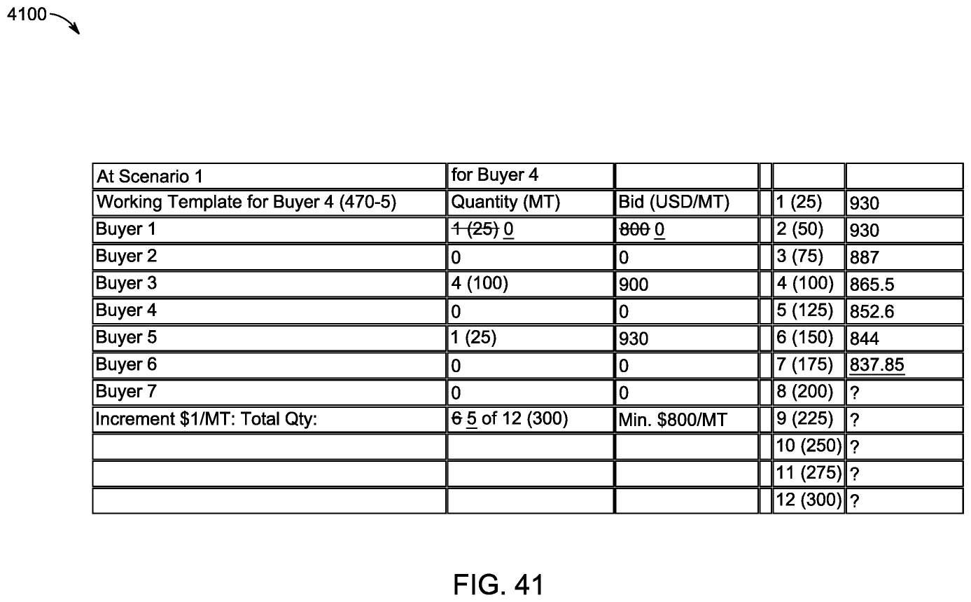

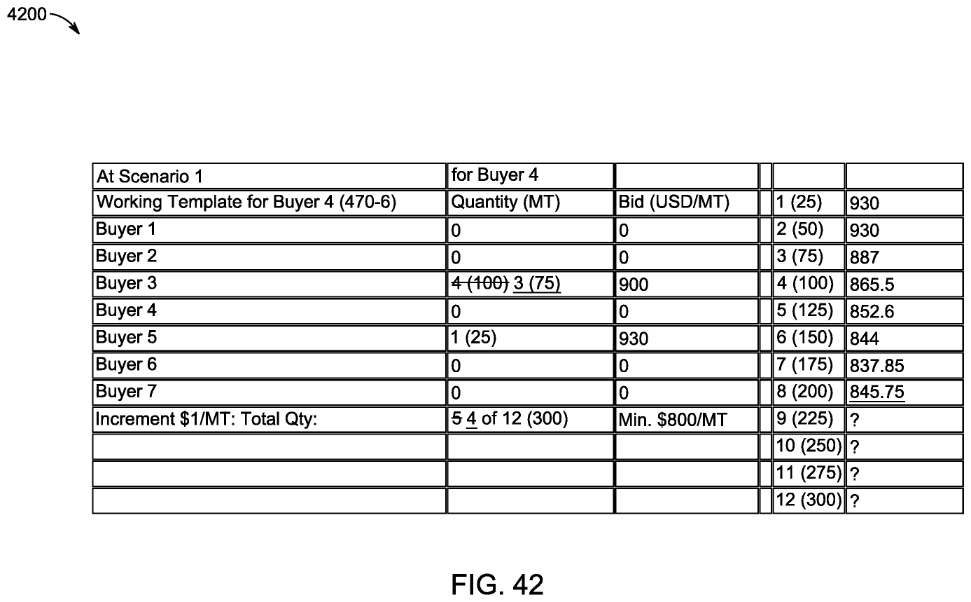

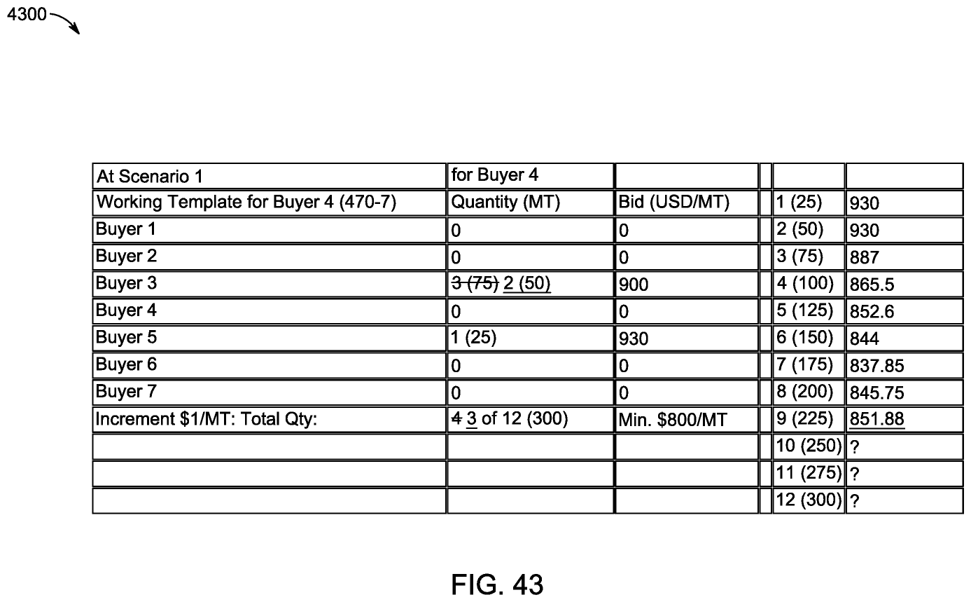

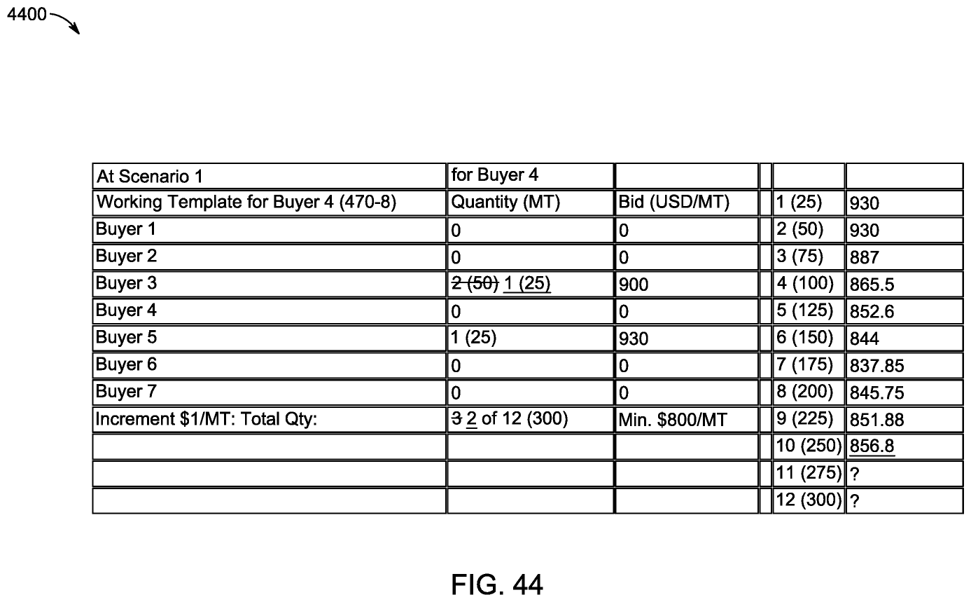

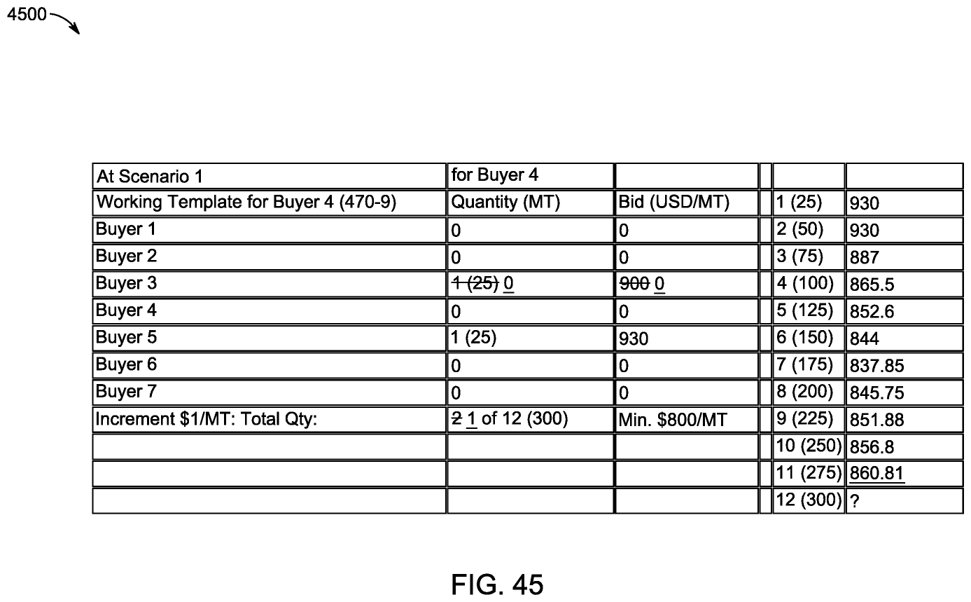

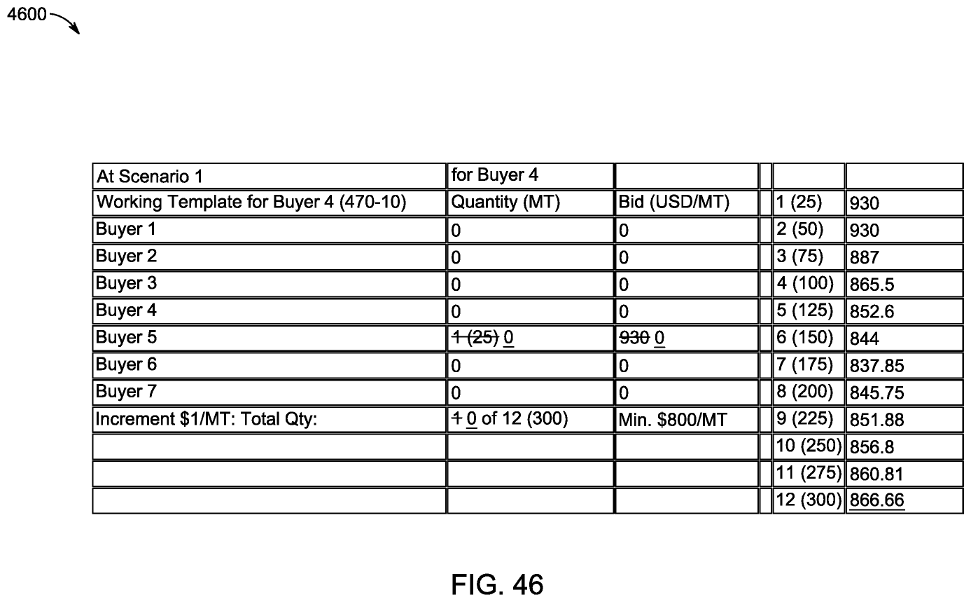

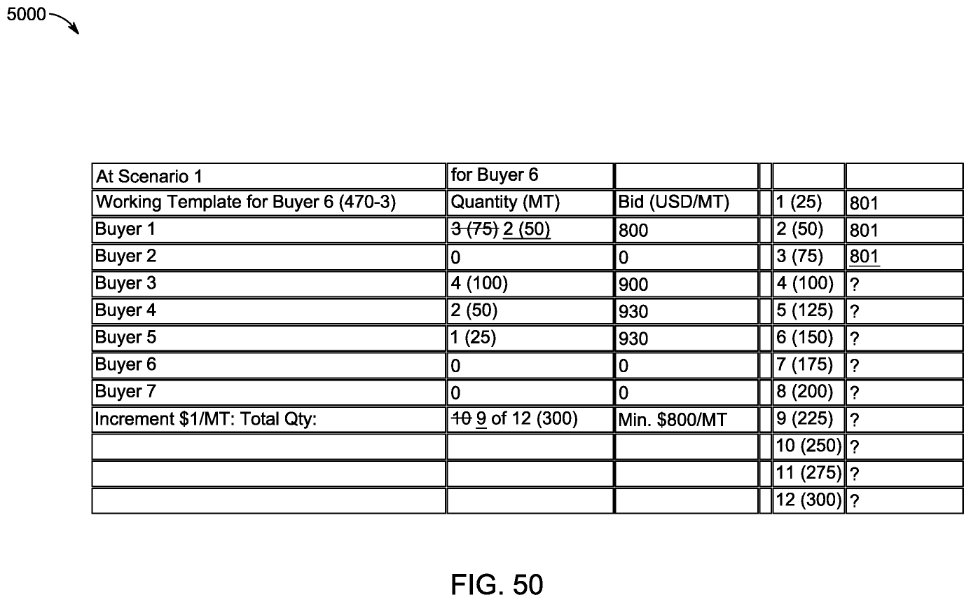

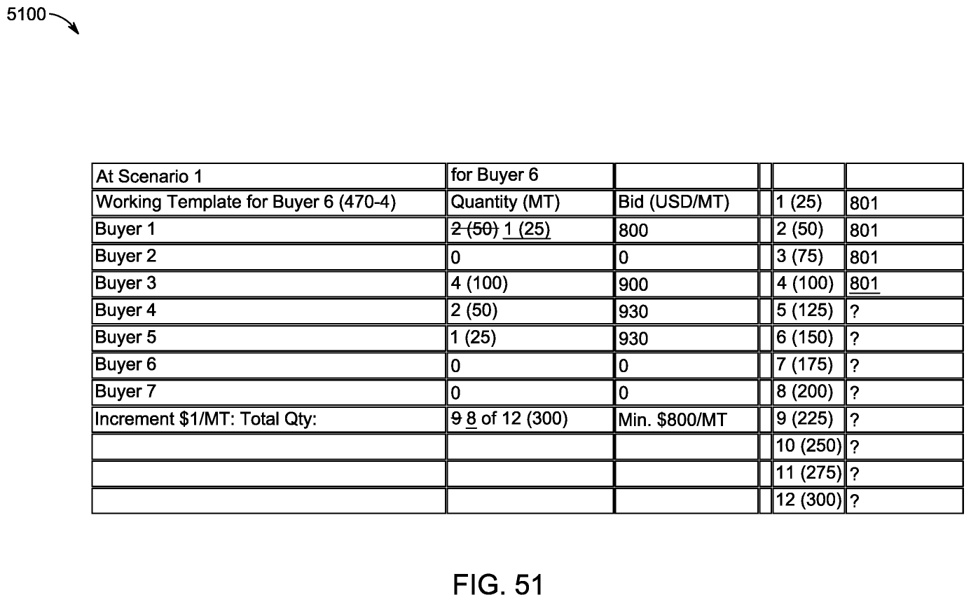

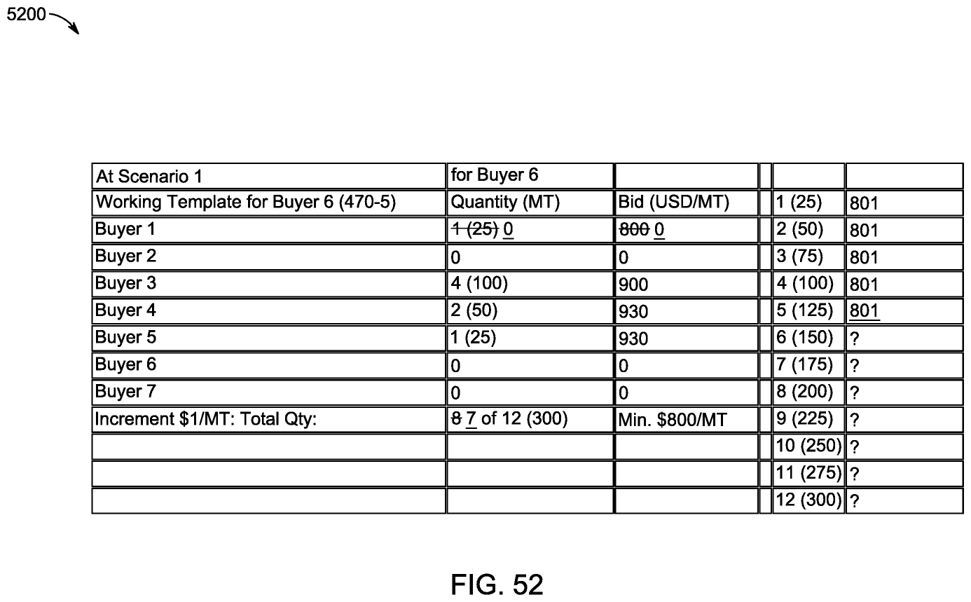

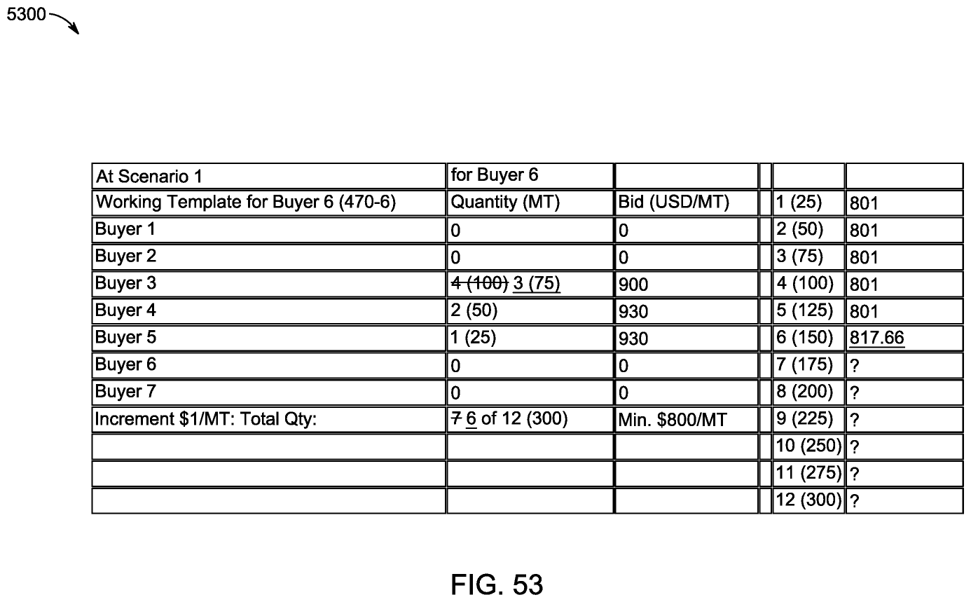

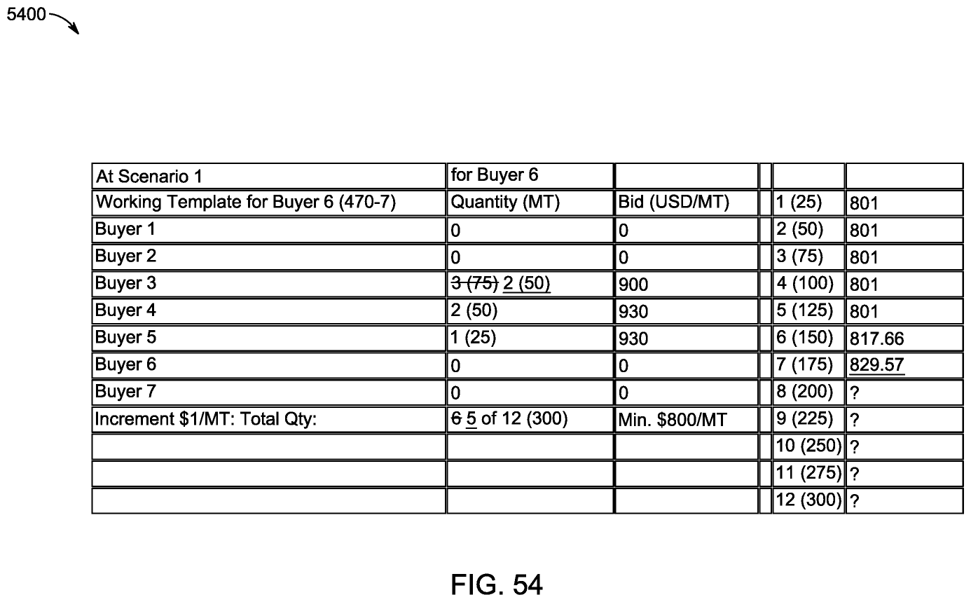

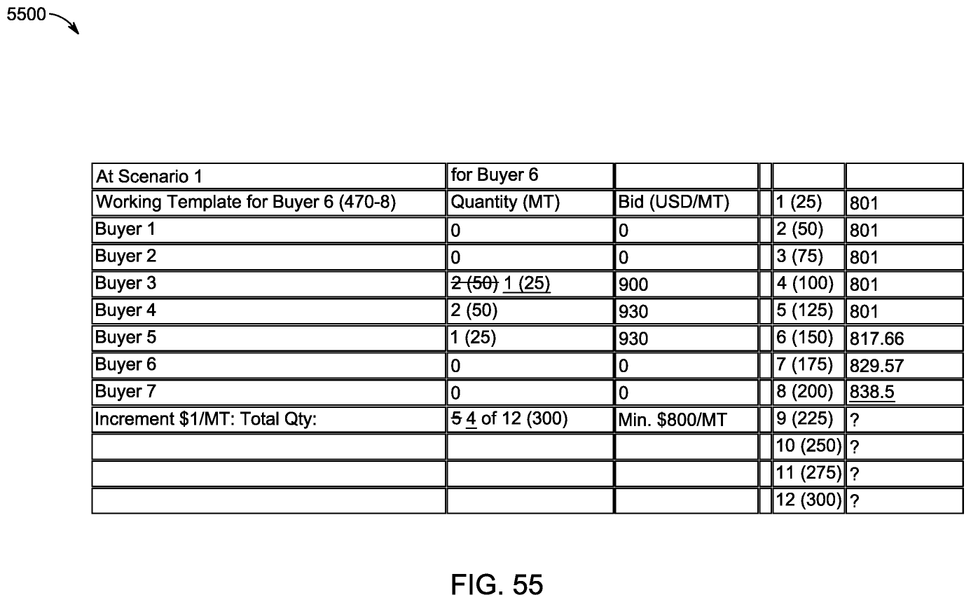

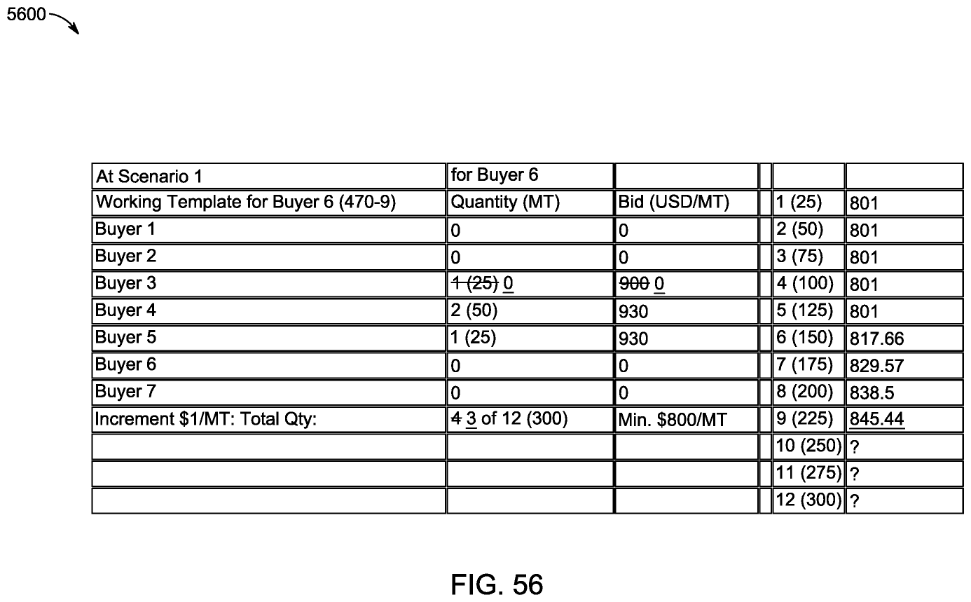

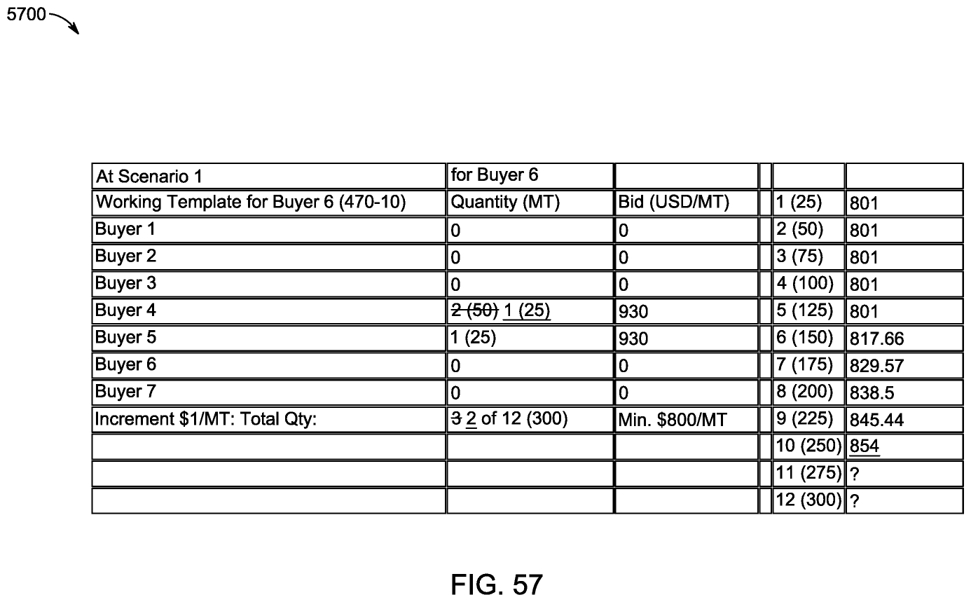

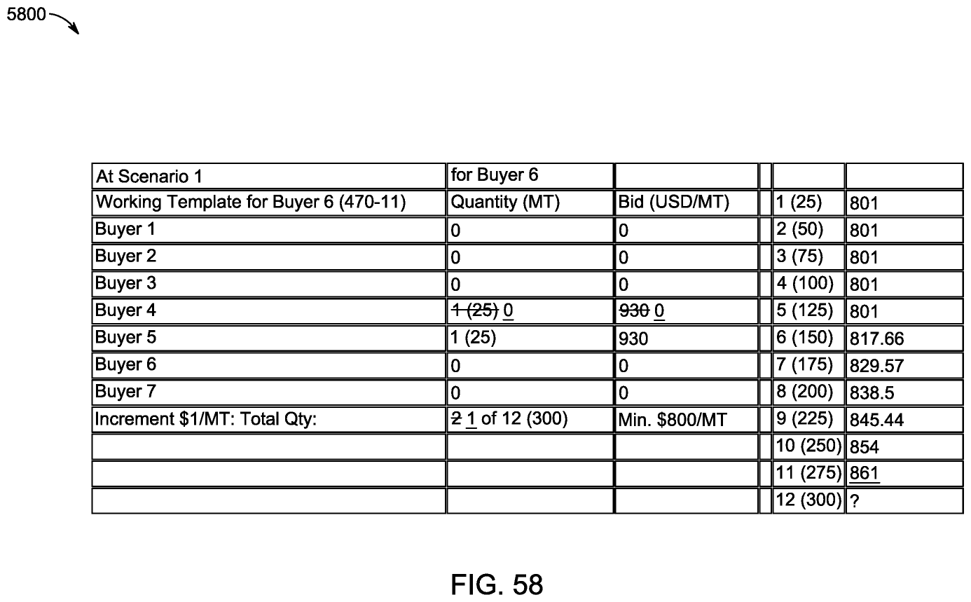

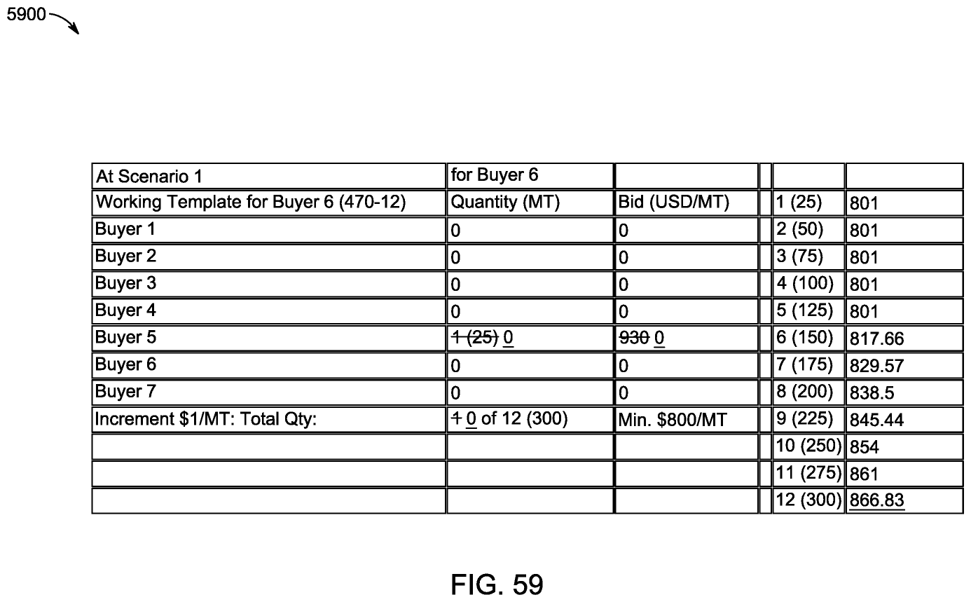

FIG. 4 is a flowchart of an illustrative auction action process 400 that may be implemented by the EASP (as may be otherwise referred to herein as “Kemgo”) and various subsystems of system 1. However, it is to be understood that process 400 may be implemented using any other suitable components or subsystems. Process 400 may provide a seamless end user experience for securely and effectively and efficiently conducting an auction with the EASP (e.g., an English-Yankee auction) of any suitable seller product as defined by a seller and EASP (e.g., through process 200) for one or more particular buyers (e.g., as through process(es) 300 and/or 300A). To facilitate the following discussion regarding the operation of system 1 for conducting an auction according to process 400 of FIG. 4, reference is made to various components of system 1 of the schematic diagrams of FIGS. 1 and 1A, to various specific subprocesses of an illustrative process 400A of FIG. 4, to one or more of front views of screens 500-900B of FIGS. 5-9B that may be representative of various graphical user interfaces (“GUIs”) of one or more subsystems of system 1 during process 400 of FIG. 4, and to one or more of various data structures or tables thereof (e.g., of FIGS. 10-62A (e.g., any suitable template (e.g., partially or fully defined) that may be any suitable data structure or any suitable database or any suitable ordered data storage that may be accessible in any suitable way by the EASP)) that may be representative of auction data that can be utilized by processes of the electronic auction service during process 400 of FIG. 4. The operations described may be achieved with a wide variety of graphical elements and visual schemes. Therefore, the embodiments of the GUIs of FIGS. 5-9B are not intended to be limited to the precise interface conventions adopted herein. Rather, embodiments may include a wide variety of interface styles, including some that may be at least partially non-visual, but rather at least partially aural and/or tactile or otherwise configured to convey information to and/or receive information from one or more end users.

At operation 402, process 400 may start and proceed to operation 404, although it is to be understood that an auction action process may alternatively start by proceeding to any other suitable operation. At operation 404 of process 400, the EASP may start an auction clock (e.g., on any suitable interface of one, some, or each suitable BEU subsystem (e.g., one, some, or each of BEU subsystems 100h-100j of system 1)), where the duration of the auction clock may have been defined by the seller (e.g., at operation 238 of process 200). For example, as shown by the GUI of screens 900, 900A, and 900B, the current time remaining in the auction may be presented to a buyer during the auction. At operation 406 of process 400, the EASP may set an initial auction status for the auction. This initial auction status may be defined based on various characteristics defined by the seller and/or by one or more of the buyers of the auction (e.g., at one or more operations of process 200 and/or process 300 and/or process 300A), including, but not limited to, identification of each buyer, total quantity of lots available, a minimum starting price, minimum increment, number of lots currently bid on by a particular buyer, raw minimum bid value per buyer per current bid, and/or the like. As just one particular example, operation 406 may include the EASP (e.g., EAS subsystem 10) obtaining various values for various types of auction data during process 200 and/or process 300 and/or process 300A for a particular auction that may be used not only to define the duration of the auction clock (e.g., for operation 404) but also for defining a particular initial auction status, of which an exemplary embodiment may be shown by an initial auction status of table 1000 of FIG. 10. As shown in FIG. 10, the initial auction status may identify 12 total lots available (e.g., 12 lots of 25 MTs each of auctioned product (e.g., 300 MTs of auctioned product total)), 7 buyers (e.g., Buyer 1-Buyer 7), where each buyer currently has no active bid (e.g., each buyer has currently bid for 0 quantity at a value of $0/MT per bid), while the auction has been defined to include an increment of $1/MT, and a minimum starting price of $800/MT.

After the initial auction status for the auction has been set at operation 406, process 400 may advance to operation 408, where the EASP may be configured to calculate automatically, for each buyer in the auction, a raw minimum bid value for each possible bid quantity. For example, in the particular auction example described above where there are 7 buyers and 12 total lots available, a total of 84 raw minimum bid values may be calculated (e.g., 12 minimum bid values for each of the 7 buyers (e.g., 1 minimum bid value for each of the 12 possible bid quantities for each of the 7 buyers)) for the particular current status of the auction. This calculation of operation 408 of process 400 may be accomplished by one of many possible processes, an exemplary one of which may be described and shown with respect to process 408A of FIG. 4A for each one of the buyers of the auction. In some embodiments, each one of the buyer's respective BEU subsystems (e.g., respective ones of subsystems 100a-100g) may be configured to carry out its own iteration of operation 408/process 408A locally (e.g., based on auction-wide status data as may be provided by EAS subsystem 10 or otherwise). Alternatively, EAS subsystem 10 may be configured to carry out operation 408/process 408A for each one of the buyers of the auction.

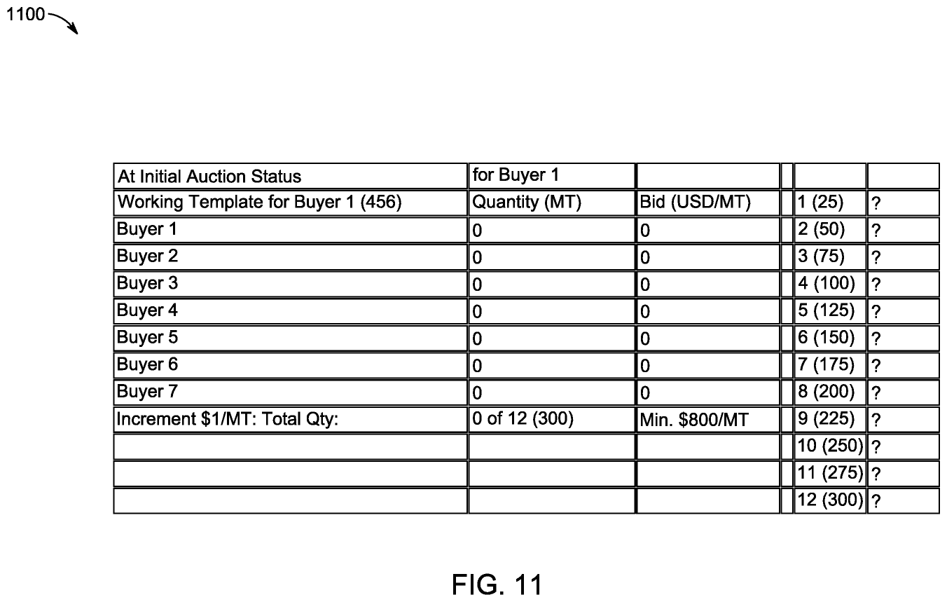

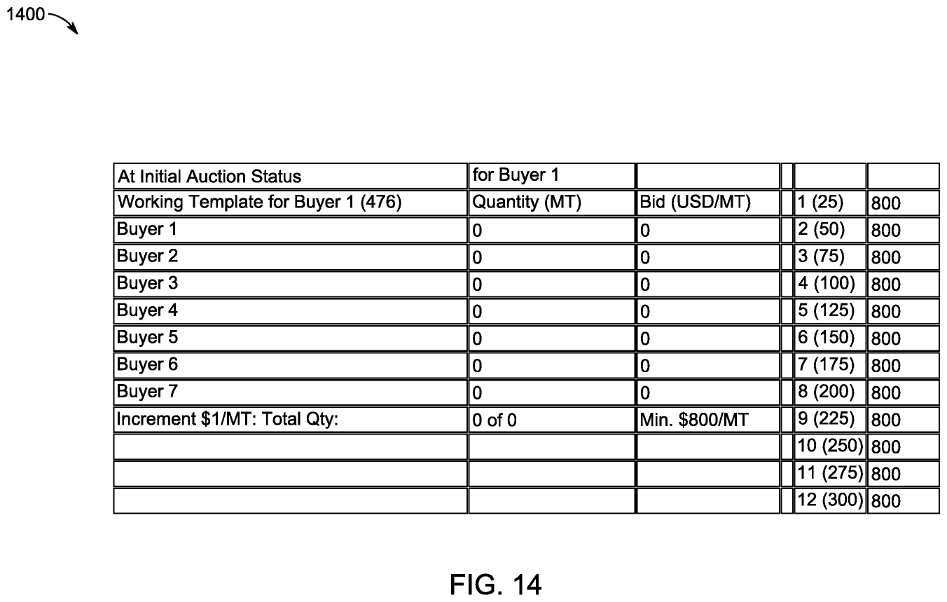

As shown in FIG. 4A, process 408A for a particular buyer, may start at operation 452 and proceed to operation 454, although it is to be understood that an auction action process may alternatively start by proceeding to any other suitable operation. At operation 454 of process 408A, a new working template may be created for a particular buyer of the auction, and then, at operation 456, the current auction status and an undefined raw minimum value for each possible bid quantity may be stored in the new working template for a particular buyer. For example, new working templates for each one of buyers 1, 4, and 6 may be shown by respective tables 1100-1300 of FIGS. 11-13, where each may include the current auction status of the auction, which during the first iteration of operation 408 may be the initial auction status of FIG. 10 (e.g., as set at operation 406), and where each new working template may also include a set of 12 undefined raw minimum bid values (e.g., one for each of the 12 possible bid quantities for the auction (e.g., 1 lot (25 MTs) possible bid quantity, 2 lots (50 MTs) possible bid quantity, 3 lots (75 MTs) possible bid quantity, 4 lots (100 MTs) possible bid quantity, 5 lots (125 MTs) possible bid quantity, 6 lots (150 MTs) possible bid quantity, 7 lots (175 MTs) possible bid quantity, 8 lots (200 MT) possible bid quantity, 9 lots (225 MTs) possible bid quantity, 10 lots (250 MT) possible bid quantity, 11 lots (275 MTs) possible bid quantity, and 12 lots (300 MTs) possible bid quantity)). Next, at operation 458, the EASP may be configured to determine if the particular buyer has a current active bid in the current auction status of the new working template for the particular buyer. If yes, process 408A may proceed from operation 458 to operation 460 (e.g., as described herein for other iterations of operation 408 of process 400). However, as may be the situation when the current auction status is the initial auction status, when the particular buyer does not have a current active bid in the current auction status of the new working template for the particular buyer, process 408A may proceed from operation 458 to operation 462, where the EASP may be configured to determine if there is at least one lot of the auction that is not part of any current auction bid in the current auction status of the new working template for the particular buyer. If no, process 408A may proceed from operation 462 to operation 468 (e.g., as described herein for other iterations of operation 408 of process 400). However, as may be the situation when the current auction status is the initial auction status, when at least one lot of the auction is not part of any current auction bid in the current auction status of the new working template for the particular buyer, process 408A may proceed from operation 462 to operation 464, where the EASP may be configured to define, in the new working template for the particular buyer, the raw minimum bid value for the smallest possible bid quantity that is undefined to be the quotient of: (1) the sum of: (A) the minimum allowable bid value of the auction; and (B) the product of: (Bi) the raw minimum bid value for the largest possible bid quantity that is already defined in the new working template for the particular buyer; and (Bii) the largest possible bid quantity that has an already defined raw minimum bid value in the new working template for the particular buyer; and (2) the smallest possible bid quantity that has an undefined raw minimum bid value in the new working template for the particular buyer. Therefore, operation 464 may determine the weighted average (e.g., weighted arithmetic mean) of the minimum allowable bid value of the auction (e.g., based on the auction-wide minimum allowable bid defined by the seller in process 200) (e.g., weighted for the next 1 lot) and of the raw minimum bid value for the largest possible bid quantity that is already defined (e.g., weighted for the number of lots of that largest possible bid quantity). For example, using table 1100 for buyer 1, operation 462 of process 408A for buyer 1 may determine that at least one lot (in fact that all 12 lots) of the auction is not part of any current auction bid in the current auction status of the new working template for the particular buyer 1, such that process 408A for buyer 1 may advance from operation 462 to operation 464 and then define in the new working template for buyer 1 the raw minimum bid value for the smallest possible bid quantity that is undefined (e.g., for the 1 lot (25 MTs) possible bid quantity) to be the quotient of: (1) the sum of: (A) the minimum allowable bid value of the auction (i.e., $800/MT); and (b) the product of: (bi) the raw minimum bid value for the largest possible bid quantity that is already defined in the new working template for the particular buyer (i.e., a null set); and (bii) the largest possible bid quantity that has an already defined raw minimum bid value in the new working template for the particular buyer (i.e., a null set); and (2) the smallest possible bid quantity that has an undefined raw minimum bid value in the new working template for the particular buyer (i.e., 1), such that the raw minimum bid value for the 1 lot (25 MTs) possible bid quantity may be defined to be $800/MT in the new working template for buyer 1. Then, process 408A may advance from operation 464 to operation 466, where a single lot size from the amount of lots not part of any current active bid in the current auction status of the new working template for the particular buyer may be removed (e.g., 1 of the 12 lots not part of any current active bid in the current (initial) auction status of the new working template for buyer 1) and then process 408A may return to operation 462. Therefore, as may be the situation when the current auction status is the initial auction status, when all 12 lots of the auction are not part of any current auction bid in the current auction status of the new working template for the particular buyer, process 408A may run 12 complete iterations of operations 462, 464, and 466, such that each one of the 12 possible bid quantities may be defined to be $800/MT in the new working template for a particular buyer (see, e.g., tables 1400-1600 of FIGS. 14-16, for each one of buyers 1, 4, and 6 after such 12 iterations of operations 462, 464, and 466). For example, using table 1300 (or table 1600) for buyer 6, on the last of twelve such iterations, operation 462 of process 408A for buyer 6 may determine that at least one lot (i.e., the 12 lots quantity) of the auction is not part of any current auction bid in the current auction status of the new working template for the particular buyer 6, such that process 408A for buyer 6 may advance from operation 462 to operation 464 and then define in the new working template for buyer 6 the raw minimum bid value for the smallest possible bid quantity that is undefined (e.g., for the 12 lots (300 MTs) possible bid quantity) to be the quotient of: (1) the sum of: (A) the minimum allowable bid value of the auction (i.e., $800/MT); and (b) the product of: (bi) the raw minimum bid value for the largest possible bid quantity that is already defined in the new working template for the particular buyer (i.e., $800/MT for the 11 lots (275 MTs) possible id quantity); and (bii) the largest possible bid quantity that has an already defined raw minimum bid value in the new working template for the particular buyer (i.e., 11 lots); and (2) the smallest possible bid quantity that has an undefined raw minimum bid value in the new working template for the particular buyer (i.e., 12 lots), such that the raw minimum bid value for the 12 lots (300 MTs) possible bid quantity may be defined to be $800/MT in the new working template for buyer 6 (e.g., “[[$800+($800*11)]/[12]”). However, at a thirteenth iteration of operation 462, the EASP may determine that there is not any lot of the auction remaining (e.g., as each one of the 12 lots has been removed from the current auction status of the new working template for a particular buyer during a respective one of the earlier 12 iterations of operations 462, 464, and 466), such that process 408a may proceed from operation 462 to operation 468, where the EASP may be configured to remove any current active bid (if any) of the particular buyer from the current auction status of the new working template for the particular buyer and then advance to operation 474. Operation 468 may not remove any bid from the current auction status of the particular buyer's template during this first iteration of operation 408, as no buyer may have any current active bid when the auction initially starts. Then, at operation 474, the EASP may be configured to determine if there is at least one possible bid quantity in the new working template for the particular buyer that has an undefined raw minimum bid value. If yes, process 408A may proceed from operation 474 to operation 470 (e.g., as described herein for other iterations of operation 408 of process 400). However, as may be the situation when the raw minimum bid value has already been defined for each of the possible bid quantities in the new working template for a particular buyer (e.g., as described with respect to the earlier 12 iterations of operations 462, 464, and 466 when the auction has just been initiated), then operation 474 may be determined to be no and may advance to operation 476 and end, such that process 408A of FIG. 4A may end by defining one of working templates 1400-1600 for a respective one of buyers 1, 4, and 6, although it is to be understood that 7 iterations of process 408A of FIG. 4A may be carried out, once for each of buyers 1-7, where such iterations may be carried out serially or in parallel or in any other suitable manner. Therefore, at the outset of an auction, each buyer may have a raw minimum bid value equal to the minimum allowable bid value of the auction for each possible bid quantity.

It is understood that the operations shown in process 400A of FIG. 4A are only illustrative and that existing operations may be modified or omitted, additional operations may be added, and the order of certain operations may be altered.

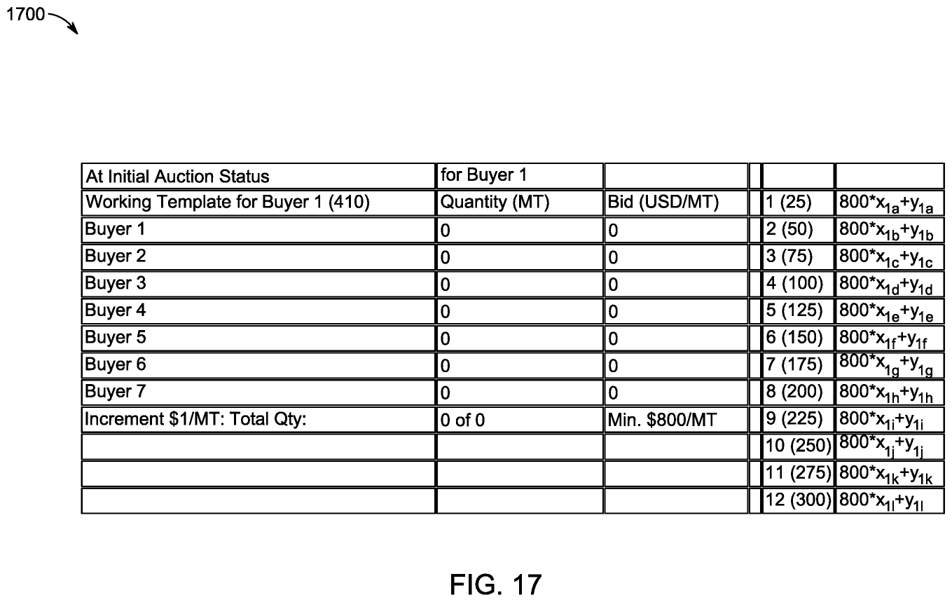

After operation 408, process 400 may advance to operation 410, where, for each buyer, each calculated raw minimum bid value for each possible bid quantity may be adjusted based on any appropriate buyer-customization value(s) (or, which may otherwise be referred to as customization variable(s) or simply buyer-specific auction variable(s)). For example, as shown by adjusted new working templates for each one of buyers 1, 4, and 6 in respective tables 1700, 1800, and 1900 of FIGS. 17-19, each calculated raw minimum bid value for each possible bid quantity for each buyer may be adjusted by any suitable multiplier customization value(s) (e.g., one or more values that may be multiplied by or divided by the raw minimum value) and/or any suitable addition customization value(s) (e.g., one or more values that may be added to or subtracted from the raw minimum value) and/or any suitable exponential customization values (e.g., one or more values that may be raised to the power of the raw minimum value or that may raise the power of the raw minimum value or the like (not shown)). For example, the calculated raw minimum bid value of $800/MT for the 1 lot (25 MTs) possible bid quantity for buyer 1 may be adjusted by at least one multiplier customization value Xia and by at least one addition customization value Yia, (e.g., such that the adjusted minimum bid value for 1 lot (25 MTs) for buyer 1 at the initiation of the auction may be set equal to the result of the equation “$800/MT*X₁ₐ+Y₁ₐ”), while the calculated raw minimum bid value of $800/MT for the 2 lots (50 MTs) possible bid quantity for buyer 1 may be adjusted by at least one multiplier customization value X_{1b} and by at least one addition customization value Y_{1b}, while the calculated raw minimum bid value of $800/MT for the 3 lots (75 MTs) possible bid quantity for buyer 1 may be adjusted by at least one multiplier customization value X_{1c} and by at least one addition customization value Y_{1c}, and the like, while the calculated raw minimum bid value of $800/MT for the 1 lot (25 MTs) possible bid quantity for buyer 4 may be adjusted by at least one multiplier customization value X₄ₐ and by at least one addition customization value Y₄ₐ, while the calculated raw minimum bid value of $800/MT for the 2 lots (50 MTs) possible bid quantity for buyer 4 may be adjusted by at least one multiplier customization value X_{4b} and by at least one addition customization value Y_{4b}, while the calculated raw minimum bid value of $800/MT for the 3 lots (75 MTs) possible bid quantity for buyer 4 may be adjusted by at least one multiplier customization value X_{4c} and by at least one addition customization value Y_{4c}, and the like, while the calculated raw minimum bid value of $800/MT for the 1 lot (25 MTs) possible bid quantity for buyer 6 may be adjusted by at least one multiplier customization value X₆ₐ and by at least one addition customization value Y₆ₐ, while the calculated raw minimum bid value of $800/MT for the 2 lots (50 MTs) possible bid quantity for buyer 6 may be adjusted by at least one multiplier customization value X_{6b} and by at least one addition customization value Y_{6b}, while the calculated raw minimum bid value of $800/MT for the 3 lots (75 MTs) possible bid quantity for buyer 6 may be adjusted by at least one multiplier customization value X_{6c} and by at least one addition customization value Y_{6c}, and the like. Each one of variables X₄ₐ-X₁₁, X₆ₐ-X₆₁, Y₁ₐ-Y₁₁, Y₄ₐ-Y₄₁, Y₆ₐ-Y₆₁, and the like for each other buyer may be independently defined based on the customization settings of the seller of process 200 and/or based on the customization settings of each buyer of process 300 and/or of process 300A (e.g., dependent upon any logistics or shipping or packaging options enabled by the participants). As just one example, addition customization value X₁ₐ may be a value of $250/MT if a particular shipping customization value for buyer 1 is to add $10/MT for any bid that buyer 1 is to place for 1 lot (25 MTs).

After operation 410, process 400 may advance to operation 412, where each adjusted minimum bid value for each possible bid quantity for a particular buyer may be presented to that particular buyer along with any other suitable auction status information (e.g., remaining auction time information, etc.), such that the particular buyer may know what the minimum amount it will cost that buyer to bid on a particular bid quantity at that particular moment in the auction. The value presented to a particular buyer for one, some, or each possible bid quantity may be transparent by showing not only the calculated raw minimum bid value but also the adjusted bid value based on the one or more customization values. Alternatively, the value presented to a particular buyer for one, some, or each possible bid quantity may be opaque by showing only the adjusted bid value and not the calculated raw minimum value or any of the customization values (e.g., if the seller does not wish for one or more of the customization values to be known to the buyer or otherwise (e.g., if one or more logistics costs is not to be made publicly available)). All of the adjusted minimum bid values for a particular buyer may be presented to the buyer at once (e.g., in a table or list or graph or otherwise (see, e.g., screen 900 of FIG. 9)) or the buyer may be presented with an adjusted minimum bid value for a selected one or more of the possible bid quantities and others may be selectively presented at the buyer's request (e.g., through use of a slider or any other suitable UI (see, e.g., screen 900A of FIG. 9A and/or screen 900B of FIG. 9B, etc.)). As mentioned, in some embodiments, a seller may set different buy now prices for different possible bid quantities (e.g., during process 200 of FIG. 2). In such embodiments, when presenting the adjusted minimum bid values for the possible bid quantities for a particular buyer (e.g., at operation 412), the EASP may also present the one or more possible buy now prices for the particular buyer (e.g., the raw buy now price(s) as defined by the seller but now as optionally adjusted by the customization value(s) for that buyer). For example, although showing the raw minimum bid values, FIGS. 9A and 9B may also show the raw buy now prices for 50 MTs and 300 MTs, respectively (see, e.g., “Buy 50 MTs Now: $1,100.00/MT” of FIG. 9A and “Buy 300 MTs Now: $999.00/MT” of FIG. 9B).

After operation 412, process 400 may advance to operation 414, where the EASP may be configured to determine if the auction clock has expired (e.g., the clock started at operation 404). If so, process 400 may advance to operation 416 and end, thereby closing the bidding process. Alternatively, if the auction clock has not yet expired, process 400 may advance to operation 418, where the EASP may be configured to determine if any new bid has been received by any one of the buyers. If not, process 400 may return to operation 414 to determine if the auction clock has expired. It is to be understood that operation 414 may be carried out at any suitable frequency and not only or explicitly after operation 412, in order to determine in a timely fashion when to end the auction. Additionally or alternatively, it is to be understood that operation 418 may be carried out at any suitable frequency and not only or explicitly after operation 412 and/or operation 414, in order to determine in a timely fashion when a new bid has been received.

When a new bid is received from any one of the buyers of the auction, process 400 may advance from operation 418 to operation 420, where the EASP may be configured to automatically update the status of the auction based on the new received bid. This operation may include determining the identity of the buyer of the new bid, the bid quantity (e.g., number of lots) of the new bid, and the raw bid value (e.g., the price per MT (e.g., not adjusted by any customization values even if the buyer made the bid when presented with an adjusted bid value based on customization value(s))) of the new bid, and then updating the current auction status of the auction by updating the list of what buyers currently have a bid on what bid quantity and at what bid value (e.g., raw bid value) in the current auction status based on the new bid information. This operation may include removing one or more quantities (e.g., lots) from one or more previously active bids in order to enable adding the one or more quantities (e.g., lots) from the new bid. In some embodiments, this will involve removing one or more quantities from one or more previously active bids that have the lowest raw bid value(s). In some embodiments, an auction may be customized using any suitable seller and/or buyer conditions/criteria to dictate how certain active bids are removed or altered to make room for the new bid (e.g., based on raw bid value(s) or number of lots bid on or buyer priority or the like). In some embodiments, operation 420 may also affect the auction clock. For example, if the auction has been defined to adjust for sniping, the auction clock may be increased by 60 seconds if the new bid is received when the auction clock was below 30 seconds (e.g., for up to 10 increases). Then, after operation 420, process 400 may advance to another iteration of operation 408 in order to re-calculate a raw minimum bid value for each possible bid quantity for each buyer based on the updated auction status of operation 420 (e.g., rather than based on the initial auction status of operation 406 (e.g., as per the first iteration of operation 408)).

It is understood that the operations shown in process 400 of FIG. 4 are only illustrative and that existing operations may be modified or omitted, additional operations may be added, and the order of certain operations may be altered. It is to be understood that process 400 of FIG. 4 may be how operation 338 of process 300 and/or operation 378 of process 300A may be carried out by the EASP for each one of the buyers of the auction.

Now, process 400 and process 408A of FIGS. 4 and 4A may be further described with respect to a few exemplary auction scenarios.

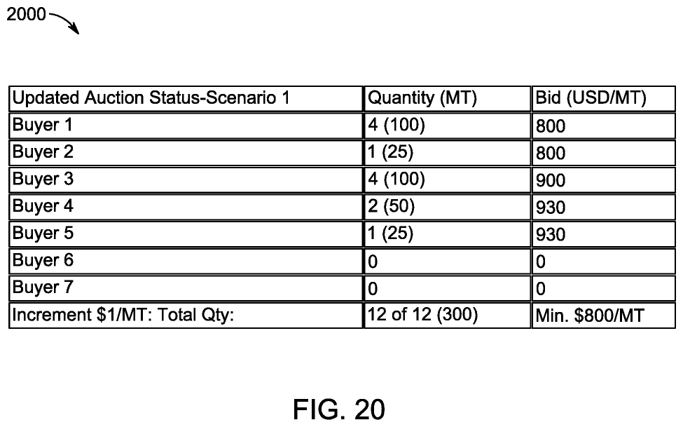

As mentioned, at operation 420 of process 400, the EASP may update the status of an active auction based on receiving a new bid. The updated auction status may be defined based on various characteristics defined by the seller and/or by one or more of the buyers of the auction (e.g., at one or more operations of process 200 and/or process 300 and/or process 300A), including, but not limited to, identification of each buyer, total quantity of lots available, a minimum starting price, minimum increment, number of lots currently bid on by a particular buyer, raw minimum bid value per buyer per current bid, and/or the like. As just one particular example, operation 420 may include the EASP (e.g., EAS subsystem 10) obtaining various values for various types of auction data during process 200 and/or process 300 and/or process 300A for the particular auction as well as the current auction status prior to receiving the new bid, and information indicative of the received new bid for defining the updated auction status, of which an exemplary embodiment may be shown by an updated auction status of table 2000 of FIG. 20. As shown in FIG. 20, the exemplary updated auction status (e.g., for a “Scenario 1” may identify that each one of the 12 total lots has a current active bid placed on it (e.g., 12 lots of 25 MTs each of auctioned product (e.g., 300 MTs of auctioned product total)), 7 buyers (e.g., Buyer 1-Buyer 7), where buyer 1 currently has an active bid for 4 lots (100 MTs of auctioned product) at a raw bid value of $800/MT, where buyer 2 currently has an active bid for 1 lot (25 MTs of auctioned product) at a raw bid value of $800/MT, where buyer 3 currently has an active bid for 4 lots (100 MTs of auctioned product) at a raw bid value of $900/MT, where buyer 4 currently has an active bid for 2 lots (50 MTs of auctioned product) at a raw bid value of $930/MT, where buyer 5 currently has an active bid for 1 lot (25 MTs of auctioned product) at a raw bid value of $930/MT, where buyer 6 currently has no active bids, and where buyer 7 currently has no active bids, while the auction has been defined to include an increment of $1/MT, and a minimum starting price of $800/MT. Such an updated auction status may have been reached in response to any number of possible earlier scenarios, including, as just one example, buyer 1 bidding on 4 lots for the minimum raw value of $800/MT at a first iteration of operation 418, then buyer 2 bidding on 1 lot for the minimum raw value of $800/MT at a second iteration of operation 418, then buyer 3 bidding on 4 lots for the raw value of $900/MT at a third iteration of operation 418 (e.g., at a value higher than the minimum raw value of $800/MT that might have been available to that buyer (e.g., if the buyer wanted to place a bid higher than necessary for any suitable reason (e.g., the buyer had to step away from the auction and wanted his current best bid to be accepted))), then buyer 4 bidding on 2 lots for the raw value of $930/MT at a fourth iteration of operation 418, and then buyer 5 bidding on 1 lot for the raw value of $930/MT at a fifth iteration of operation 418. It is to be understood that various other sequences of earlier scenarios may have also arrived at the updated auction status of scenario 1.

After the auction status for the auction has been updated at operation 420, process 400 may advance to operation 408, where the EASP may be configured to calculate automatically, for each buyer in the auction, a raw minimum bid value for each possible bid quantity. For example, in the particular auction example described above where there are 7 buyers for 12 total lots, a total of 84 raw minimum bid values may be calculated (e.g., 12 minimum bid values for each of the 7 buyers (e.g., 1 minimum bid value for each of the 12 possible bid quantities for each of the 7 buyers)) for the particular current status of the auction. This calculation of operation 408 of process 400 may be accomplished by one of many possible processes, an exemplary one of which may be described and shown with respect to process 408A of FIG. 4A for each one of the buyers of the auction. In some embodiments, each one of the buyer's respective BEU subsystems (e.g., respective ones of subsystems 100a-100g) may be configured to carry out its own iteration of operation 408/process 408A locally (e.g., based on auction-wide status data as may be provided by EAS subsystem 10 or otherwise). Alternatively, EAS subsystem 10 may be configured to carry out operation 408/process 408A for each one of the buyers of the auction. In some embodiments, each one of the buyer's respective BEU subsystems (e.g., respective ones of subsystems 100a-100g) may be configured to carry out its own iteration of operation 410 locally (e.g., based on a calculated buyer-specific set of raw minimum bid values as may be provided by EAS subsystem 10 or otherwise). Alternatively, EAS subsystem 10 may be configured to carry out operation 408/process 408A and operation 410 for each one of the buyers of the auction and then communicate an adjusted set of calculated raw values for a particular buyer to a BEU subsystem of that buyer for presentation to the buyer.

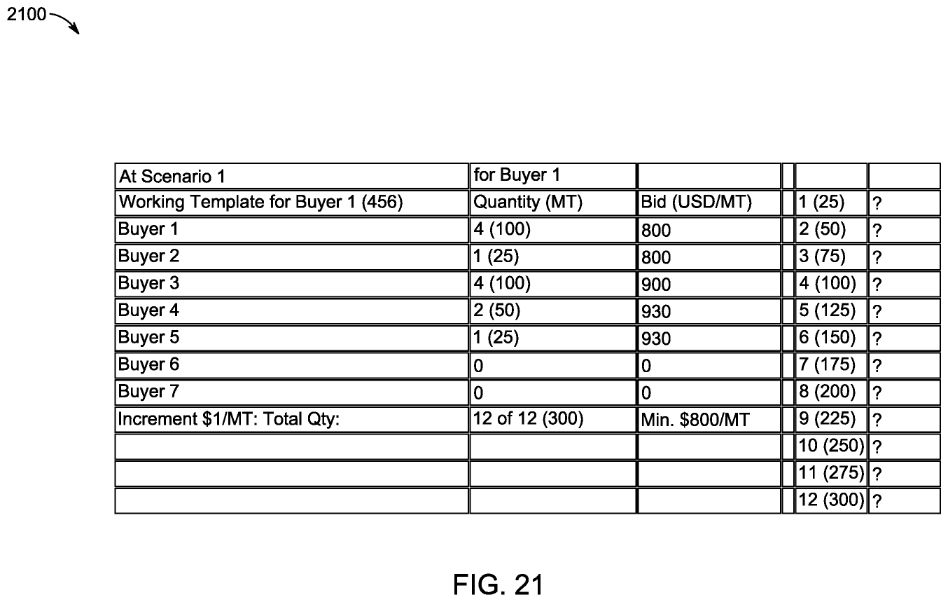

Continuing with the updated auction status of FIG. 20, process 408A for a particular buyer, may start at operation 452 and proceed to operation 454, although it is to be understood that an auction action process may alternatively start by proceeding to any other suitable operation. At operation 454 of process 408A, a new working template may be created for a particular buyer of the auction, and then, at operation 456, the current auction status and an undefined raw minimum value for each possible bid quantity may be stored in the new working template for a particular buyer. For example, new working templates for each one of buyers 1, 4, and 6 for the updated auction status of scenario 1 may be shown by respective tables 2100-2300 of FIGS. 21-23, where each may include the current auction status of the auction, which during this iteration of operation 408 may be the updated auction status of FIG. 20 (e.g., as set at operation 420), and where each new working template may also include a set of 12 undefined raw minimum bid values (e.g., one for each of the 12 possible bid quantities for the auction (e.g., 1 lot (25 MTs) possible bid quantity, 2 lots (50 MTs) possible bid quantity, 3 lots (75 MTs) possible bid quantity, 4 lots (100 MTs) possible bid quantity, 5 lots (125 MTs) possible bid quantity, 6 lots (150 MTs) possible bid quantity, 7 lots (175 MTs) possible bid quantity, 8 lots (200 MT) possible bid quantity, 9 lots (225 MTs) possible bid quantity, 10 lots (250 MT) possible bid quantity, 11 lots (275 MTs) possible bid quantity, and 12 lots (300 MTs) possible bid quantity)).

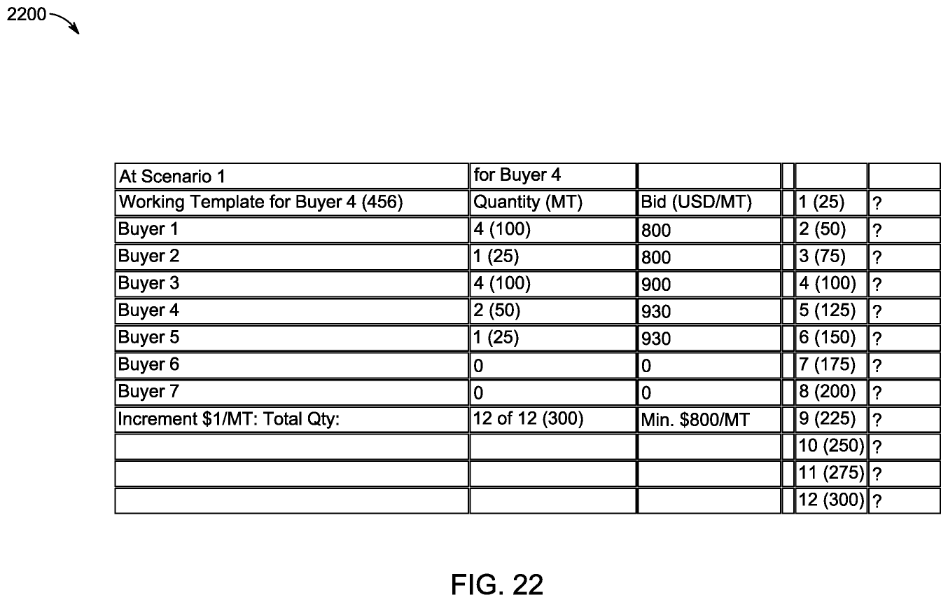

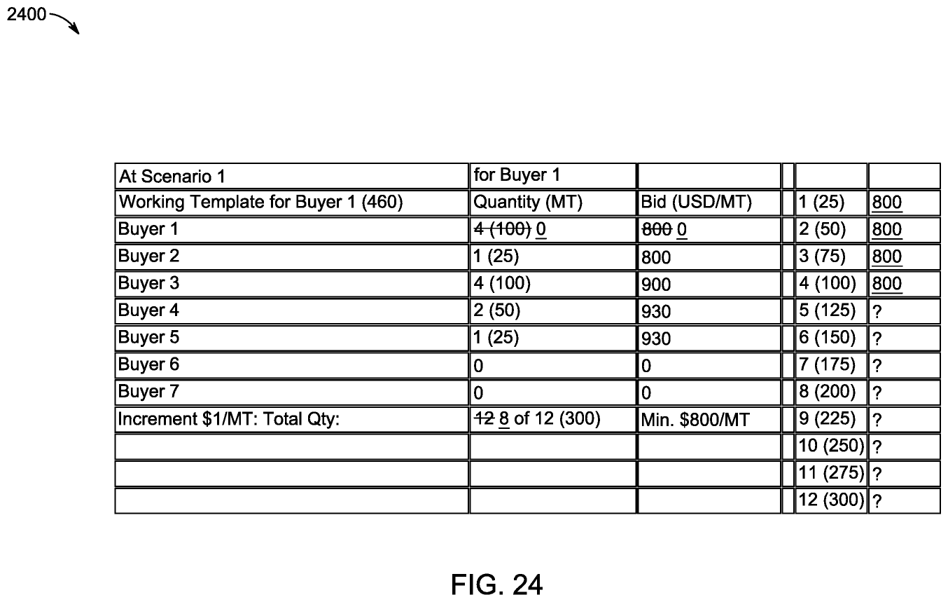

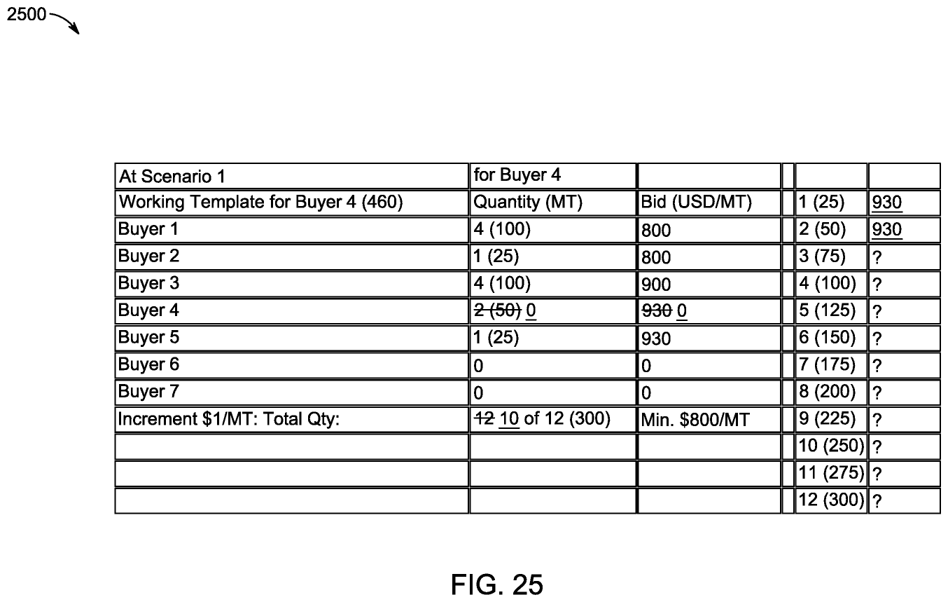

Next, at operation 458, the EASP may be configured to determine if the particular buyer has a current active bid for a current bid quantity and a current bid value in the current auction status of the new working template for the particular buyer. If no (e.g., for each one of buyers 6 and 7 at scenario 1), process 408A may proceed from operation 458 to operation 462. However, if yes (e.g., for each one of buyers 1-5 at scenario 1), process 408A may proceed from operation 458 to operation 460, where the EASP may be configured to define, in the new working template for the particular buyer, the raw minimum bid value for each possible bid quantity that is no greater than the current bid quantity to be the current bid value, and then advance to operation 462. For example, for buyer 1, operation 458 may determine that buyer 1 has a current active bid for a current active bid quantity of 4 lots (100 MTs) and for a current raw bid value of $800/MT, such that process 408A may advance from operation 458 to operation 460 for buyer 1 and such that the new working template for buyer 1 may be updated at operation 460 from table 2100 of FIG. 21 to table 2400 of FIG. 24, whereby the raw minimum bid value for each possible bid quantity (e.g., 1 lot, 2 lots, 3 lots, and 4 lots) that is no greater than the current bid quantity (4 lots) is defined to be the current raw bid value ($800/MT). As another example, for buyer 4, operation 458 may determine that buyer 4 has a current active bid for a current active bid quantity of 2 lots (50 MTs) and for a current raw bid value of $930/MT, such that process 408A may advance from operation 458 to operation 460 for buyer 4 and such that the new working template for buyer 4 may be updated at operation 460 from table 2200 of FIG. 22 to table 2500 of FIG. 25, whereby the raw minimum bid value for each possible bid quantity (e.g., 1 lot, and 2 lots) that is no greater than the current bid quantity (2 lots) is defined to be the current raw bid value ($930/MT). Similar iterations of operations 458 and 460 may be carried out for each one of buyers 2, 3, and 5. However, for each one of buyers 6 and 7, process 408A may instead bypass operation 460 and advance directly to operation 462 (e.g., because neither buyer 6 nor buyer 7 may be determined at operation 458 to have a current active bid operation based on current auction status of scenario 1).

Next, at operation 462, the EASP may be configured to determine if there is at least one lot of the auction that is not part of any current auction bid in the current auction status of the new working template for the particular buyer. If yes, process 408A may proceed from operation 462 to operation 464 and carry out one or more iterations of operations 462, 464, and 466 (e.g., as described with respect to the first iteration of operation 408 after the auction was initiated). However, if the EASP determines at operation 462 that there is no lot of the auction that is not part of any current auction bid in the current auction status of the new working template for the particular buyer (e.g., as may be the case at operation 462 for each of the buyers when the current auction status is the status as shown in table 2000 of FIG. 20), then process 408A may advance from operation 462 to operation 468, where the EASP may be configured to remove any current active bid of the particular buyer from the current auction status of the new working template for the particular buyer. For example, for buyer 1, operation 468 may determine that buyer 1 has a current active bid for a current active bid quantity of 4 lots (100 MTs) and for a current raw bid value of $800/MT, such that the current active status of the new working template for buyer 1 may be updated at operation 468 further from table 2100 of FIG. 21 to table 2400 of FIG. 24 by removing that current active bid of buyer 1 from the current active status of the new working template for buyer 1 and indicating that only 8 of 12 lots (rather than all 12 of 12 lots) have a current active bid thereon. As another example, for buyer 4, operation 468 may determine that buyer 4 has a current active bid for a current active bid quantity of 2 lots (50 MTs) and for a current raw bid value of $930/MT, such that the current active status of the new working template for buyer 4 may be updated at operation 468 further from table 2200 of FIG. 22 to table 2500 of FIG. 25 by removing that current active bid of buyer 4 from the current active status of the new working template for buyer 4 and indicating that only 10 of 12 lots (rather than all 12 of 12 lots) have a current active bid thereon.

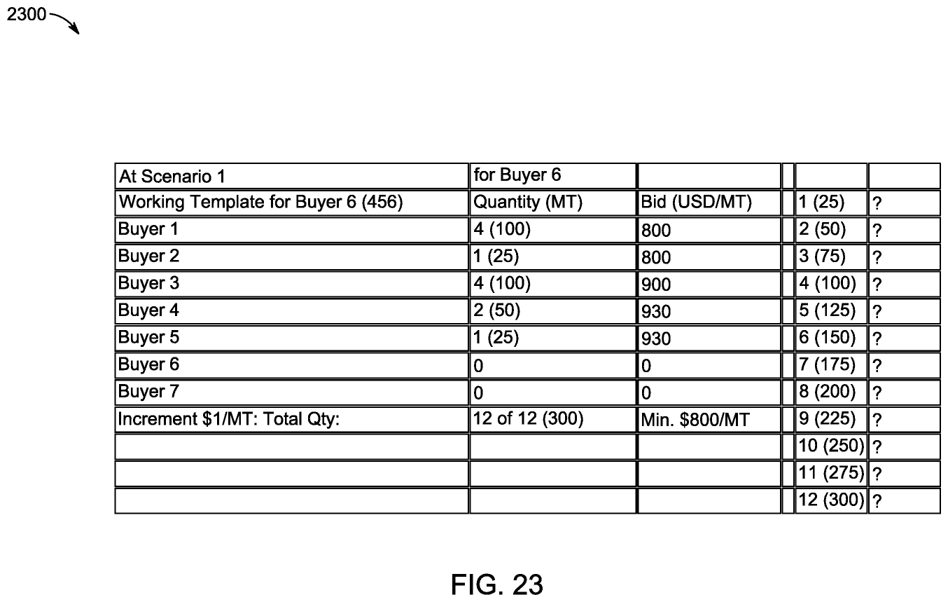

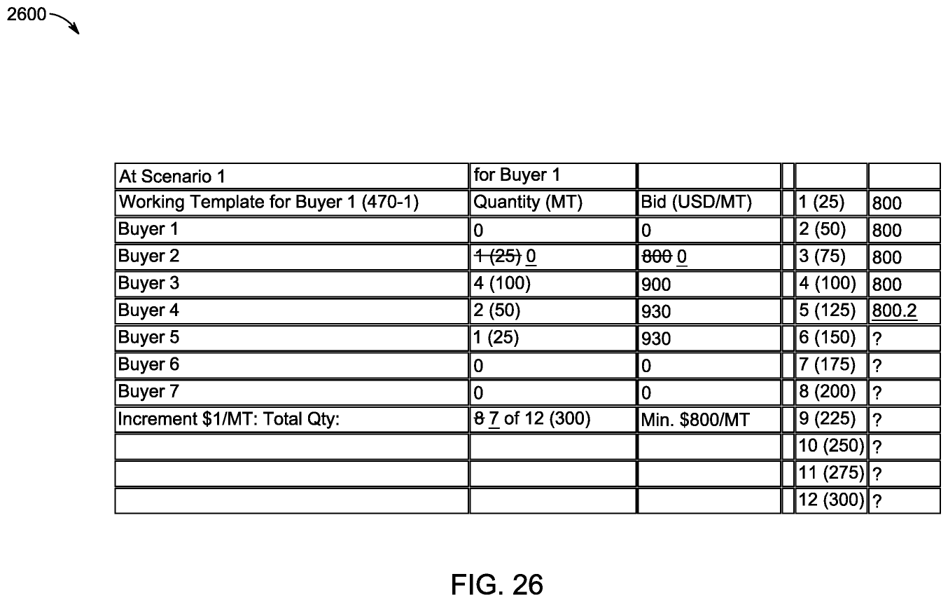

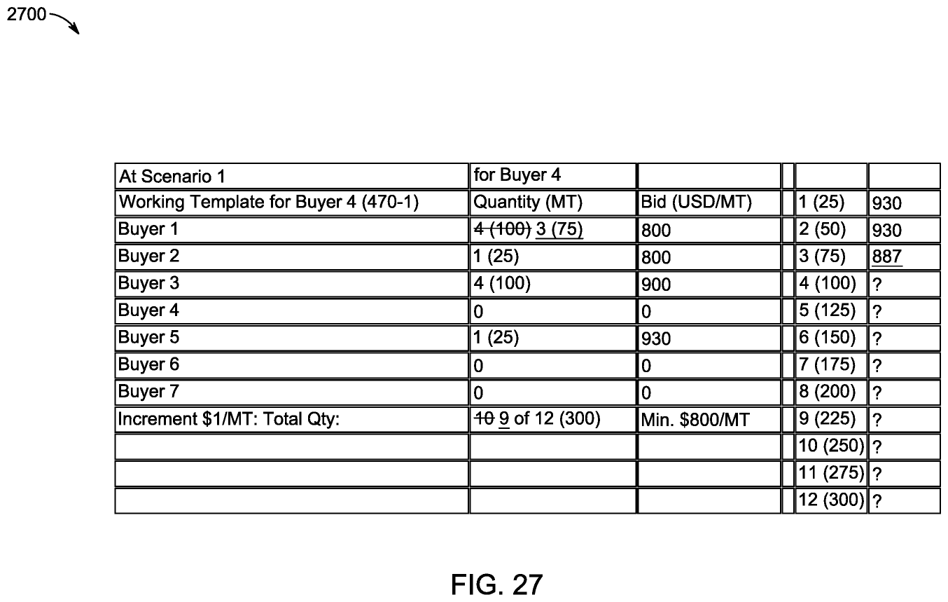

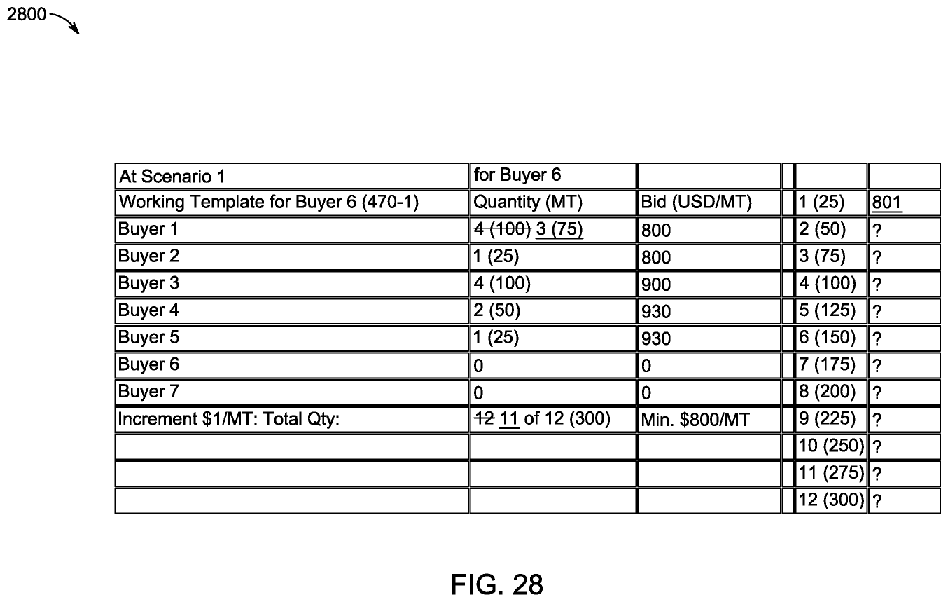

Next, after operation 468, the EASP may be configured to advance to operation 474, where the EASP may be configured to determine if there is at least one possible bid quantity in the new working template for the particular buyer that has an undefined raw minimum bid value. If no, then process 408A may proceed from operation 474 to operation 476 and end. Otherwise, if the EASP determines for a particular buyer that there is at least one possible bid quantity in the new working template for the particular buyer that has an undefined raw minimum bid value (e.g., for each one of buyers 1-7 at scenario 1), then process 408A may advance from operation 474 to operation 470, where the EASP may be configured to define, in the new working template for the particular buyer, the raw minimum bid value for the smallest possible bid quantity that is undefined to be the quotient of: (1) the sum of: (A) the minimum allowed increment value of the auction; (B) the lowest raw bid value of any current active bid in the current auction status of the new working template for the particular buyer; and (C) the product of: (Ci) the raw minimum bid value for the largest possible bid quantity that is already defined in the new working template for the particular buyer; and (Cii) the largest possible bid quantity that has an already defined raw minimum bid value in the new working template for the particular buyer; and (2) the smallest possible bid quantity that has an undefined raw minimum bid value in the new working template for the particular buyer. Therefore, operation 470 may determine the weighted average (e.g., weighted arithmetic mean) of the minimum allowable bid value of the auction (e.g., based on adding the defined increment to the lowest raw bid value of a current active bid) (e.g., weighted for the next 1 lot) and of the raw minimum bid value for the largest possible bid quantity that is already defined (e.g., weighted for the number of lots of that largest possible bid quantity). After operation 470, process 408A may advance to operation 472, where the EASP may be configured to remove a single lot size from any current active bid with the lowest raw bid value in the current auction status of the new working template for the particular buyer, and then process 408A may return to another iteration of operation 474. For example, for buyer 1, operation 474 may determine that for buyer 1 there is at least one possible bid quantity (e.g., 8 bid quantities (5 lots through 12 lots)) in the new working template for the particular buyer that has an undefined raw minimum bid value, such that process 408A may advance from operation 474 to operation 470 for buyer 1 and such that the new working template for buyer 1 may be updated at operation 470 from table 2400 of FIG. 24 to table 2600 of FIG. 26, as the EASP may be configured to define, in the new working template for the particular buyer, the raw minimum bid value for the smallest possible bid quantity that is undefined (e.g., 5 lots (125 MTs)) to be the quotient of: (1) the sum of: (A) the minimum allowed increment value of the auction (i.e., $1/MT); (B) the lowest raw bid value of any current active bid in the current auction status of the new working template for the particular buyer (i.e., $800/MT of the current active bid of buyer 2); and (C) the product of: (Ci) the raw minimum bid value for the largest possible bid quantity that is already defined in the new working template for the particular buyer (i.e., $800/MT for 4 lots); and (Cii) the largest possible bid quantity that has an already defined raw minimum bid value in the new working template for the particular buyer (i.e., 4 (4 lots)); and (2) the smallest possible bid quantity that has an undefined raw minimum bid value in the new working template for the particular buyer (i.e., 5 (5 lots)), whereby such calculation of “[($1/MT+$800/MT+($800/MT*4)]/5” provides a result of $800.20/MT that may be used by operation 470 to define the raw minimum bid value for the smallest possible bid quantity that is undefined in the current auction status of the new working template for buyer 1 (e.g., as shown in FIG. 26). Then, at operation 472, for buyer 1, the EASP may be configured to further update the current auction status of the new working template for buyer 1 from table 2400 of FIG. 24 to table 2600 of FIG. 26 by removing a single lot size (1 lot) from any current active bid with the lowest bid value in the current auction status (from the current active bid of buyer 2 with the lowest raw bid value of $800/MT) of the new working template for particular buyer 1. As another example, for buyer 4, operation 474 may determine that for buyer 4 there is at least one possible bid quantity (e.g., 10 bid quantities (3 lots through 12 lots)) in the new working template for the particular buyer that has an undefined raw minimum bid value, such that process 408A may advance from operation 474 to operation 470 for buyer 4 and such that the new working template for buyer 4 may be updated at operation 470 from table 2500 of FIG. 25 to table 2700 of FIG. 27, as the EASP may be configured to define, in the new working template for the particular buyer, the raw minimum bid value for the smallest possible bid quantity that is undefined (e.g., 3 lots (75 MTs)) to be the quotient of: (1) the sum of: (A) the minimum allowed increment value of the auction (i.e., $1/MT); (B) the lowest raw bid value of any current active bid in the current auction status of the new working template for the particular buyer (i.e., $800/MT of the current active bid of buyer 1); and (C) the product of: (Ci) the raw minimum bid value for the largest possible bid quantity that is already defined in the new working template for the particular buyer (i.e., $930/MT for 2 lots); and (Cii) the largest possible bid quantity that has an already defined raw minimum bid value in the new working template for the particular buyer (i.e., 2 (2 lots)); and (2) the smallest possible bid quantity that has an undefined raw minimum bid value in the new working template for the particular buyer (i.e., 3 (3 lots)), whereby such calculation of “[($1/MT+$800/MT+($930/MT*2)]/3” provides a result of $887/MT that may be used by operation 470 to define the raw minimum bid value for the smallest possible bid quantity that is undefined in the current auction status of the new working template for buyer 4 (e.g., as shown in FIG. 27). Then, at operation 472, for buyer 4, the EASP may be configured to further update the current auction status of the new working template for buyer 4 from table 2500 of FIG. 25 to table 2700 of FIG. 27 by removing a single lot size (1 lot) from any current active bid with the lowest bid value in the current auction status (from the current active bid of buyer 1 with the lowest raw bid value of $800/MT) of the new working template for particular buyer 4. As another example, for buyer 6, operation 474 may determine that for buyer 6 there is at least one possible bid quantity (e.g., all 12 bid quantities (1 lot through 12 lots)) in the new working template for the particular buyer that has an undefined raw minimum bid value, such that process 408A may advance from operation 474 to operation 470 for buyer 6 and such that the new working template for buyer 6 may be updated at operation 470 from table 2300 of FIG. 23 to table 2800 of FIG. 28, as the EASP may be configured to define, in the new working template for the particular buyer, the raw minimum bid value for the smallest possible bid quantity that is undefined (e.g., 1 lot (25 MTs)) to be the quotient of: (1) the sum of: (A) the minimum allowed increment value of the auction (i.e., $1/MT); (B) the lowest raw bid value of any current active bid in the current auction status of the new working template for the particular buyer (i.e., $800/MT of the current active bid of buyer 1); and (C) the product of: (Ci) the raw minimum bid value for the largest possible bid quantity that is already defined in the new working template for the particular buyer (i.e., null set); and (Cii) the largest possible bid quantity that has an already defined raw minimum bid value in the new working template for the particular buyer (i.e., null set); and (2) the smallest possible bid quantity that has an undefined raw minimum bid value in the new working template for the particular buyer (i.e., 1 (1 lot)), whereby such calculation of “[($1/MT+$800/MT+(null*null)]/1” provides a result of $801/MT that may be used by operation 470 to define the raw minimum bid value for the smallest possible bid quantity that is undefined in the current auction status of the new working template for buyer 6 (e.g., as shown in FIG. 28). Then, at operation 472, for buyer 6, the EASP may be configured to further update the current auction status of the new working template for buyer 5 from table 2300 of FIG. 23 to table 2800 of FIG. 28 by removing a single lot size (1 lot) from any current active bid with the lowest bid value in the current auction status (from the current active bid of buyer 1 with the lowest raw bid value of $800/MT) of the new working template for particular buyer 6.

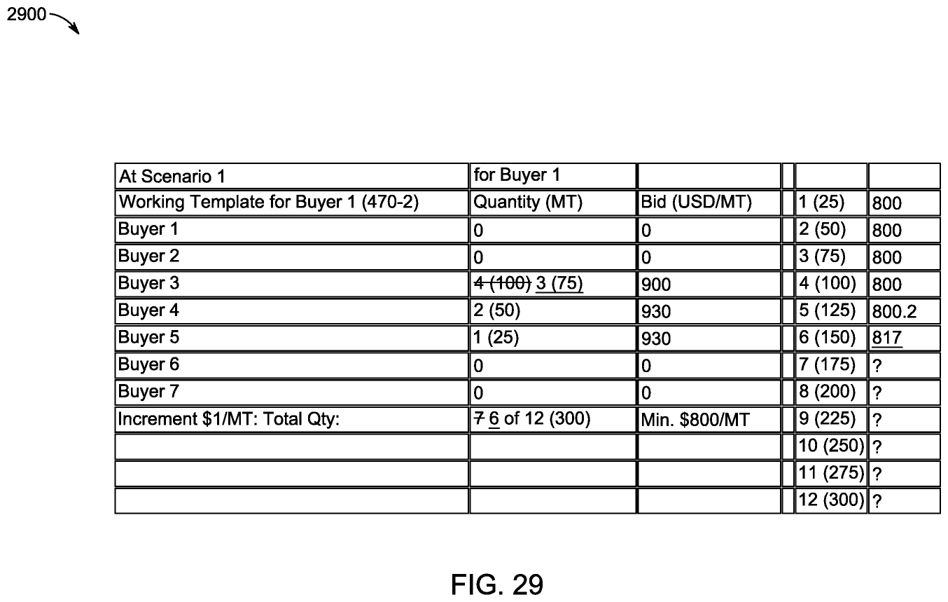

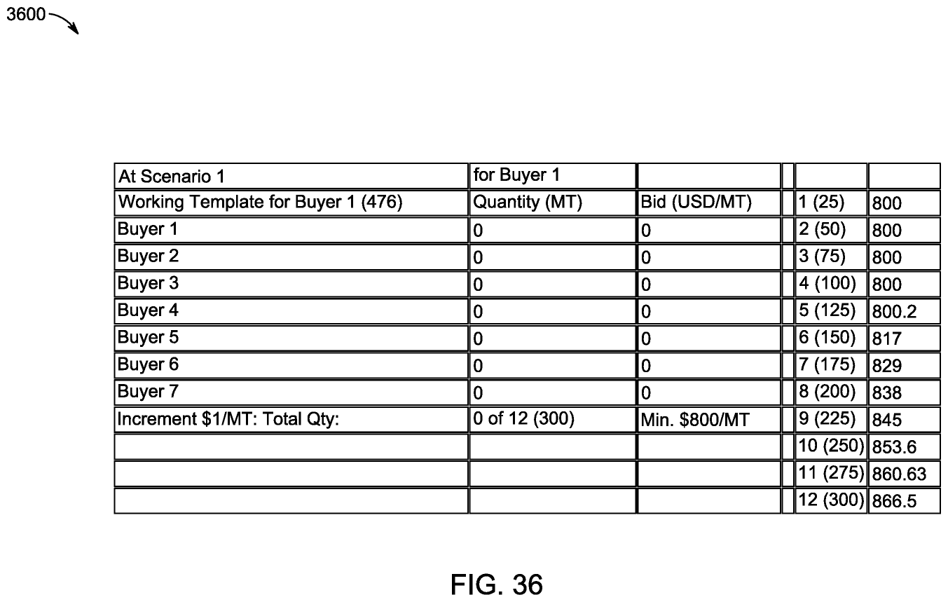

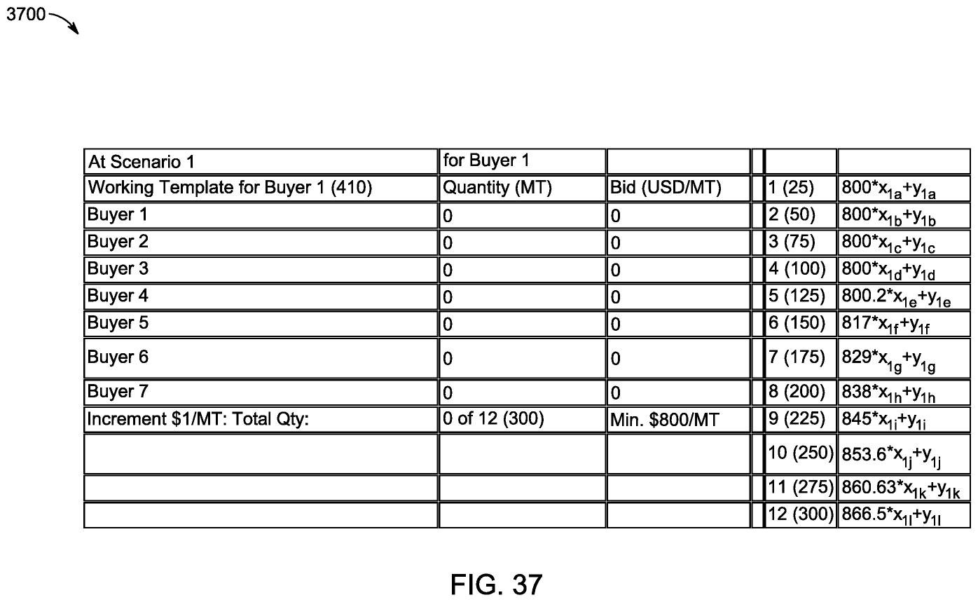

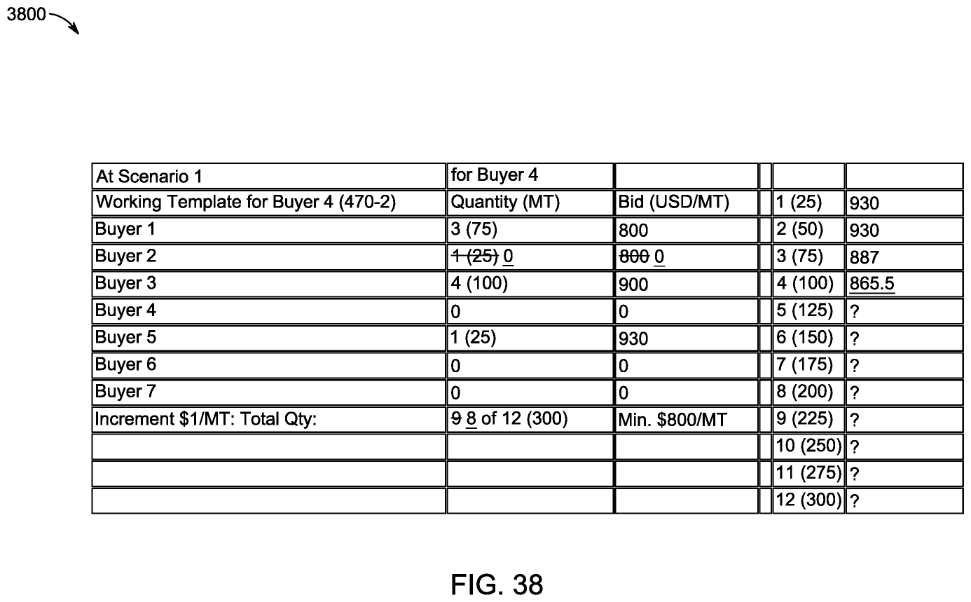

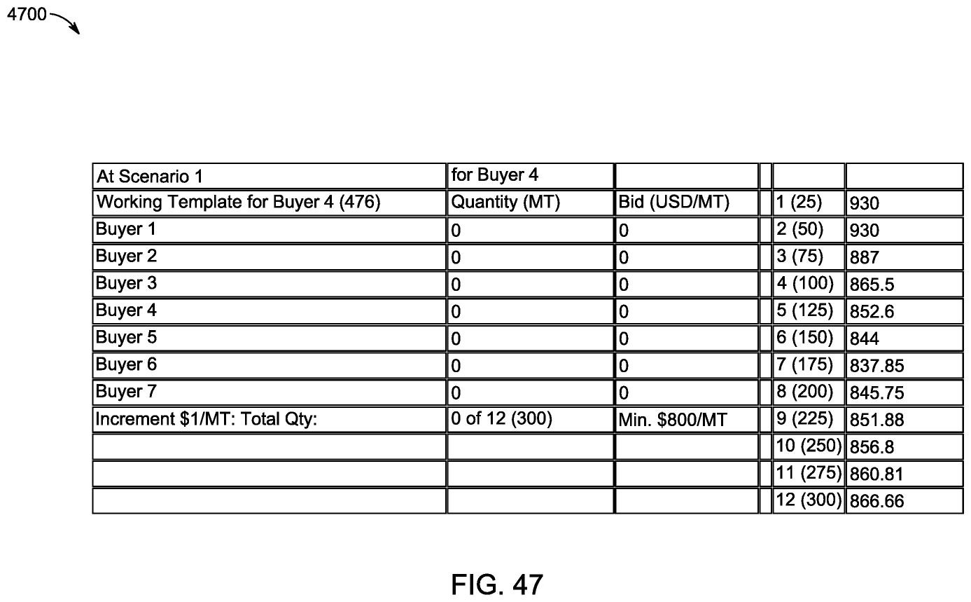

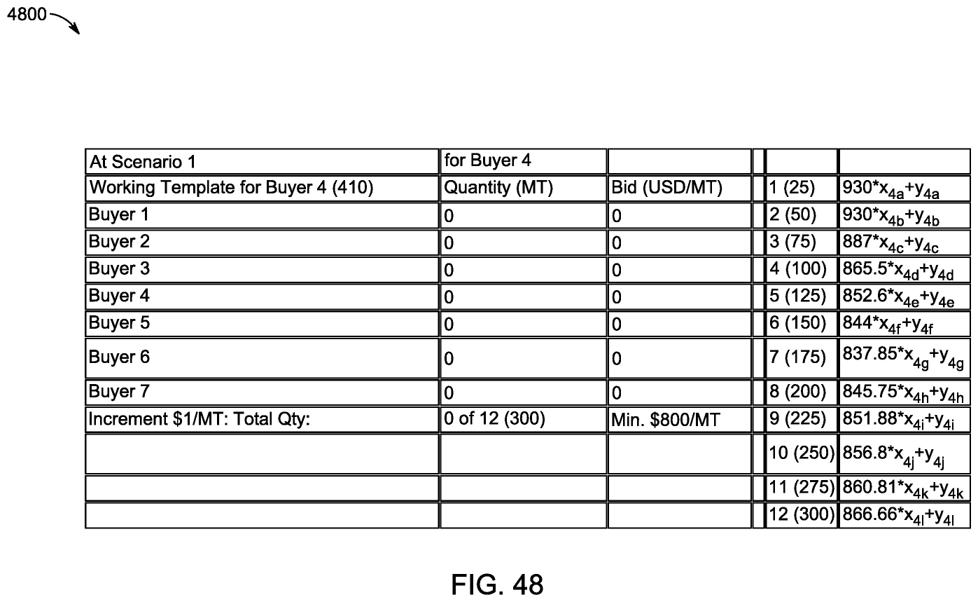

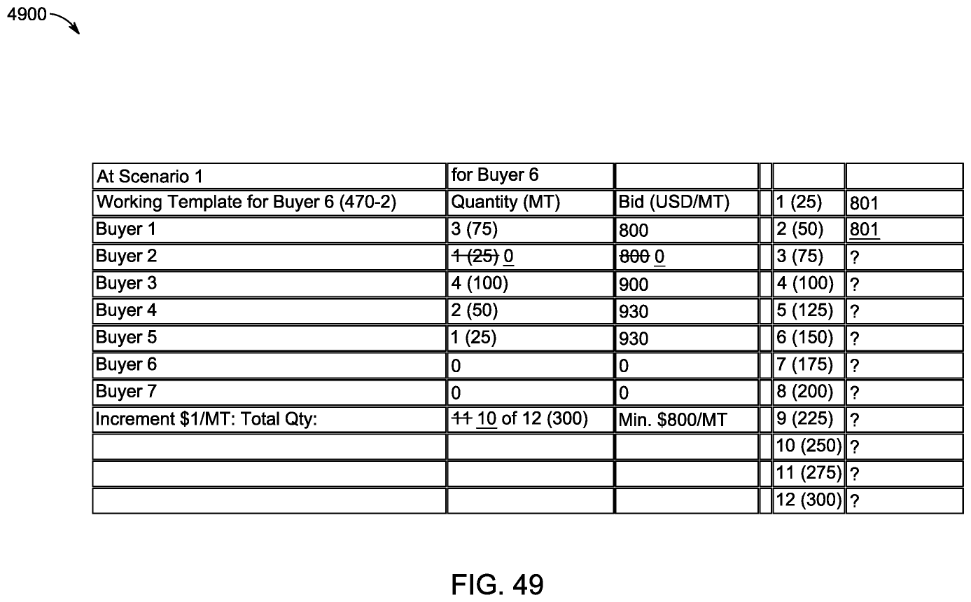

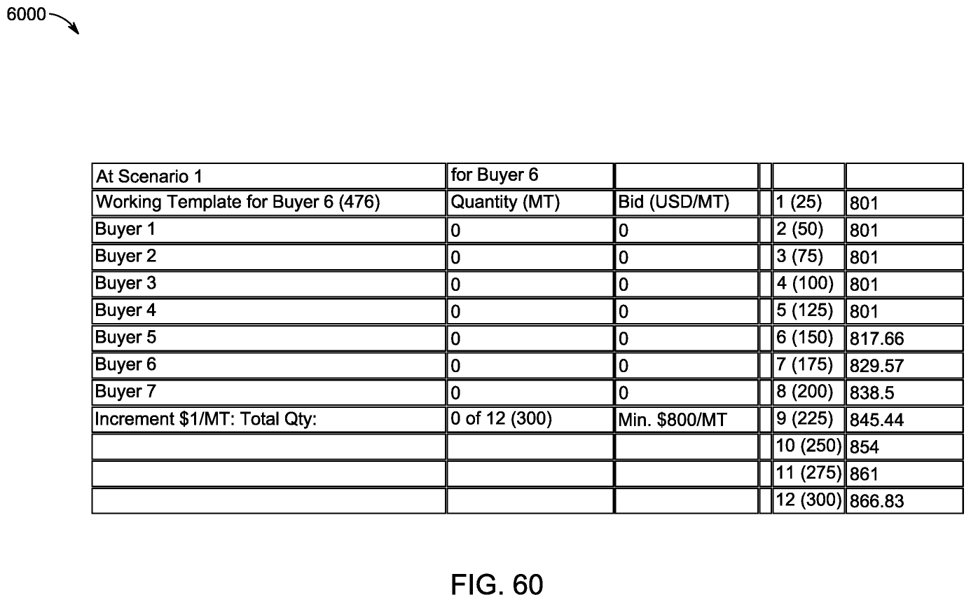

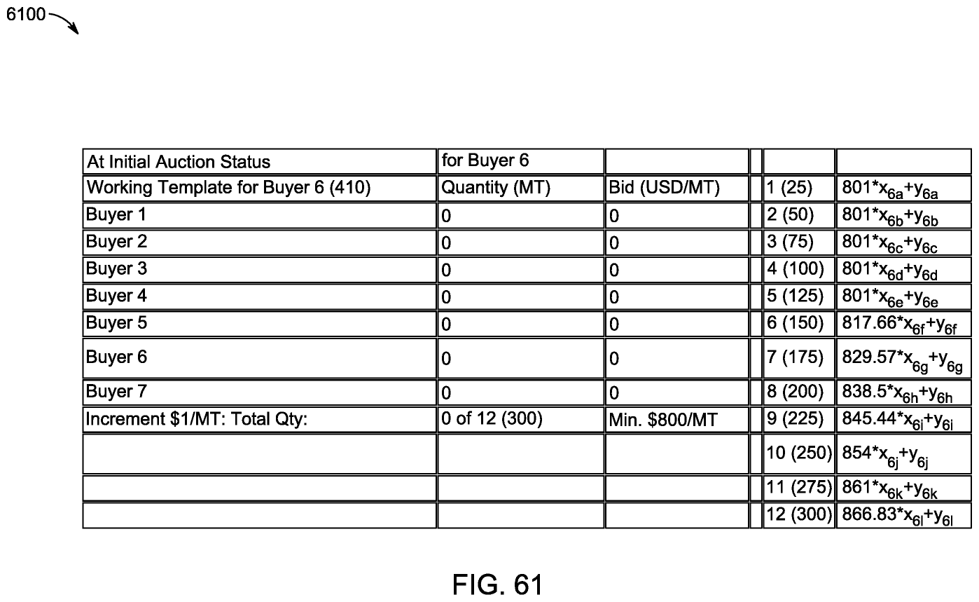

Any suitable number of iterations of operations 474, 470, and 472 may be carried out by process 408A for each of the particular buyers for a particular updated auction status until each of the raw minimum bid values has been defined in each particular buyer's new working template. For example, continuing with the example of buyer 1 after a first iteration of operations 474, 470, and 472 may have produced the updated new working template for buyer 1 as shown by table 2600 of FIG. 26 where a raw minimum bid value has been defined for only the first five smallest possible bid quantities, seven additional iterations of operations 474, 470, and 472 may be carried out by the EASP (e.g., as shown by seven successive updated new working templates for buyer 1 as shown by respective tables 2900-3500 of FIGS. 29-35) until a raw minimum bid value has been defined for all 12 of the possible bid quantities, whereby process 408A may end at operation 476 for the auction status of scenario 1 of table 2000 of FIG. 20 for buyer 1 with a working template for buyer 1 as shown by table 3600 of FIG. 36, and which may then be adjusted at an iteration of operation 410 of process 400 to provide an adjusted working template for buyer 1 as shown by table 3700 of FIG. 37. As another example, continuing with the example of buyer 4 after a first iteration of operations 474, 470, and 472 may have produced the updated new working template for buyer 4 as shown by table 2700 of FIG. 27 where a raw minimum bid value has been defined for only the first three smallest possible bid quantities, nine additional iterations of operations 474, 470, and 472 may be carried out by the EASP (e.g., as shown by nine successive updated new working templates for buyer 4 as shown by respective tables 3800-4600 of FIGS. 38-46) until a raw minimum bid value has been defined for all 12 of the possible bid quantities, whereby process 408A may end at operation 476 for the auction status of scenario 1 of table 2000 of FIG. 20 for buyer 4 with a working template for buyer 4 as shown by table 4700 of FIG. 47, and which may then be adjusted at an iteration of operation 410 of process 400 to provide an adjusted working template for buyer 4 as shown by table 4800 of FIG. 48. As another example, continuing with the example of buyer 6 after a first iteration of operations 474, 470, and 472 may have produced the updated new working template for buyer 6 as shown by table 2800 of FIG. 28 where a raw minimum bid value has been defined for only the first one smallest possible bid quantity, eleven additional iterations of operations 474, 470, and 472 may be carried out by the EASP (e.g., as shown by nine successive updated new working templates for buyer 6 as shown by respective tables 4900-5900 of FIGS. 49-59) until a raw minimum bid value has been defined for all 12 of the possible bid quantities, whereby process 408A may end at operation 476 for the auction status of scenario 1 of table 2000 of FIG. 20 for buyer 6 with a working template for buyer 6 as shown by table 6000 of FIG. 60, and which may then be adjusted at an iteration of operation 410 of process 400 to provide an adjusted working template for buyer 6 as shown by table 6100 of FIG. 61.

As mentioned, after operation 410, process 400 may advance to operation 412, where each adjusted minimum bid value for each possible bid quantity for a particular buyer may be presented to that particular buyer along with any other suitable auction status information (e.g., remaining auction time information, etc.), such that the particular buyer may know what the minimum amount it will cost that buyer to bid on a particular bid quantity at that particular moment in the auction. The value presented to a particular buyer for one, some, or each possible bid quantity may be transparent by showing not only the calculated raw minimum bid value but also the adjusted bid value based on the one or more customization values (e.g., 866.83*x₆₁+y₆₁=z₆₁). Alternatively, the value presented to a particular buyer for one, some, or each possible bid quantity may be opaque by showing only the adjusted bid value and not the calculated raw minimum value or any of the customization values (e.g., z₆₁ only, if the seller does not wish for one or more of the customization values to be known to the buyer or otherwise (e.g., if one or more logistics costs is not to be made publicly available)). All of the adjusted minimum bid values for a particular buyer may be presented to the buyer at once (e.g., in a table or list or graph or otherwise (see, e.g., screen 900 of FIG. 9)) or the buyer may be presented with an adjusted minimum bid value for a selected one or more of the possible bid quantities and others may be selectively presented at the buyer's request (e.g., through use of a slider or any other suitable UI (see, e.g., screen 900A of FIG. 9A and/or screen 900B of FIG. 9B, etc.)). For example, each one of FIGS. 9-9B are illustrative embodiments of how the raw minimum bid value for one, some, or each possible bid quantity for buyer 6 at scenario 1 may be presented to that buyer 6 (e.g., one, some, or each calculated raw minimum bid value of table 6000 of FIG. 60), although it is to be understood that, in some embodiments, these data presentations may instead present the adjusted minimum bid values of table 6100 of FIG. 61. As shown in FIG. 9, each one of the minimum bid values may be presented at the same time in a plotted graph, such as a graph of possible bid quantity (e.g., on the x-axis) plotted against minimum bid price (e.g., on the y-axis), where the BEU presented with the interface (e.g., buyer 6 at operation 412 during scenario 1) may be enabled by the EASP to interact with the interface to select a particular quantity in order to place a bid for the minimum bid value associated with that quantity in the graph (or a value greater than that minimum bid value if they so choose). As shown in FIGS. 9A and 9B, a slider may be provided that may enable the BEU presented with the interface (e.g., buyer 6 at operation 412 during scenario 1) to select one of the possible bid quantities to see the minimum bid value and enable a bid to be placed for that minimum bid value (or a value greater than that minimum bid value if they so choose (e.g., the bid for 50 MTs (2 lots) in FIG. 9A and the bid for 300 MTs (12 lots) in FIG. 9B). These or any other suitable interface may enable a particular buyer to compare and contrast the minimum possible bid value for that buyer for the particular scenario at each one of the possible bid quantities and based on each of the customization value(s) associated with the auction and that buyer efficiently and effectively. While FIGS. 9-9B may indicate that any possible bid quantity is available to buyer 6 in scenario 1 (e.g., due to buyer 6 currently not having any active bid (see, e.g., the current auction status of FIG. 20), it is to be understood that a similar interface presenting option(s) to another particular buyer may disallow certain bids. For example, a similar interface to that of FIG. 9 but presented for buyer 1 may have the first four bid quantities of the graph “grayed out” or otherwise not-selectable by buyer 1 as buyer 1 may already have a current bid for 4 lots (100 MTs) at scenario 1 (see, e.g., the current auction status of FIG. 20), and, therefore, an interface presented to buyer 1 may have a plot showing 12 minimum values but the first four may not be selectable, such that if buyer 1 wants to bid on an additional 1 lot, they must select and place a bid for 5 lots total (125 MTs), although the interface may be configured to communicate to the buyer that they are already the highest bidder for 4 lots even though the quantity they are bidding on is for 5 lots total. By placing a bid for a particular quantity at a particular bid price with the EASP during an auction (e.g., through a buyer affirmatively interfacing with the “place bid” radio button of screen 900B of FIG. 9B), the buyer may be regarded by the EASP as confirming to purchase that quantity for that price if the auction ends while that bid is a current active bid of the auction.

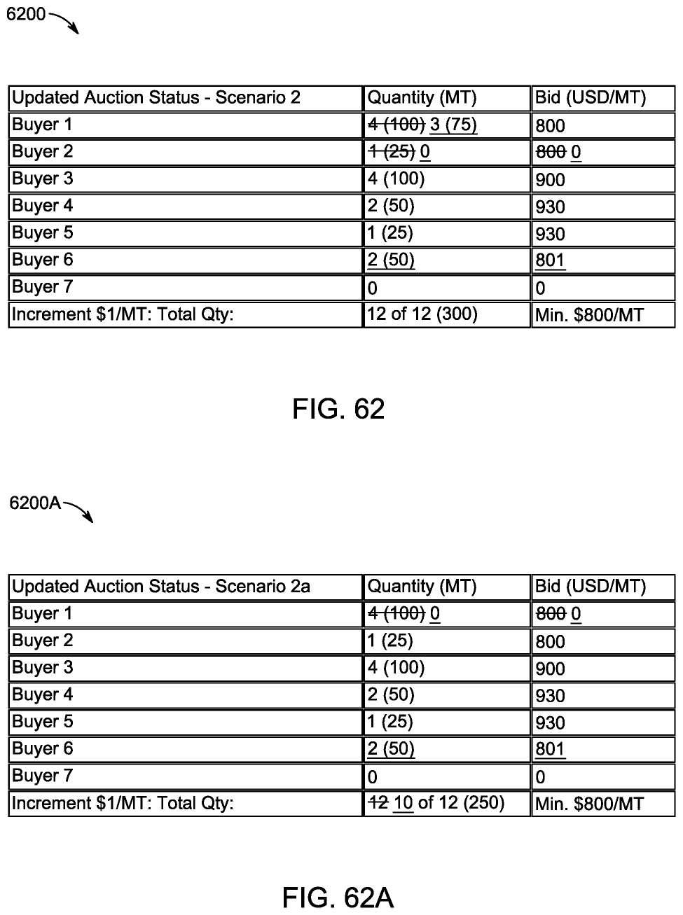

As mentioned, after operation 412, process 400 may advance to operation 414 and, if the auction clock has not expired, to operation 418, where the EASP may be configured to determine if any new bid has been received by any one of the buyers. When a new bid is received from any one of the buyers of the auction, process 400 may advance from operation 418 to operation 420, where the EASP may be configured to update the status of the auction automatically based on the new received bid. Continuing with the example of the auction status of scenario 1, as may be illustrated by table 2000 of FIG. 20, if a new bid is received by the EASP at operation 418 by buyer 6 for 2 lots (e.g., at the adjusted minimum allowable bid of z₆ₐ=801*x₆ₐ+y₆ₐ of table 6100 of FIG. 61), then the EASP may be configured to update the auction status at operation 420 in any suitable manner (e.g., using the bid value once “unadjusted” to determine the raw value of that bid value and otherwise (e.g., based on any suitable auction settings (e.g., as may have been defined by the seller during process 200 and/or by the buyer(s) during process(es) 300 and/or 300A))). As mentioned, at operation 420 of process 400, the EASP may update the status of an active auction based on receiving a new bid. The updated auction status may be defined based on various characteristics defined by the seller and/or by one or more of the buyers of the auction (e.g., at one or more operations of process 200 and/or process 300 and/or process 300A), including, but not limited to, identification of each buyer, total quantity of lots available, a minimum starting price, minimum increment, number of lots currently bid on by a particular buyer, raw minimum bid value per buyer per current bid, the buyer's willingness to have a current active bid reduced vs. fully removed, a seller's willingness to have a current active bid reduced vs. fully removed, and/or the like. As just one particular example, operation 420 may include the EASP (e.g., EAS subsystem 10) obtaining various values for various types of auction data during process 200 and/or process 300 and/or process 300A for the particular auction as well as the current auction status prior to receiving the new bid, and information indicative of the received new bid for defining the updated auction status, of which an exemplary first embodiment may be shown by an updated auction status of table 6200 of FIG. 62 for a scenario 2 if a new bid is received by the EASP at operation 418 by buyer 6 for 2 lots during scenario 1. As shown in FIG. 62, the exemplary updated auction status (e.g., for a “Scenario 2” may identify that each one of the 12 total lots has a current active bid placed on it (e.g., 12 lots of 25 MTs each of auctioned product (e.g., 300 MTs of auctioned product total)), 7 buyers (e.g., Buyer 1-Buyer 7), where buyer 1 currently has an active bid for 3 lots (75 MTs of auctioned product) at a raw bid value of $800/MT (e.g., the same raw bid value but for 1 less lot than in scenario 1), where buyer 2 currently has an active bid for 0 lots (0 MTs of auctioned product) (e.g., buyer 2's entire previously active bid for 1 lot from scenario 1 has been terminated), where buyer 3 still has an active bid for 4 lots (100 MTs of auctioned product) at a raw bid value of $900/MT (e.g., the same bid as active in scenario 1), where buyer 4 still has an active bid for 2 lots (50 MTs of auctioned product) at a raw bid value of $930/MT (e.g., the same bid as active in scenario 1), where buyer 5 still has an active bid for 1 lot (25 MTs of auctioned product) at a raw bid value of $930/MT (e.g., the same bid as active in scenario 1), where buyer 6 now has an active bid for 2 lots (50 MTs of auctioned product) at a raw bid value of $801/MT (e.g., a new active bid that did not exist in scenario 1 but that is based on the minimum raw bid value for 2 lots by buyer 6 as shown in table 6000 of FIG. 60), and where buyer 7 still has no active bids, while the auction still remains defined to include an increment of $1/MT, and a minimum starting price of $800/MT. Therefore, in this embodiment, the 2 lots now actively bid on by buyer 6 have been pulled equally from buyer 1 and buyer 2 (i.e., 1 lot from buyer 1 and 1 lot from buyer 2), each of whom previously had active bids at the lowest raw bid value (e.g., $800/MT), such that operation 420 may include the EASP being configured to update the list of what bidders own what amount at what price (one price/amount per bidder using raw bid value) by removing amount(s) of lowest bidder(s) to accommodate the new current active bid received at operation 418. In other embodiments, rather than pulling lots equally from multiple buyers' active bids, the auction may be configured such that the EASP may pull from one buyer's active bid over another buyer's active bid based on which of those buyers made their bid more recently (e.g., the later-submitted of the multiple buyers' active bids may be pulled from before the earlier-submitted of the multiple buyers' active bids).

However, rather than removing 1 lot from each of buyers 1 and 2 having previous active bids with the lowest raw bid amounts, the EASP may instead be configured by the previously defined auction settings to remove all the lots from a first buyer before also affecting the current active bid of another buyer (e.g., to minimize the number of previously active bids that are affected by the new received bid). Therefore, as just one other particular example, operation 420 may include the EASP (e.g., EAS subsystem 10) obtaining various values for various types of auction data during process 200 and/or process 300 and/or process 300A for the particular auction as well as the current auction status prior to receiving the new bid, and information indicative of the received new bid for defining the updated auction status, of which an exemplary second embodiment may be shown by an updated auction status of table 6200A of FIG. 62A for a scenario 2a if a new bid is received by the EASP at operation 418 by buyer 6 for 2 lots during scenario 1. As shown in FIG. 62A, the exemplary updated auction status (e.g., for a “Scenario 2A” may identify that only 10 of the 12 total lots has a current active bid placed on it (e.g., 10 lots of 25 MTs each of auctioned product (e.g., 250 MTs of auctioned product total)), 7 buyers (e.g., Buyer 1-Buyer 7), where buyer 1 currently has an active bid for 0 lots (0 MTs of auctioned product) (e.g., buyer 1's entire previously active bid for 4 lots from scenario 1 has been terminated), where buyer 2 still has an active bid for 1 lot (25 MTs of auctioned product) at a raw bid value of $800/MT (e.g., the same bid as active in scenario 1), where buyer 3 still has an active bid for 4 lots (100 MTs of auctioned product) at a raw bid value of $900/MT (e.g., the same bid as active in scenario 1), where buyer 4 still has an active bid for 2 lots (50 MTs of auctioned product) at a raw bid value of $930/MT (e.g., the same bid as active in scenario 1), where buyer 5 still has an active bid for 1 lot (25 MTs of auctioned product) at a raw bid value of $930/MT (e.g., the same bid as active in scenario 1), where buyer 6 now has an active bid for 2 lots (50 MTs of auctioned product) at a raw bid value of $801/MT (e.g., a new active bid that did not exist in scenario 1 but that is based on the minimum raw bid value for 2 lots by buyer 6 as shown in table 6000 of FIG. 60), and where buyer 7 still has no active bids, while the auction still remains defined to include an increment of $1/MT, and a minimum starting price of $800/MT. Therefore, in this embodiment, the 2 lots now actively bid on by buyer 6 have been pulled completely from buyer 1 and not at all from buyer 2 (i.e., 2 lots from buyer 1), who previously had an active bid for 4 lots at the lowest raw bid value (e.g., $800/MT), such that operation 420 may include the EASP being configured to update the list of what bidders own what amount at what price (one price/amount per bidder using raw bid value) by removing amount(s) of lowest bidder(s) to accommodate the new current active bid received at operation 418. However, rather than removing 1 lot from each of buyers 1 and 2 having previous active bids with the lowest raw bid amounts, the EASP has instead been configured by the previously defined auction settings to remove all the lots from a first buyer before also affecting the current active bid of another buyer (e.g., to minimize the number of previously active bids that are affected by the new received bid). This may be desired if buyer 1 does not wish for a previously active bid to be reduced, but would instead prefer it to be terminated (e.g., if buyer 1 needs 4 lots but has no need for only 3 lots). By returning certain lots back to being available as if not currently bid on, scenario 2A may result in different raw minimum bid value(s) for one or more buyers than might have been possible for scenario 2 where all lots were actively bid on. For example, when scenario 2A is the current auction status, operations 462, 464, and 466 may be utilized by process 408A of operation 408, which may lower the raw minimum bid value that may be defined for one or more possible bid quantities for one or more buyers than may be possible by process 408A of operation 408 when all lots of the auction are currently part of an active bid (e.g., when scenario 2 is the current auction status).

Therefore, the EASP may be configured to automatically calculate and then present to each one of any suitable number of buyers a customized allowed minimum bid value for each buyer for each one of any suitable number of possible bid quantities (e.g., lot sizes) in any suitable auction type (e.g., an English-Yankee auction) based on any particular auction scenario characteristics at any particular moment in time during the auction, including, but not limited to, the current active bid value and quantity of each buyer, the current number of unbid lots, any buyer-customization variables, and/or the like. The raw minimum bid values may be calculated and optionally adjusted and then presented on a per-buyer basis in response to any change in the status of the current active bids in an auction. The number of rapid calculations that may be carried out automatically and instantaneously by the EASP to enable such an auction may be too vast to be carried out in a timely manner for enabling a user-friendly auction experience unless carried out by an electronic computing platform of the EASP. The EASP may enable transparency or selective opaqueness with respect to the variable logistics, shipping, packaging, and/or other suitable costs associated with auction of a lot-divisible auction product while allowing customizable and fast auction update times for all bidders regardless of whether or not they have an active bid. Much of process 400 may be carried out transparently to a buyer for providing a more seamless and secure and efficient and effective user experience. For example, if buyer 1 is the buyer that places the new bid received by the EASP at operation 418, then operations 420-410 may be transparent to buyer 1 and buyer 1 will be presented with an updated set of adjusted minimum bid values and auction status at operation 412. As another example, if buyer 2 is the buyer that places the new bid received by the EASP at operation 418, then operations 418-410 may be transparent to buyer 6 and buyer 6, while being presented with a first set of adjusted minimum bid values and auction status by a first iteration of operation 412, will be presented automatically with an updated second set of adjusted minimum bid values and auction status by a second iteration of operation 412 (e.g., after operations 418-410 are automatically carried out by the EASP in response to receiving the new bid from buyer 2) (e.g., operations 418-412 may be transparent to buyer 6 between being presented with screen 900 of FIG. 9 and being presented with an updated version thereof in response to the EASP automatically processing a received new bid from another buyer at operation 418 (e.g., the EASP may be configured to generate and present an active and dynamic minimum allowable bid value graph to each buyer that is customized for each buyer and the current status of an auction that may be changing rapidly as new bids are received)). The processing power and communication speed of the EASP may be configured to conduct an English-Yankee auction with any suitable number of distinct buyers (e.g., any suitable number of distinct BEU subsystems 100) and to calculate and adjust and present automatically and instantaneously or substantially instantaneously to each buyer a set of updated minimum bid values that are customized to each buyer in response to any new bid being received or any other suitable change in status of the auction, such that the auction may run quickly and smoothly for all buyers. This may enable the auction to run as efficiently as possible, as each buyer may be presented with all the various minimum bid values that are available to them the moment an auction status change occurs, rather than requiring each buyer to guess what a minimum acceptable bid value might be at any given moment and/or rather than pausing an auction in order to run all the numerous calculations described herein.

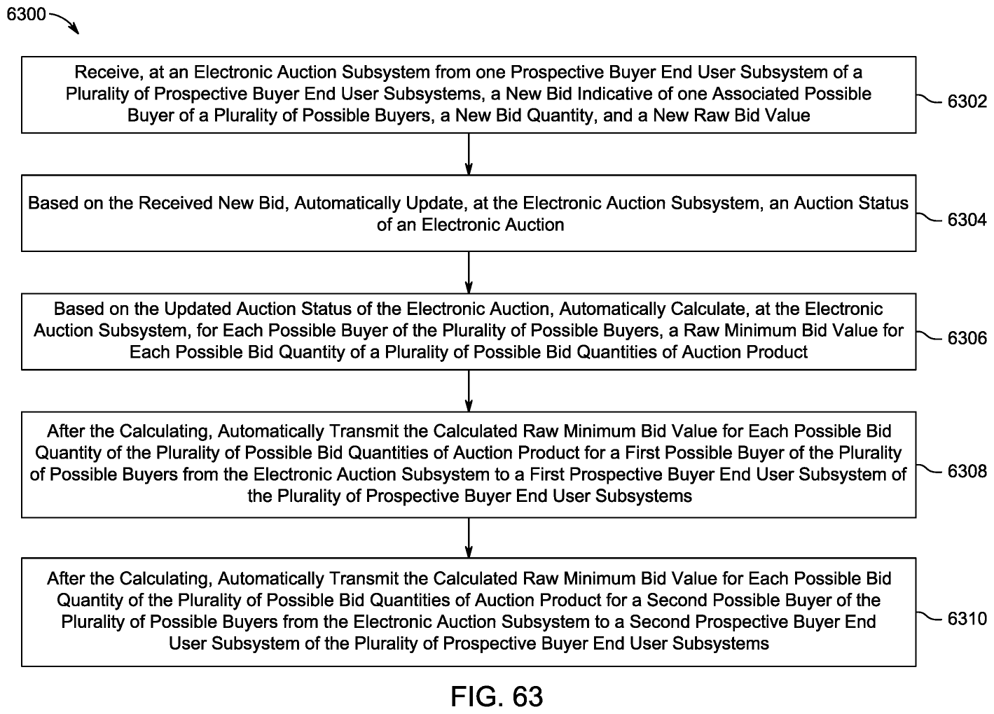

FIG. 63 is a flowchart of an illustrative process 6300 for facilitating, at an electronic auction subsystem including a communications component and a memory and at least one processor, an electronic auction between a prospective seller end user subsystem and a plurality of prospective buyer end user subsystems, wherein the electronic auction may include an auction status indicative of a plurality of possible buyers, a plurality of possible bid quantities of auction product, a minimum starting bid value, a minimum increment value, and, for each current active bid of the auction, a current bid quantity, a current raw bid value, and an associated possible buyer of the plurality of possible buyers. At operation 6302 of process 6300, the electronic auction subsystem may receive from one prospective buyer end user subsystem of the plurality of prospective buyer end user subsystems a new bid that may be indicative of one associated possible buyer of the plurality of possible buyers, a new bid quantity, and a new raw bid value (see, e.g., operation 418 of process 400). At operation 6304 of process 6300, based on the received new bid, the electronic auction subsystem may automatically update the auction status of the electronic auction (see, e.g., operation 420 of process 400). At operation 6306 of process 6300, based on the updated auction status of the electronic auction, the electronic auction subsystem may automatically calculate, for each possible buyer of the plurality of possible buyers, a raw minimum bid value for each possible bid quantity of the plurality of possible bid quantities of auction product (see, e.g., operation 408 of process 400). At operation 6308 of process 6300, after the calculating of operation 6306, the electronic auction subsystem may automatically transmit the calculated raw minimum bid value for each possible bid quantity of the plurality of possible bid quantities of auction product for a first possible buyer of the plurality of possible buyers to a first prospective buyer end user subsystem of the plurality of prospective buyer end user subsystems (see, e.g., operation 412 of process 400). At operation 6310 of process 6300, after the calculating of operation 6306, the electronic auction subsystem may automatically transmit the calculated raw minimum bid value for each possible bid quantity of the plurality of possible bid quantities of auction product for a second possible buyer of the plurality of possible buyers to a second prospective buyer end user subsystem of the plurality of prospective buyer end user subsystems (see, e.g., operation 412 of process 400).

It is understood that the operations shown in process 6300 of FIG. 63 are only illustrative and that existing operations may be modified or omitted, additional operations may be added, and the order of certain operations may be altered.

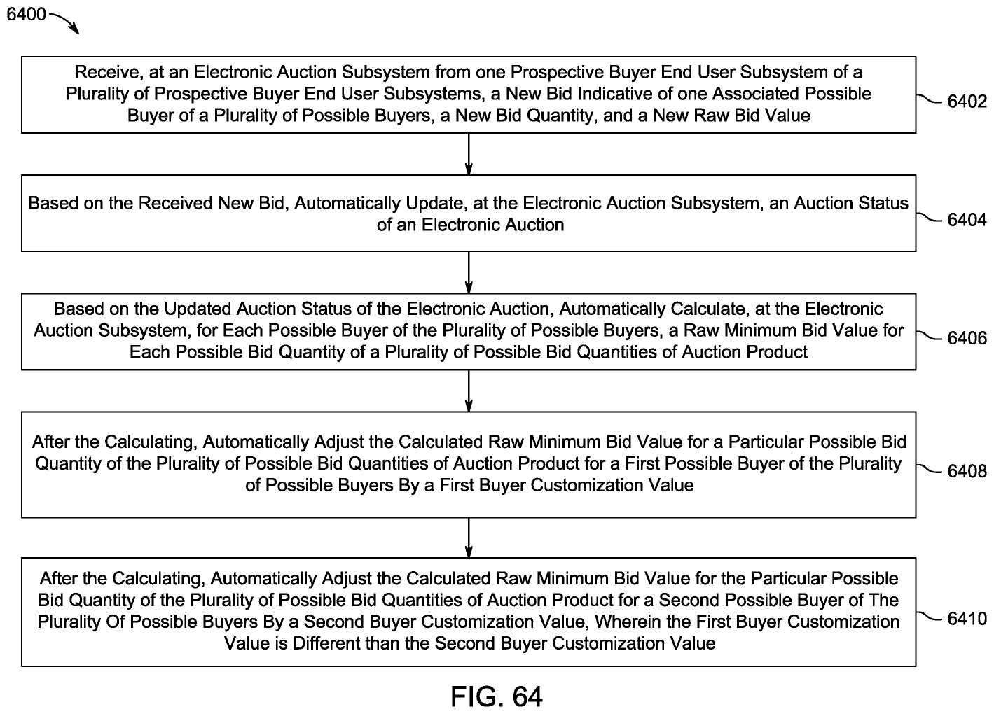

FIG. 64 is a flowchart of an illustrative process 6400 for facilitating, at an electronic auction subsystem including a communications component and a memory and at least one processor, an electronic auction between a prospective seller end user subsystem and a plurality of prospective buyer end user subsystems, wherein the electronic auction may include an auction status indicative of a plurality of possible buyers, a plurality of possible bid quantities of auction product, a minimum starting bid value, a minimum increment value, at least one first buyer-customization value associated with a first possible buyer of the plurality of possible buyers, at least one second buyer-customization value associated with a second possible buyer of the plurality of possible buyers and, for each current active bid of the auction, a current bid quantity, a current raw bid value, and an associated possible buyer of the plurality of possible buyers. At operation 6402 of process 6400, the electronic auction subsystem may receive, from one prospective buyer end user subsystem of the plurality of prospective buyer end user subsystems, a new bid indicative of one associated possible buyer of the plurality of possible buyers, a new bid quantity, and a new raw bid value (see, e.g., operation 418 of process 400). At operation 6404 of process 6400, based on the received new bid, the electronic auction subsystem may automatically update the auction status of the electronic auction (see, e.g., operation 420 of process 400). At operation 6406 of process 6400, based on the updated auction status of the electronic auction, the electronic auction subsystem may automatically calculate, for each possible buyer of the plurality of possible buyers, a raw minimum bid value for each possible bid quantity of the plurality of possible bid quantities of auction product (see, e.g., operation 408 of process 400). At operation 6408 of process 6400, after the calculation of operation 6406, the electronic auction subsystem may automatically adjust the calculated raw minimum bid value for a particular possible bid quantity of the plurality of possible bid quantities of auction product for the first possible buyer by the first buyer-customization value (see, e.g., operation 410 of process 400). At operation 6410 of process 6400, after the calculation of operation 6406, the electronic auction subsystem may automatically adjust the calculated raw minimum bid value for a particular possible bid quantity of the plurality of possible bid quantities of auction product for the second possible buyer by the second buyer-customization value, wherein the first buyer customization value may be different than the second buyer customization value (see, e.g., operation 410 of process 400).

It is understood that the operations shown in process 6400 of FIG. 64 are only illustrative and that existing operations may be modified or omitted, additional operations may be added, and the order of certain operations may be altered.

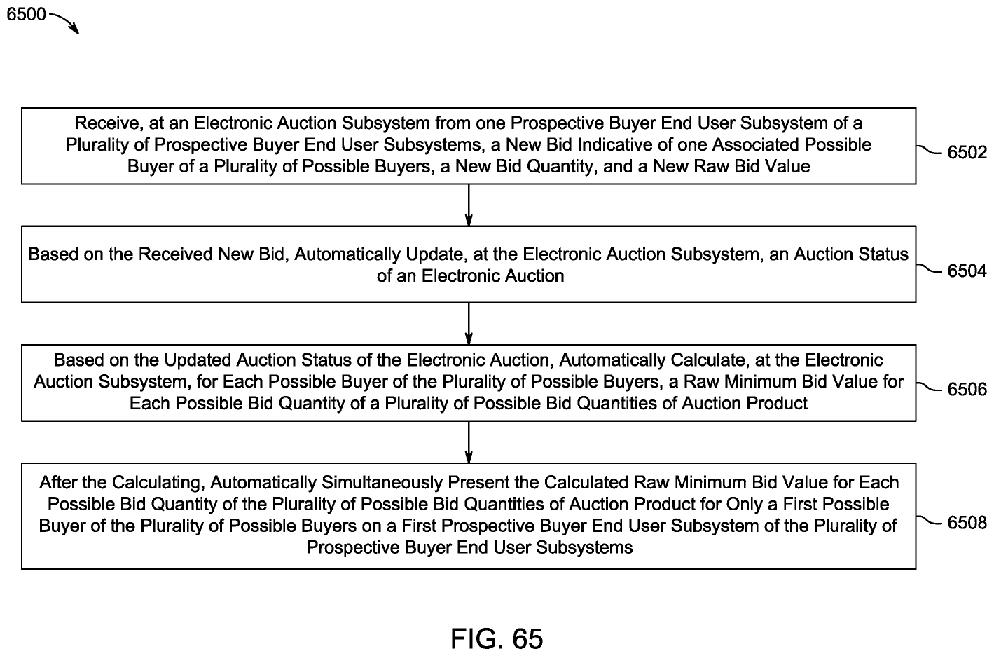

FIG. 65 is a flowchart of an illustrative process 6500 for facilitating, at an electronic auction subsystem including a communications component and a memory and at least one processor, an electronic auction between a prospective seller end user subsystem and a plurality of prospective buyer end user subsystems, wherein the electronic auction may include an auction status indicative of a plurality of possible buyers, a plurality of possible bid quantities of auction product, a minimum starting bid value, a minimum increment value, and, for each current active bid of the auction, a current bid quantity, a current raw bid value, and an associated possible buyer of the plurality of possible buyers. At operation 6502 of process 6500, the electronic auction subsystem may receive, from one prospective buyer end user subsystem of the plurality of prospective buyer end user subsystems, a new bid indicative of one associated possible buyer of the plurality of possible buyers, a new bid quantity, and a new raw bid value (see, e.g., operation 418 of process 400). At operation 6504 of process 6500, based on the received new bid, the electronic auction subsystem may automatically update the auction status of the electronic auction (see, e.g., operation 420 of process 400). At operation 6506 of process 6500, based on the updated auction status of the electronic auction, the electronic auction subsystem may automatically calculate, for each possible buyer of the plurality of possible buyers, a raw minimum bid value for each possible bid quantity of the plurality of possible bid quantities of auction product (see, e.g., operation 408 of process 400). At operation 6508 of process 6500, after the calculation of operation 6506, a first prospective buyer end user subsystem of the plurality of prospective buyer end user subsystems may automatically simultaneously present the calculated raw minimum bid value for each possible bid quantity of the plurality of possible bid quantities of auction product for only a first possible buyer of the plurality of possible buyers (see, e.g., operation 412 of process 400 and/or the GUI of screen 900 of FIG. 9).

It is understood that the operations shown in process 6500 of FIG. 65 are only illustrative and that existing operations may be modified or omitted, additional operations may be added, and the order of certain operations may be altered.

One, some, or all of the processes described with respect to FIGS. 1-65 may each be implemented by software, but may also be implemented in hardware, firmware, or any combination of software, hardware, and firmware. Instructions for performing these processes may also be embodied as machine- or computer-readable code recorded on a machine- or computer-readable medium. In some embodiments, the computer-readable medium may be a non-transitory computer-readable medium. Examples of such a non-transitory computer-readable medium include but are not limited to a read-only memory, a random-access memory, a flash memory, a CD-ROM, a DVD, a magnetic tape, a removable memory card, and a data storage device (e.g., memory 113 of a subsystem 100). In other embodiments, the computer-readable medium may be a transitory computer-readable medium. In such embodiments, the transitory computer-readable medium can be distributed over network-coupled computer systems so that the computer-readable code is stored and executed in a distributed fashion. For example, such a transitory computer-readable medium may be communicated from EAS subsystem 10 to a subsystem 100, from a subsystem 100 to EAS subsystem 10, and/or from one subsystem 100 to another subsystem 100 using any suitable communications protocol (e.g., the computer-readable medium may be communicated to a subsystem 100 via communications component 14/114 (e.g., as at least a portion of a data structure 119)). Such a transitory computer-readable medium may embody computer-readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal.

Any, each, or at least one module or component or subsystem of the disclosure may be provided as a software construct, firmware construct, one or more hardware components, or a combination thereof. For example, any, each, or at least one module or component or subsystem of system 1 may be described in the general context of computer-executable instructions, such as program modules, that may be executed by one or more computers or other devices. Generally, a program module may include one or more routines, programs, objects, components, and/or data structures that may perform one or more particular tasks or that may implement one or more particular abstract data types. The number, configuration, functionality, and interconnection of the modules and components and subsystems of system 1 are only illustrative, and that the number, configuration, functionality, and interconnection of existing modules, components, and/or subsystems may be modified or omitted, additional modules, components, and/or subsystems may be added, and the interconnection of certain modules, components, and/or subsystems may be altered.

While there have been described systems, methods, and computer-readable media for carrying out multi-lot, multi-buyer auctions on electronic auction platforms, many changes may be made therein without departing from the spirit and scope of the subject matter described herein in any way. Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

Therefore, those skilled in the art will appreciate that the concepts of the disclosure can be practiced by other than the described embodiments, which are presented for purposes of illustration rather than of limitation.

What is claimed is:

1. A computer-implemented method of facilitating, at an electronic auction subsystem comprising a communications component and a memory and at least one processor, an electronic auction between a prospective seller end user subsystem and a plurality of prospective buyer end user subsystems, wherein the electronic auction comprises an auction status indicative of a plurality of possible buyers, a plurality of possible bid quantities of auction product, a minimum starting bid value, a minimum increment value, and, for each current active bid of the auction, a current bid quantity, a current raw bid value, and an associated possible buyer of the plurality of possible buyers, the method comprising:
receiving, at the electronic auction subsystem from one prospective buyer end user subsystem of the plurality of prospective buyer end user subsystems, a new bid indicative of:
one associated possible buyer of the plurality of possible buyers;
a new bid quantity; and
a new raw bid value;
based on the received new bid, automatically updating, at the electronic auction subsystem, the auction status of the electronic auction;
based on the updated auction status of the electronic auction, automatically calculating, at the electronic auction subsystem, for each possible buyer of the plurality of possible buyers, a raw minimum bid value for each possible bid quantity of the plurality of possible bid quantities of auction product; and
after the calculating, automatically transmitting:
the calculated raw minimum bid value for each possible bid quantity of the plurality of possible bid quantities of auction product for a first possible buyer of the plurality of possible buyers from the electronic auction subsystem to a first prospective buyer end user subsystem of the plurality of prospective buyer end user subsystems; and
the calculated raw minimum bid value for each possible bid quantity of the plurality of possible bid quantities of auction product for a second possible buyer of the plurality of possible buyers from the electronic auction subsystem to a second prospective buyer end user subsystem of the plurality of prospective buyer end user subsystems.

2. The method of claim 1, further comprising, at the first prospective buyer end user subsystem, simultaneously presenting the calculated raw minimum bid value for each possible bid quantity of the plurality of possible bid quantities of auction product for the first possible buyer.

3. The method of claim 2, further comprising, at the second prospective buyer end user subsystem, simultaneously presenting the calculated raw minimum bid value for each possible bid quantity of the plurality of possible bid quantities of auction product for the second possible buyer.

4. The method of claim 1, wherein the calculated raw minimum bid value for a particular possible bid quantity of the plurality of possible bid quantities of auction product for the first possible buyer is different than the calculated raw minimum bid value for the particular possible bid quantity of the plurality of possible bid quantities of auction product for the second possible buyer.

5. The method of claim 1, wherein the calculated raw minimum bid value for each possible bid quantity of the plurality of possible bid quantities of auction product for the first possible buyer is different than the calculated raw minimum bid value for each possible bid quantity of the plurality of possible bid quantities of auction product for the second possible buyer.

6. The method of claim 1, wherein:
the electronic auction further comprises at least one first buyer-customization value associated with the first possible buyer; and
the method further comprises adjusting the calculated raw minimum bid value for at least one possible bid quantity of the plurality of possible bid quantities of auction product for the first possible buyer of the plurality of possible buyers based on the at least one first buyer-customization value associated with the first possible buyer.

7. The method of claim 6, further comprising, at the first prospective buyer end user subsystem, presenting the adjusted raw minimum bid value for the at least one possible bid quantity of the plurality of possible bid quantities of auction product for the first possible buyer.

8. The method of claim 7, wherein the presenting does not comprise presenting the at least one first buyer-customization value.

9. The method of claim 6, wherein the first buyer-customization value is operative to adjust the calculated raw minimum bid value for the at least one possible bid quantity of the plurality of possible bid quantities of auction product for the first possible buyer by a particular amount based on a particular shipping option of the electronic auction selected by the first possible buyer prior to the receiving.

10. The method of claim 6, wherein the first buyer-customization value is operative to adjust the calculated raw minimum bid value for the at least one possible bid quantity of the plurality of possible bid quantities of auction product for the first possible buyer by a particular amount based on a particular packaging option of the electronic auction selected by the first possible buyer prior to the receiving.

11. The method of claim 6, wherein the first buyer-customization value is operative to adjust the calculated raw minimum bid value for the at least one possible bid quantity of the plurality of possible bid quantities of auction product for the first possible buyer by a particular amount based on a particular logistics option of the electronic auction selected by the first possible buyer prior to the receiving.

12. The method of claim 1, wherein:
the electronic auction further comprises:
at least one first buyer-customization value associated with the first possible buyer; and
at least one second buyer-customization value associated with the second possible buyer; and
the method further comprises:
based on the at least one first buyer-customization value, adjusting the calculated raw minimum bid value for a particular possible bid quantity of the plurality of possible bid quantities of auction product for the first possible buyer by a first amount based on a logistics option of the electronic auction selected by the first possible buyer prior to the receiving; and
based on the at least one second buyer-customization value, adjusting the calculated raw minimum bid value for the particular possible bid quantity of the plurality of possible bid quantities of auction product for the second possible buyer by a second amount based on a logistics option of the electronic auction selected by the second possible buyer prior to the receiving, wherein the first amount is different than the second amount.

13. The method of claim 1, wherein, for a particular possible buyer of the plurality of possible buyers, the automatically calculating comprises:
creating a new working template for the particular possible buyer;
in the new working template for the particular possible buyer, storing:
the updated auction status as a current auction status; and
an undefined raw minimum bid value for each possible bid quantity of the plurality of possible bid quantities of auction product; and
when the particular possible buyer is associated with a current active bid for a current bid quantity and a current raw bid value in the current auction status of the new working template for the particular possible buyer, defining, in the new working template for the particular possible buyer, the raw minimum bid value for each possible bid quantity that is no greater than the current bid quantity to be the current raw bid value.

14. The method of claim 13, wherein, for the particular possible buyer of the plurality of possible buyers, the automatically calculating further comprises:
until no possible bid quantity of the plurality of possible bid quantities of auction product is not part of any current active bid in the current auction status of the new working template for the particular possible buyer:
defining, in the new working template for the particular possible buyer, the raw minimum bid value for the smallest possible bid quantity that is undefined to be the quotient of: (1) the sum of: (a) the minimum starting bid value; and (b) the product of: (bi) the raw minimum bid value for the largest possible bid quantity that is already defined in the new working template for the particular possible buyer; and (bii) the largest possible bid quantity that has an already defined raw minimum bid value in the new working template for the particular possible buyer; and (2) the smallest possible bid quantity that has an undefined raw minimum bid value in the new working template for the particular possible buyer; and
removing a single possible bid quantity from the number of possible bid quantities not part of any current active bid in the current auction status of the new working template for the particular possible buyer.

15. The method of claim 14, wherein, for the particular possible buyer of the plurality of possible buyers, the automatically calculating further comprises:
when no possible bid quantity of the plurality of possible bid quantities of auction product is not part of any current active bid in the current auction status of the new working template for the particular possible buyer, removing any current active bid of the particular possible buyer from the current auction status of the new working template for the particular possible buyer; and
until no possible bid quantity of the plurality of possible bid quantities of auction product has an undefined raw minimum bid value in the new working template for the particular possible buyer:
defining, in the new working template for the particular possible buyer, the raw minimum bid value for the smallest possible bid quantity that is undefined to be the quotient of: (1) the sum of: (a) the minimum increment value; (b) the lowest raw bid value of any current active bid in the current auction status of the new working template for the particular possible buyer; and (c) the product of: (ci) the raw minimum bid value for the largest possible bid quantity that is already defined in the new working template for the particular possible buyer; and (cii) the largest possible bid quantity that has an already defined raw minimum bid value in the new working template for the particular possible buyer; and (2) the smallest possible bid quantity that has an undefined raw minimum bid value in the new working template for the particular possible buyer; and
removing a single possible bid quantity from any current active bid with the lowest raw bid value in the current auction status of the new working template for the particular possible buyer.

16. The method of claim 1, wherein, for a particular possible buyer of the plurality of possible buyers, the automatically calculating comprises:
creating a new working template for the particular possible buyer;
in the new working template for the particular possible buyer, storing:
the updated auction status as a current auction status; and
an undefined raw minimum bid value for each possible bid quantity of the plurality of possible bid quantities of auction product; and
until no possible bid quantity of the plurality of possible bid quantities of auction product is not part of any current active bid in the current auction status of the new working template for the particular possible buyer:
defining, in the new working template for the particular possible buyer, the raw minimum bid value for the smallest possible bid quantity that is undefined to be the quotient of: (1) the sum of: (a) the minimum starting bid value; and (b) the product of: (bi) the raw minimum bid value for the largest possible bid quantity that is already defined in the new working template for the particular possible buyer; and (bii) the largest possible bid quantity that has an already defined raw minimum bid value in the new working template for the particular possible buyer; and (2) the smallest possible bid quantity that has an undefined raw minimum bid value in the new working template for the particular possible buyer; and
removing a single possible bid quantity from the number of possible bid quantities not part of any current active bid in the current auction status of the new working template for the particular possible buyer.

17. The method of claim 16, wherein, for the particular possible buyer of the plurality of possible buyers, the automatically calculating further comprises:
when no possible bid quantity of the plurality of possible bid quantities of auction product is not part of any current active bid in the current auction status of the new working template for the particular possible buyer, removing any current active bid of the particular possible buyer from the current auction status of the new working template for the particular possible buyer; and
until no possible bid quantity of the plurality of possible bid quantities of auction product has an undefined raw minimum bid value in the new working template for the particular possible buyer:
defining, in the new working template for the particular possible buyer, the raw minimum bid value for the smallest possible bid quantity that is undefined to be the quotient of: (1) the sum of: (a) the minimum increment value; (b) the lowest raw bid value of any current active bid in the current auction status of the new working template for the particular possible buyer; and (c) the product of: (ci) the raw minimum bid value for the largest possible bid quantity that is already defined in the new working template for the particular possible buyer; and (cii) the largest possible bid quantity that has an already defined raw minimum bid value in the new working template for the particular possible buyer; and (2) the smallest possible bid quantity that has an undefined raw minimum bid value in the new working template for the particular possible buyer; and
removing a single possible bid quantity from any current active bid with the lowest raw bid value in the current auction status of the new working template for the particular possible buyer.

18. The method of claim 1, wherein, for a particular possible buyer of the plurality of possible buyers, the automatically calculating comprises:
creating a new working template for the particular possible buyer;
in the new working template for the particular possible buyer, storing:
the updated auction status as a current auction status; and
an undefined raw minimum bid value for each possible bid quantity of the plurality of possible bid quantities of auction product;
when no possible bid quantity of the plurality of possible bid quantities of auction product is not part of any current active bid in the current auction status of the new working template for the particular possible buyer, removing any current active bid of the particular possible buyer from the current auction status of the new working template for the particular possible buyer; and
until no possible bid quantity of the plurality of possible bid quantities of auction product has an undefined raw minimum bid value in the new working template for the particular possible buyer:
defining, in the new working template for the particular possible buyer, the raw minimum bid value for the smallest possible bid quantity that is undefined to be the quotient of: (1) the sum of: (a) the minimum increment value; (b) the lowest raw bid value of any current active bid in the current auction status of the new working template for the particular possible buyer; and (c) the product of: (ci) the raw minimum bid value for the largest possible bid quantity that is already defined in the new working template for the particular possible buyer; and (cii) the largest possible bid quantity that has an already defined raw minimum bid value in the new working template for the particular possible buyer; and (2) the smallest possible bid quantity that has an undefined raw minimum bid value in the new working template for the particular possible buyer; and
removing a single possible bid quantity from any current active bid with the lowest raw bid value in the current auction status of the new working template for the particular possible buyer.

19. A computer-implemented method of facilitating, at an electronic auction subsystem comprising a communications component and a memory and at least one processor, an electronic auction between a prospective seller end user subsystem and a plurality of prospective buyer end user subsystems, wherein the electronic auction comprises an auction status indicative of a plurality of possible buyers, a plurality of possible bid quantities of auction product, a minimum starting bid value, a minimum increment value, at least one first buyer-customization value associated with a first possible buyer of the plurality of possible buyers, at least one second buyer-customization value associated with a second possible buyer of the plurality of possible buyers and, for each current active bid of the auction, a current bid quantity, a current raw bid value, and an associated possible buyer of the plurality of possible buyers, the method comprising:
receiving, at the electronic auction subsystem from one prospective buyer end user subsystem of the plurality of prospective buyer end user subsystems, a new bid indicative of:
one associated possible buyer of the plurality of possible buyers;
a new bid quantity; and
a new raw bid value;
based on the received new bid, automatically updating, at the electronic auction subsystem, the auction status of the electronic auction;
based on the updated auction status of the electronic auction, automatically calculating, at the electronic auction subsystem, for each possible buyer of the plurality of possible buyers, a raw minimum bid value for each possible bid quantity of the plurality of possible bid quantities of auction product; and
after the calculating:
automatically adjusting the calculated raw minimum bid value for a particular possible bid quantity of the plurality of possible bid quantities of auction product for the first possible buyer by the first buyer-customization value; and
automatically adjusting the calculated raw minimum bid value for the particular possible bid quantity of the plurality of possible bid quantities of auction product for the second possible buyer by the second buyer-customization value, wherein the first buyer-customization value is different than the second buyer-customization value.

20. A computer-implemented method of facilitating, at an electronic auction subsystem comprising a communications component and a memory and at least one processor, an electronic auction between a prospective seller end user subsystem and a plurality of prospective buyer end user subsystems, wherein the electronic auction comprises an auction status indicative of a plurality of possible buyers, a plurality of possible bid quantities of auction product, a minimum starting bid value, a minimum increment value, and, for each current active bid of the auction, a current bid quantity, a current raw bid value, and an associated possible buyer of the plurality of possible buyers, the method comprising:
receiving, at the electronic auction subsystem from one prospective buyer end user subsystem of the plurality of prospective buyer end user subsystems, a new bid indicative of:
one associated possible buyer of the plurality of possible buyers;
a new bid quantity; and
a new raw bid value;
based on the received new bid, automatically updating, at the electronic auction subsystem, the auction status of the electronic auction;
based on the updated auction status of the electronic auction, automatically calculating, at the electronic auction subsystem, for each possible buyer of the plurality of possible buyers, a raw minimum bid value for each possible bid quantity of the plurality of possible bid quantities of auction product; and
after the calculating, automatically simultaneously presenting the calculated raw minimum bid value for each possible bid quantity of the plurality of possible bid quantities of auction product for only a first possible buyer of the plurality of possible buyers on a first prospective buyer end user subsystem of the plurality of prospective buyer end user subsystems.
